(19) United States
(12) Patent Application Publication
(10) Pub. No.: US 2008/0049323 A1
(43) Pub. Date: Feb. 28, 2008

(54) Optical film, production method of optical film, polarizing plate and liquid crystal display device

(75) Inventors: Susumu Sugiyama, Kanagawa (JP); Kunihiro Atsumi, Kanagawa (JP); Hajime Nakayama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/878,766

(22) Filed: Jul. 26, 2007

(30) Foreign Application Priority Data
Jul. 27, 2006 (JP) 2006-205063

(51) Int. Cl. G02B 5/30; B29D 11/00; G02F 1/1335

(52) U.S. Cl. 359/500; 264/1.34; 428/1.31

(57) ABSTRACT

An optical film includes at least one kind of humidity dependency improver that improves ΔRe, wherein the optical film has a ratio of Re/Rth which is larger as a wavelength is longer in the visible wavelength region; and Re which is larger as a wavelength is longer in the visible wavelength region, wherein Re represents an in-plane retardation (unit: nm) of the optical film; Rth represents a retardation (unit: nm) in a thickness direction of the optical film; and ΔRe represents a humidity dependency of Re defined by the following formula (1):

ΔRe=|Re(550)10%RH−Re(550)80%RH|,: Formula (1)

wherein Re(550)10%RH represents Re at a wavelength of 550 nm, at a temperature of 25° C. and at a relative humidity of 10%; and Re(550)80%RH represents Re at a wavelength of 550 nm, at a temperature of 25° C. and at a relative humidity of 80%.

### BACKGROUND OF THE INVENTION

1. Field of the Invention

The present invention relates to an optical film ensuring correct optical compensation of a liquid crystal cell irrespective of the ambient humidity to achieve high contrast and improve the color shift dependent on the viewing angle direction at the black display time, a production method of the optical film, and a polarizing plate and a liquid crystal display device each using the optical film.

2. Description of the Related Art

The liquid crystal display has a liquid crystal cell and a polarizing plate. The polarizing plate generally has a polarizing film and a protective film comprising a cellulose acylate and is obtained, for example, by dyeing a polarizing film comprising a polyvinyl alcohol film with iodine, stretching the film, and stacking a protective film on both surfaces thereof. In a transmissive liquid crystal display device, a polarizing plate is fixed to both sides of a liquid crystal cell and one or more sheets of optically-compensatory film are sometimes further disposed. In a reflective liquid crystal display device, a reflective plate, a liquid crystal cell, one or more sheets of optically-compensatory film, and a polarizing plate are usually disposed in this order. The liquid crystal cell comprises a liquid crystalline molecule, two substrates for encapsulating the liquid crystalline molecule, and an electrode layer for applying a voltage to the liquid crystalline molecule. The liquid crystal cell switches the ON-OFF display by utilizing the difference in the aligned state of liquid crystal molecules, and there have been proposed display modes applicable to both transmission type and reflection type, such as TN (twisted nematic), IPS (in-plane switching), OCB (optically compensatory bend), VA (vertically aligned) and ECB (electrically controlled birefringence).

Out of these LCD devices, in the usage where a high display quality is required, a 90°-twisted nematic liquid crystal display device using a nematic liquid crystal molecule with a positive dielectric anisotropy and being driven by a thin-film transistor is mainly used (hereinafter referred to as a TN mode). The TN mode has viewing angle characteristics such that when viewed from the front, excellent display properties are exhibited, but when viewed from an oblique direction, the contrast decreases and tone reversal or the like of reversing the brightness at a gradation display occurs, giving rise to worsened display properties. In this point, improvement is strongly demanded.

On the other hand, a wide viewing angle liquid crystal mode such as IPS mode, OCB mode and VA mode is increasing its market share along with recent increase in the demand for a liquid crystal television. In each mode, the display quality is enhanced year by year, but the problem of color shift which occurs when viewed obliquely is not solved.

Incidentally, it is conventionally known to design a retardation plate, particularly a ¼ wavelength plate, comprising a polymer oriented film to satisfy 0.6<Δn·d(450)/Δn·d(550)<0.97 and 1.01<Δn·d(650)/Δn·d(550)<1.35 (wherein Δn·d(λ) is the phase difference of the polymer oriented film at a wavelength of λ nm) (see, JP-A-2000-137116 (the term “JP-A” as used herein means an “unexamined published Japanese patent application”)).

### SUMMARY OF THE INVENTION

The present invention provides an optical film ensuring correct optical compensation of a liquid crystal cell irrespective of the ambient humidity to achieve high contrast and improve the color shift dependent on the viewing angle direction at the black display time, a production method of the optical film, and a polarizing plate and a liquid crystal display device each using the optical film.

The means for achieving the object of the present invention are as follows.

[1] An optical film comprising:

at least one kind of humidity dependency improver that improves ΔRe,

wherein the optical film has:

a ratio of Re/Rth which is larger as a wavelength is longer in the visible wavelength region; and

Re which is larger as a wavelength is longer in the visible wavelength region,

wherein Re represents an in-plane retardation (unit: nm) of the optical film;

Rth represents a retardation (unit: nm) in a thickness direction of the optical film; and

ΔRe represents a humidity dependency of Re defined by the following formula (1):

ΔRe=|Re(550)10%RH−Re(550)80%RH|, Formula (1):

wherein Re(550)10%RH represents Re at a wavelength of 550 nm, at a temperature of 25° C. and at a relative humidity of 10%; and

Re(550)80%RH represents Re at a wavelength of 550 nm, at a temperature of 25° C. and at a relative humidity of 80%.

[2] The optical film as described in [1], further comprising: at least one kind of polymer.

[3] The optical film as described in [2], having ΔRe(A) and ΔRe(0) which satisfy the following formula (2):

|ΔRe(A)−ΔRe(0)|/A≧1 (unit: nm/parts by mass), Formula (2):

wherein ΔRe(A) represents ΔRe of the optical film comprising the humidity dependency improver in an amount of A parts by mass, assuming that the optical film comprises the polymer in an amount of 100 parts by mass; and

ΔRe(0) represents ΔRe of the optical film comprising the humidity dependency improver in an amount of 0 parts by mass, assuming that the optical film comprises the polymer in an amount of 100 parts by mass.

[4] The optical film as described in [1], having the retardation values which satisfy the following formulae (Ia), (Ib), (II), (III) and (A):

0.4<{(Re(450)/Rth(450))/(Re(550)/Rth(550))}<0.95 Formula (Ia):

1.05<{(Re(650)/Rth(650))/(Re(550)/Rth(550))}<1.9 Formula (Ib):

0.1<(Re(450)/Re(550))<0.95 Formula (II):

1.03<(Re(650)/Re(550))<1.93 Formula (III):

10≧|Re(550)10%RH−Re(550)80%RH|, Formula (A):

wherein Re(λ) represents Re at a wavelength of λ nm; and

Rth(λ) represents Rth at a wavelength of λ nm.

[5] The optical film as described in [1],

wherein the humidity dependency improver is a compound containing at least two hydrogen-bonding groups.

[6] A production method of an optical film, comprising

a step of stretching a film by a stretch ration of X %; and

a step of shrinking the film by a shrinkage ratio of Y %,

wherein X and Y satisfy the following formula (Z); and

the film comprises a humidity dependency improver which is a compound containing at least two hydrogen-bonding groups:

400-4000/\sqrt{(100+X)}≧Y≧100−1000\sqrt{(100+X)}. Formula (Z):

[7] The optical film as described in [1], which is produced by the production method of an optical film comprising:

a step of stretching a film by a stretch ration of X %; and

a step of shrinking the film by a shrinkage ratio of Y %,

wherein X and Y satisfy the following formula (Z); and

the film comprises a humidity dependency improver which is a compound containing at least two hydrogen-bonding groups:

400−4000/\sqrt{(100+X)}≧Y≧100-1000/\sqrt{(100+X)}. Formula (Z):

[8] The optical film as described in [1],

wherein Re(550) is from 20 to 100 nm; and

Rth(550) is from 100 to 300 nm,

wherein Re(550) represents Re at a wavelength of 550 nm; and

Rth(550) represents Rth at a wavelength of 550 nm.

[9] The optical film as described in [1], further comprising:

a cellulose acylate.

[10] The optical film as described in [9],

wherein the cellulose acylate satisfies the following formulae (IV) and (V):

2.0≦(DS2+DS3+DS6)≦3.0 Formula (IV):

DS6/(DS2+DS3+DS6)≧0.315, Formula (V):

wherein DS2 represents a degree of substitution of a hydroxyl group by an acyl group at a 2-position in a glucose unit of the cellulose acylate;

DS3 represents a degree of substitution of a hydroxyl group by an acyl group at a 3-position in a glucose unit of the cellulose acylate; and

DS6 represents a degree of substitution of a hydroxyl group by an acyl group at a 6-position in a glucose unit of the cellulose acylate.

[11] The optical film as described in [9],

wherein the cellulose acylate satisfies the formulae (VI) and (VII):

2.0≦A+B≦3.0 Formula (VI):

0<B, Formula (VII):

wherein A represents a degree of substitution of a hydroxyl group by an acetyl group in a glucose unit of the cellulose acylate; and

B represents a degree of substitution of a hydroxyl group by a propionyl group, butyryl group or benzoyl group in a glucose unit of the cellulose acylate.

[12] The optical film as described in [1], further comprising:

a retardation developer.

[13] A polarizing plate comprising:

a polarizing film; and

a pair of protective films between which the polarizing film is sandwiched,

wherein at least one of the protective films is the optical film as described in [1].

[14] A liquid crystal display device comprising:

the optical film as described in [1].

[15] A liquid crystal display device of IPS, OCB or VA mode, comprising a liquid crystal cell; and

a pair of polarizing plates arranged on both sides of the liquid crystal cell,

wherein the pair of the polarizing plates are the polarizing plates as described in [13].

[16] A liquid crystal display device of VA mode, comprising:

the polarizing plate as described in [13] on a backlight side.

In the present invention, the terms “45°”, “in parallel” or “at right angles” mean that the angle is in the range of exact angle±less than 5°. The error from the exact angle is preferably less than 4°, more preferably less than 3°. As for the angle, “+” means the clockwise direction, and “−” means the counterclockwise direction. Also, the “slow axis” means the direction in which the refractive index becomes maximum, and the “visible light region” means a region of 380 to 780 nm. Furthermore, unless otherwise indicated, the refractive index is a value measured at a wavelength of λ=550 nm in the visible light region.

In the present specification, unless otherwise indicated, the term “polarizing plate” is used to include both a lengthy polarizing plate and a polarizing plate cut into a size suitable for the incorporation into a liquid crystal display device (in the present specification, “cut” includes “punch”, “clip” and the like). Also, the “polarizing film” and the “polarizing plate” are differentiated in the present specification, but the “polarizing plate” means a laminate where a transparent protective film for protecting the polarizing film is disposed on at least one surface of the “polarizing film”.

In the present invention, Re(λ) and Rth(λ) indicate the in-plane retardation and the retardation in a thickness-direction, respectively, at a wavelength of X. Re(λ) is measured by making light at a wavelength of λ nm to be incident in the film normal direction in KOBRA 21ADH or WR (manufactured by Oji Scientific Instruments).

In the case where the film measured is a film expressed by a uniaxial or biaxial refractive index ellipsoid, the Rth(λ) is calculated by the following method.

The above-described Re(λ) is measured at 6 points in total by making light at a wavelength of λ nm to be incident from directions inclined with respect to the film normal direction in 10° steps up to 50° on one side from the normal direction with the in-plane slow axis (judged by KOBRA 21ADH or WR) being used as the inclination axis (rotation axis) (when the slow axis is not present, an arbitrary direction in the film plane is used as the rotation axis) and based on the retardation values measured, the assumed values of average refractive index and the film thickness values input, Rth(λ) is calculated by KOBRA 21ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, the assumed values of average refractive index and the film thickness values input, Rth can also be calculated according to the following formulae (3) and (4).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 3 )$$

In the above, Re(0) represents the retardation value in the direction inclined at an angle of θ from the normal direction.

In formula (3), nx represents a refractive index in the in-plane slow axis direction, ny represents a refractive index in the direction crossing with nx at right angles in the plane, and nz represents a refractive index crossing with nx and ny at right angles.

$$Rth = [ \frac{nx + ny}{2} - nz ] \times d \qquad Formula ( 4 )$$

In the case where the film measured is a film incapable of being expressed by a uniaxial or biaxial refractive index ellipsoid or a film without a so-called optic axis, Rth(λ) is calculated by the following method.

The Re(λ) is measured at 11 points by making light at a wavelength of λ nm to be incident from directions inclined with respect the film normal direction in 10° steps from −50° to +50° with the in-plane slow axis (judged by KOBRA 21ADH or WR) being used as the inclination axis (rotation axis) and based on the retardation values measured, the assumed values of average refractive index and the film thickness values input, Rth(λ) is calculated by KOBRA 21ADH or WR.

In the measurement above, as for the assumed value of average refractive index, those described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

### DETAILED DESCRIPTION OF THE INVENTION

In the present invention, an optical property that the wavelength dispersion of retardation for incident light differs between the normal direction and a direction inclined with respect to the normal direction, for example, a direction at a polar angle of 60°, is imparted to the optical film, and this is aggressively used for optical compensation. The present invention is not limited by the display mode of the liquid crystal layer and can be used for a liquid crystal display device having a liquid crystal layer in any display mode such as VA mode, IPS mode, ECB mode, TN mode and OCB mode.

The present invention is described in detail below.

### (Optical Film)

The optical film of the present invention is characterized in that (i) the ratio Re/Rth of the retardation value Re in the film plane to the retardation value Rth in the thickness direction becomes larger as the wavelength is longer in the visible wavelength region and at the same time, (ii) Re becomes larger as the wavelength is longer in the visible wavelength region.

The wavelength dispersions (dependency of Re on the visible wavelength) (i) and (ii) of Re and Rth in the visible wavelength region of the optical film of the present invention are described below.

The wavelength dispersion (ii) that Re becomes larger as the wavelength is longer is advantageous for the optical compensation (viewing angle compensation) by the optical film in a liquid crystal display device. Since the amount of optical compensation by an optical film is determined by (phase difference of film)/(wavelength λ), the optical compensation amount increases as the wavelength is shorter and the optical compensation amount decreases as the wavelength is longer. Accordingly, when the phase difference (Re here) of the film is made small at a short wavelength and made large at a long wavelength, an equal optical compensation amount can be obtained at any wavelength.

Also, by virtue of the wavelength dispersion (i) that the ratio Re/Rth of Re to Rth becomes larger as the wavelength is longer in the visible wavelength region, the amount of wavelength dispersion of Rth becomes smaller than the amount of wavelength dispersion of Re (the amount of Re increased as the wavelength becomes longer). This is also advantageous for the optical compensation by the optical film in a liquid crystal display device. When the wavelength dispersion of the retardation Rth in the thickness direction is relatively small with respect to the wavelength dispersion of the retardation Re in the in-plane direction, optical compensation in the black state of VA mode, IPS mode or OCB mode can be achieved at almost all wavelengths.

In the optical film of the present invention, the retardation values preferably satisfy the following formulae (Ia), (Ib), (II), (III) and (A).

0.4<{(Re(450)/Rth(450))/(Re(550)/Rth(550))}<0.95 Formula (Ia):

1.05<{(Re(650)/Rth(650))/(Re(550)/Rth(550))}<1.9 Formula (Ib):

0.1<(Re(450)/Re(550))<0.95 Formula (II):

1.03<(Re(650)/Re(550))<1.93 Formula (III):

(wherein in formulae (Ia), (Ib), (II) and (III), Re(λ) is the in-plane retardation Re (unit: nm) for light at a wavelength of λ nm, and Rth(λ) is the retardation Rth (unit: nm) in a thickness direction for light at a wavelength of λ nm).

10≧|Re(550)10%RH−Re(550)80%RH| Formula (A):

(wherein Re(550)10%RH and Re(550)80%RH are Re(550) at 25° C.-10% RH and 25° C.-80% RH, respectively).

Formulae (Ia), (Ib), (II) and (III) more preferably satisfy the following formulae (Ia-1), (Ib-1), (II-1) and (III-1):

0.5<{(Re(450)/Rth(450))/(Re(550)/Rth(550))}<0.9 Formula (Ia-1):

1.1<{(Re(650)/Rth(650))/(Re(550)/Rth(550))}<1.7 Formula (Ib-1):

0.2<(Re(450)/Re(550))<0.9 Formula (II-1):

1.1<(Re(650)/Re(550))<1.7 Formula (III-1):

Also, |Re(550)10%RH−Re(550)80%RH|, that is, the difference ΔRe (=Re_{10%}−Re_{80%}) between the Re value at 25° C. and 10% RH and the Re value at 25° C. and 80% RH, is more preferably from −10 to 10 nm, still more preferably from −6 to 6 nm.

### (Humidity Dependency Improver)

The optical film of the present invention is also characterized by comprising at least one kind of humidity dependency improver of improving the humidity dependency ΔRe represented by the following formula (1) of Re of the optical film:

Humidity dependency ΔRe (nm) of Re of optical film=|Re(550)10%RH−Re(550)80%RH| Formula (1):

(wherein Re(550)10%RH and Re(550)80%RH are Re at a wavelength of 550 nm at 25° C. and a relative humidity of 10% and Re at a relative humidity of 80%, respectively).

The optical film of the present invention comprises at least one kind of polymer and at least one kind of humidity dependency improver.

The humidity dependency improver has an effect that the humidity dependency ΔRe of Re of the optical film of the present invention satisfies the following formula (2):

|ΔRe(A)−ΔRe(0)|/A≧1 (nm/parts by mass) Formula (2):

wherein ΔRe(A) is the humidity dependency of Re of the optical film having a humidity dependency improver content of A parts by mass and ΔRe(0) is the humidity dependency of the optical film having a humidity dependency improver content of 0 part by mass, assuming that the content of the polymer is 100 parts by mass.

The humidity dependency improver is preferably a compound containing at least two hydrogen-bonding groups.

The humidity dependency improver is described below by referring to the case using a cellulose acylate which is preferred as the material forming the optical film of the present invention.

By virtue of adding a humidity dependency improver to the optical film of the present invention, the humidity dependency of the in-plane retardation can be improved. This is considered to result because the humidity dependency improver has two or more hydrogen-bonding groups and interacts with the hydroxyl group of the cellulose acylate to form a pseudo-crosslinking point between the cellulose acylate chains and thereby inhibit the interaction between the cellulose acylate and a water molecule in the outer world.

Accordingly, the humidity dependency improver must contain a hydrogen-bonding group for the interaction with a cellulose acylate. However, if the humidity dependency improver allows for presence of many hydrogen-bonding groups and becomes excessively hydrophilic, there arises a problem that the film comes to have excessively large moisture content or water permeability and the humidity-heat resistance of the polarizing plate deteriorates.

In this regard, the humidity dependency improver preferably contains one or more aromatic rings for increasing the hydrophilicity.

The humidity dependency improver most preferably contains from 2 to 4 hydrogen-bonding groups and at the same time, contains from 1 to 3 aromatic rings.

In the present invention, the hydrogen-bonding group is a functional group having a hydrogen atom and being capable of forming a hydrogen bond between the hydrogen atom and another functional group having high electronegativity. The hydrogen-bonding group for use in the present invention is preferably an amino group, an acylamino group, an alkoxycarbonylamino group, an aryloxycarbonylamino group, a sulfonylamino group, a hydroxy group, a mercapto group or a carboxyl group, more preferably a functional group such as hydroxy group, acylamino group and sulfonylamino group.

In the present invention, the humidity dependency improver is preferably contained in the cellulose acylate film to account for 1 to 30%, more preferably from 5 to 20%, still more preferably from 7 to 16%.

The molecular weight of the humidity dependency improver for use in the present invention is preferably from 250 to 2,000, and the boiling point thereof is preferably 260° C. or more. The boiling point can be measured using a commercially available measuring apparatus (for example, TG/DTA100, manufactured by Seiko Instruments & Electronics Ltd.).

Various compounds may be used as the humidity dependency improver for use in the present invention, but a compound represented by the following formula (a) can be preferably used.

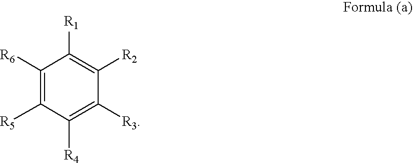

In formula (a), R₁, R₂, R₃, R₄, R₅ and R₆ each represents a hydrogen atom or a substituent, and at least two of R₁, R₂, R₃, R₄, R₅ and R₆ are a hydrogen-bonding group. As for the substituent, the following substituent T can be applied.

Examples of the substituent T include an alkyl group (preferably having a carbon number of 1 to 20, more preferably from 1 to 12, still more preferably from 1 to 8, e.g., methyl, ethyl, iso-propyl, tert-butyl, n-octyl, n-decyl, n-hexadecyl, cyclopropyl, cyclopentyl, cyclohexyl), an alkenyl group (preferably having a carbon number of 2 to 20, more preferably from 2 to 12, still more preferably from 2 to 8, e.g., vinyl, allyl, 2-butenyl, 3-pentenyl), an alkynyl group (preferably having a carbon number of 2 to 20, more preferably from 2 to 12, still more preferably from 2 to 8, e.g., propargyl, 3-pentynyl), an aryl group (preferably having a carbon number of 6 to 30, more preferably from 6 to 20, still more preferably from 6 to 12, e.g., phenyl, p-methylphenyl, naphthyl), a substituted or unsubstituted amino group (preferably having a carbon number of 0 to 20, more preferably from 0 to 10, still more preferably from 0 to 6, e.g., amino, methylamino, dimethylamino, diethylamino, dibenzylamino), an alkoxy group (preferably having a carbon number of 1 to 20, more preferably from 1 to 12, still more preferably from 1 to 8, e.g., methoxy, ethoxy, butoxy), an aryloxy group (preferably having a carbon number of 6 to 20, more preferably from 6 to 16, still more preferably from 6 to 12, e.g., phenyloxy, 2-naphthyloxy), an acyl group (preferably having a carbon number of 1 to 20, more preferably from 1 to 16, still more preferably from 1 to 12, e.g., acetyl, benzoyl, formyl, pivaloyl), an alkoxycarbonyl group (preferably having a carbon number of 2 to 20, more preferably from 2 to 16, still more preferably from 2 to 12, e.g., methoxycarbonyl, ethoxycarbonyl), an aryloxycarbonyl group (preferably having a carbon number of 7 to 20, more preferably from 7 to 16, still more preferably from 7 to 10, e.g., phenyloxycarbonyl), an acyloxy group (preferably having a carbon number of 2 to 20, more preferably from 2 to 16, still more preferably from 2 to 10, e.g., acetoxy, benzoyloxy), an acylamino group (preferably having a carbon number of 2 to 20, more preferably from 2 to 16, still more preferably from 2 to 10, e.g., acetylamino, benzoylamino), an alkoxycarbonylamino group (preferably having a carbon number of 2 to 20, more preferably from 2 to 16, still more preferably from 2 to 12, e.g., methoxycarbonylamino), an aryloxycarbonylamino group (preferably having a carbon number of 7 to 20, more preferably from 7 to 16, still more preferably from 7 to 12, e.g., phenyloxycarbonylamino), a sulfonylamino group (preferably having a carbon number of 1 to 20, more preferably from 1 to 16, still more preferably from 1 to 12, e.g., methanesulfonylamino, benzenesulfonylamino), a sulfamoyl group (preferably having a carbon number of 0 to 20, more preferably from 0 to 16, still more preferably from 0 to 12, e.g., sulfamoyl, methylsulfamoyl, dimethylsulfamoyl, phenylsulfamoyl), a carbamoyl group (preferably having a carbon number of 1 to 20, more preferably from 1 to 16, still more preferably from 1 to 12, e.g., carbamoyl, methylcarbamoyl, diethylcarbamoyl, phenylcarbamoyl), an alkylthio group (preferably having a carbon number of 1 to 20, more preferably from 1 to 16, still more preferably from 1 to 12, e.g., methylthio, ethylthio), an arylthio group (preferably having a carbon number of 6 to 20, more preferably from 6 to 16, still more preferably from 6 to 12, e.g., phenylthio), a sulfonyl group (preferably having a carbon number of 1 to 20, more preferably from 1 to 16, still more preferably from 1 to 12, e.g., mesyl, tosyl), a sulfinyl group (preferably having a carbon number of 1 to 20, more preferably from 1 to 16, still more preferably from 1 to 12, e.g., methanesulfinyl, benzenesulfinyl), a ureido group (preferably having a carbon number of 1 to 20, more preferably from 1 to 16, still more preferably from 1 to 12, e.g., ureido, methylureido, phenylureido), a phosphoric acid amide group (preferably having a carbon number of 1 to 20, more preferably from 1 to 16, still more preferably from 1 to 12, e.g., diethylphosphoric acid amide, phenylphosphoric acid amide), a hydroxy group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably having a carbon number of 1 to 30, more preferably from 1 to 12; examples of the heteroatom include a nitrogen atom, an oxygen atom and a sulfur atom; specific examples of the heterocyclic group include imidazolyl, pyridyl, quinolyl, furyl, piperidyl, morpholino, benzoxazolyl, benzimidazolyl and benzothiazolyl), and a silyl group (preferably having a carbon number of 3 to 40, more preferably from 3 to 30, still more preferably from 3 to 24, e.g., trimethylsilyl, triphenylsilyl). Among these, preferred are an alkyl group, an aryl group, a substituted or unsubstituted amino group, an alkoxy group and an aryloxy group, and more preferred are an alkyl group, an aryl group and an alkoxy group.

These substituents each may be further substituted by the substituent T. When two or more substituents are present, the substituents may be the same or different and, if possible, may combine with each other to form a ring.

At least two members out of R₁, R₂, R₃, R₄, R₅ and R₆ are a substituted or unsubstituted amino group, an acylamino group, an alkoxycarbonylamino group, an aryloxycarbonyl group, a sulfonylamino group, a hydroxy group, a mercapto group or a carboxyl group, preferably an amino group or a hydroxy group, more preferably a hydroxy group. At this time, the substituents may be the same or different.

Particularly preferred examples of the compound represented by formula (a) which is preferably used in the present invention are set forth below, but the present invention is not limited to these specific examples.

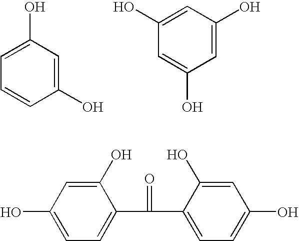

### (Production Method of Optical Film)

The production method of an optical film of the present invention comprises a step of stretching a film by a stretch ratio of X % (stretching step) and a step of shrinking the film by a shrinkage ratio of Y % (shrinking step), wherein the relationship between the stretch ratio X % and the shrinkage ratio Y % satisfies the following formula (Z) and the film comprises a humidity dependency improver which is a compound containing at least two hydrogen-bonding groups.

400−4000/\sqrt{(100+X)}≧Y≧100−1000/\sqrt{(100/+X)} Formula (Z):

As a result of extensive studies, the present inventors have found that when the production method comprises a stretching step and a shrinking step and the film comprises a humidity dependency improver which is a compound containing at least two hydrogen bonding groups, an optical film having optical properties represented by formulae (Ia), (Ib), (II) and (III) and assured of small humidity dependency of in-plane retardation Re can be obtained.

The production method of an optical film of the present invention preferably comprises a stretching step of stretching the film in the conveying direction and a shrinking step of shrinking the film in the width direction while gripping the film or preferably comprises a stretching step of stretching the film in the width direction and a shrinking step of shrinking the film in the conveying direction.

The film production method comprising a stretching step of stretching the film in the conveying direction and a shrinking step of shrinking the film in the width direction while gripping the film is described below.

In this case, the film is stretched in the film conveying direction. As for the method of stretching the film in the conveying direction, a method of creating a difference in the peripheral velocity among a plurality of rolls and stretching the film in the longitudinal direction by utilizing the difference in the peripheral velocity among rolls may be preferably used. In the film formation by a solution casting method, a method where at the time of separating the film cast on a stainless steel-made band or drum and come into a semi-dried state, the speed of the film conveying rollers is adjusted such that the film taking-up speed is higher than the film peeling speed, may also be preferably used.

As for the shrinking in the width direction, the film is conveyed while gripping the film by a device called a tenter of fixing both edges of the film with a clip or a pin, and the width of the tenter is gradually narrowed, whereby the film can be shrunk in the direction nearly orthogonal to the stretching direction.

The stretching step and the shrinking step may be sequentially performed either in the order of stretching and shrinking or in the order of shrinking and stretching.

The shrinking in the width direction can also be performed by gripping the film with a tenter capable of biaxially operating in the conveying and width directions of the film, such as chain type, screw type, pantograph type or linear motor type, and gradually narrowing the width of the tenter while gradually increasing the distance between clips in the conveying direction, thereby stretching the film.

On the other hand, in the cellulose acylate film production method comprising a stretching step of stretching the film in the width direction and a shrinking step of shrinking the film in the conveying direction, the film can be shrunk by gripping the film with a tenter capable of biaxially operating in the conveying and width directions of the film, such as chain type, screw type, pantograph type or linear motor type, and gradually reducing the distance between clips in the conveying direction while stretching the film in the width direction.

In the above-described method using a tenter capable of biaxially operating in the conveying and width directions of the film, the stretching step and the shrinking step can be at least partially performed at the same time. As a result of studies by the present inventors, such a simultaneous treatment is found advantageous in that the non-uniform stretching and shrinking in the film plane, called bowing, can be readily reduced by adjusting the timing of stretching and shrinking, the stretch ratio, and the speed.

Incidentally, as regards the stretching apparatus for specifically performing the above-described stretching step of stretching the film in either the longitudinal direction or the width direction and at the same time, shrinking the film in the other direction and increasing the thickness of the film, a FITZ machine manufactured by Ichikin Industry Co., Ltd. may be suitably used. This apparatus is described in JP-A-2001-38802.

The present inventors have made intensive studies on the stretch ratio in the stretching step and the shrinkage ratio in the shrinking step and found that when the relationship between the stretch ratio X % in the stretching step and the shrinkage ratio Y % in the shrinking step satisfies the following formula (Z), this is effective for satisfying the relationships of formulae (Ia), (Ib), (II) and (III) while setting the Re in the desired range (from 20 to 100 nm).

400−4000/\sqrt{(100+X)}≧Y≧100−1000/(100+X) Formula (Z):

If the relationship between the stretch ratio and the shrinkage ratio is less than the lower limit of formula (Z), a technical measure such as use of a special additive in combination or blending of a dissimilar polymer is required for obtaining the desired Re and satisfying the relationships of formulae (Ia), (Ib), (II) and (III), and this brings about other problems such as bleed-out of the additive or rise of the production cost. On the other hand, if the relationship between the stretch ratio and the shrinkage ratio exceeds the upper limit of formula (Z), wrinkles are generated in the film after stretching and shrinking steps and the film cannot be used as an optical film.

The stretch ratio as used in the present invention means the ratio of the incremental length of the film after stretching to the length of the film before stretching in the stretching direction, and the shrinkage ratio means the ratio of decremental length of the film after shrinking to the length of the film before shrinking in the shrinking direction.

Within the range satisfying formula (Z), the stretch ratio is preferably from 20 to 50%, more preferably from 25 to 45%, and the shrinkage ratio is preferably from 15 to 45%, more preferably from 20 to 40%.

Also, as a result of studies by the present inventors, it has been found that when the stretching step and the shrinking step are performed at a temperature from the glass transition temperature of the film to the crystallization temperature, this is preferred for achieving the desired stretch ratio, shrinkage ratio and optical properties. If the temperature is less than the glass transition temperature, the thermal shrinkage of film cannot be utilized and the shrinking step becomes difficult to perform, whereas if the film is heated at a temperature more than the crystallization temperature, Re decreases and desired optical properties cannot be attained.

Incidentally, the glass transition temperature is measured as follows in the present invention. A film sample (unstretched) of 5 mm×30 mm is moisture-conditioned at 25° C.-60% RH for 2 hours or more and then measured by a dynamic viscoelasticity meter, “Vibron DVA-225” {manufactured by IT Keisoku Seigyo K.K.}, under the conditions of a gripping distance of 20 mm, a temperature rising rate of 2° C./min, a measurement temperature range of 30 to 200° C. and a frequency of 1 Hz. The storage modulus is taken as a logarithmic axis on the ordinate, the temperature (° C.) is taken as a linear axis on the abscissa, and the temperature showing the abrupt decrease of the storage modulus, which is observed when the storage modulus shifts from the solid region to the glass transition region, is defined as the glass transition temperature Tg. More specifically, when a straight line 1 in the solid region and a straight line 2 in the glass transition region are drawn on the obtained chart, the intersection of the straight line 1 and the straight line 2 is the temperature at which the storage modulus abruptly decreases during temperature rise and the film starts softening, and this is a temperature causing the storage modulus to start shifting to the glass transition region and therefore, is defined as the glass transition temperature Tg (dynamic viscoelasticity).

Also, the treatment temperature indicates the film surface temperature measured by a non-contact infrared thermometer.

The present invention can be performed by wet stretching of stretching the film produced by a solution casting method, on the way of drying. Also, the stretching treatment may be performed continuously after drying the film, or the stretching step may be separately performed after once taking up the film. The present invention may be applied also to the stretching of the film produced by a melting method and substantially free from a solvent. The stretching and shrinking of the film may be performed in one step or in multiple steps. In the case of performing the stretching in multiple steps, this may be performed such that the product of respective stretch ratios falls within the preferred range above.

The stretching speed is preferably from 5 to 1,000%/min, more preferably from 10 to 500%/min. The stretching is preferably performed using a heat roll and/or a radiation heat source (e.g., IR heater) or with hot air.

A preheating step is preferably provided before stretching, and a heat treatment step may be performed after stretching. The heat treatment temperature is preferably from 20° C. lower than the glass transition temperature of the film to 10° C. higher than the glass transition temperature, and the heat treatment time is preferably from 1 second to 3 minutes. The heating method may be zone heating or partial heating using an infrared heater. Both edges of the film may be slit during or at the end of the step. The slitting debris is preferably recovered and reused as the raw material. The following techniques can be appropriately employed within the range of not violating the purport of the present invention. As regards the tenter, JP-A-11-077718 discloses a technique where at the time of drying the web while keeping the width by a tenter, the deterioration of quality such as planarity, which occurs when increasing the speed in a solution casting method or expanding the web width, can be prevented by appropriately controlling, for example, the drying gas blowing method, blowing angle, wind velocity distribution, wind velocity, air volume, temperature difference, air volume difference, upper-to-lower blown air volume ratio, or use of high specific heat drying gas.

JP-A-11-077822 discloses an invention, in which, after the step of stretching the thermoplastic resin film, the film is shrunk by thermal relaxation by smaller amount than the stretching amount, and the film is heat-treated by a temperature gradient provided in the film width direction for the purpose of preventing the occurrence of unevenness.

Also, for suppressing the curling due to regulation of the clipping width, JP-A-2002-248680 discloses an invention where the film is stretched at a tenter clipping width D≦(33/(log(stretch ratio)×log (volatile content)) to thereby suppress the curling and facilitate the film conveyance after the stretching step.

For attaining both high-speed soft film conveyance and stretching, JP-A-2002-337224 discloses an invention where the tenter conveyance is switched over between a first half pin and a second half pin.

For preventing the web from foaming during tenter drying and thereby improving the releasability to prevent dusting, JP-A-2003-004374 discloses an invention using a drying apparatus where the width of the dryer is set shorter than the width of the web so as to keep both edges of the web away from hot air of the dryer.

Also, for preventing the web from foaming during tenter drying and thereby improving the releasability to prevent dusting, JP-A-2003-019757 discloses an invention where a windshield plate is provided inside both edges of the web so as to keep the part held by a tenter away from drying air.

In order to perform the conveyance and drying stably, JP-A-2003-053749 discloses an invention where assuming that the dry thickness in both edges of the film carried by a pin tenter is X μm and the average dry thickness of the product part of the film is T μm, X and T satisfy the relationship of formula (1) 40≦x≦200 when T≦60, formula (2) 40+(T−60)×0.2≦X≦300 when 60<T≦120, or formula (3) 52+(T−120)×0.2≦X≦400 when 120<T.

For preventing generation of wrinkles in a multi-stage tenter, JP-A-2-182654 discloses an invention using a tenter device where a heating chamber and a cooling chamber are provided in the dryer of the multi-stage tenter and the right and left clip chains are separately cooled.

For preventing the web from rupture, wrinkle and conveyance failure, JP-A-9-077315 discloses an invention using a pin tenter where pins are arranged such that the inner pin density is high and the outer pin density is low.

For preventing foaming of the web itself or attachment of the web to the holding means in the tenter, JP-A-9-085846 discloses an invention using a tenter drying apparatus where the pins holding both edges of the web are cooled to a temperature less than the web foaming temperature by a blowing cooler and the pins immediately before engaging the web are cooled to a temperature not more than the dope gelation temperature+15° C. by a duct-type cooler.

For preventing pin tenter slippage and eliminating foreign matters, JP-A-2003-103542 discloses an invention related to a solution film-forming method using a pin tenter where an insert structure is cooled not to allow the surface temperature of the web in contact with the insert structure to exceed the web gelation temperature.

In order to prevent the deterioration of quality such as planarity, which occurs when increasing the speed in a solution casting method or expanding the web width by a tenter, JP-A-11-077718 discloses an invention where the web is dried in a tenter under the conditions of a wind velocity of 0.5 to 20 (40) m/s, a crosswise temperature distribution of 10% or less, an upper-to-lower web air volume ratio of 0.2 to 1 and a drying gas ratio of 30 to 250 J/Kmol. Also, as for the drying in a tenter, preferred drying conditions according to the residual solvent amount are disclosed. More specifically, between the time at which the web is separated from the support and the time at which the residual solvent amount in the web reaches 4 mass %, the blowing angle from the blow port is set to from 30 to 150° and at the same time, the web is dried by blowing a drying gas such that in the wind velocity distribution on the surface of the film positioned in the extending direction of blowing of the drying gas, when based on the upper limit of the wind velocity, the difference between the upper limit and the lower limit becomes 20% or less. When the residual solvent amount in the web is from 70 to 130 mass %, the wind velocity of the drying gas blown from the blowing dryer machine on the web surface is set to from 0.5 to 20 m/sec. When the residual solvent amount is from 4 mass % to less than 70 mass %, the web is dried with a drying gas wind by blowing the drying gas at a wind velocity of 0.5 to 40 m/sec such that in the temperature distribution of the drying gas in the web crosswise direction, when based on the upper limit of the gas temperature, the difference between the upper limit and the lower limit becomes 10% or less. When the residual solvent amount in the web is from 4 to 200 mass %, the flow volume ratio q of the drying gas blown from the blow ports of the blowing dryer machines positioned above and below the travelling web is set to 0.2≦q≦1. Furthermore, in a preferred embodiment disclosed, for example, at least one gas is used for the drying gas, the average specific heat thereof is from 31.0 to 250 J/K·mol, and the drying is performed using the drying gas at a saturated vapor pressure under the condition that the concentration of an organic compound contained in the drying gas during drying, which is liquid at ordinary temperature, is 50% or less.

In order to prevent the planarity or coating from deteriorating due to production of contaminants, JP-A-11-077719 discloses an invention using a TAC (triacetyl cellulose) producing apparatus where a heating portion is incorporated into the tenter clip. Also, in a preferred embodiment disclosed, for example, a device for removing foreign matters generated in the portion of the clip and the web being in contact is provided between the site at which the tenter clip releases the web and the site at which the clip carries the web again, foreign matters are removed using a jetting gas or liquid or a brush, the residual amount when the clip or pin is put into contact with the web is from 12 to 50 mass %, or the surface temperature in the portion of the clip or pin and the web being in contact is from 60 to 200° C. (preferably from 80 to 120° C.).

For enhancing the planarity and improving the quality reduction due to tear in a tenter to thereby increase the productivity, JP-A-11-090943 discloses an invention using a tenter clip where the ratio Lr=Ltt/Lt of an arbitrary length Lt (m) of the tenter to the sum length Ltt (m) in the conveying direction of the portions where the tenter clip having the same length as Lt is holding the web is 1.0≦Lr≦1.99. Also, in a preferred embodiment disclosed, the portions holding the web are disposed without any gap as viewed from the web width direction.

For preventing planarity deterioration and unstable introduction due to a slack web at the introduction of the web into a tenter, JP-A-11-090944 discloses an invention related to a plastic film producing apparatus where a device for inhibiting slack in the web crosswise direction is provided before the tenter inlet. Furthermore, in a preferred embodiment disclosed, for example, the slack inhibiting device is a rotary roller rotating in a directional range at a crosswise expanding angle from 2 to 60°, an air sucking device is provided above the web, or an air blower capable of blowing air from under the web is provided.

For the purpose of preventing the occurrence of slack as a cause of quality deterioration and productivity inhibition, JP-A-11-090945 discloses an invention related to a TAC producing method where a web separated from a support is introduced into a tenter by making an angle with respect to the horizontal direction.

For producing a film having stabilized physical properties, JP-A-2000-289903 discloses an invention related to a conveying apparatus of conveying a web while applying tension in the width direction at the time of the separated web coming to have a solvent content of 12 to 50 wt %, where web width detecting means, web holding means and two or more variable flexing points are provided and based on the web width calculated from detection signals by the web width detecting means, the position of the flexing point is changed.

For enhancing the clipping property and preventing rupture of the web for a long period of time, JP-A-2003-033933 describes an invention where a guide plate for preventing the occurrence of curling in the side edge part of the web is provided at least under the edge part out of above and under the right and left edge parts of the web on both right and left sides of the portion close to the tenter inlet and the guide plate surface facing the web is composed of a web-contacting resin part and a web-contacting metal part arranged in the web conveying direction. Furthermore, in a preferred embodiment disclosed, for example, the web-contacting resin part and the web-contacting metal part on the guide plate surface facing the web are disposed upstream and downstream, respectively, in the web conveying direction, the step (including slope) between the web-contacting resin portion and the web-contacting metal part of the guide plate is 500 μm or less, the crosswise distance for which the web-contacting resin part of the guide plate is in contact with the web and the crosswise distance for which the web-contacting metal part is in contact with the web each is from 2 to 150 mm, the distance in the web conveying direction for which the web-contacting resin part of the guide plate is in contact with the web and the distance in the web conveying direction for which the web-contacting metal part is in contact with the web each is from 5 to 120 mm, the web-contacting resin part of the guide plate is provided on a metal-made guide plate by surface resin treatment or resin coating, the web-contacting resin part of the guide plate comprises a simple resin body, the distance between the above-disposed guide plate surface facing the web and the under-disposed guide plate surface facing the web in the right and left edge parts of the web is from 3 to 30 mm, the distance between the upper guide plate surface facing the web and the lower guide plate surface facing the web in the right and left edge parts of the web is increased in the web crosswise direction to the inward direction at a rate of 2 mm or more per 100 mm of width, the upper and lower guide plates in the right and left edge parts of the web each has a length of 10 to 300 mm with the upper and lower guide plates being disposed to shift back or forth in the web conveying direction and the shift distance between the upper and lower guide plates being from −200 to +200 mm, the upper guide plate surface facing the web is composed of only a resin or a metal, the web-contacting resin part of the guide plate is made of Teflon® with the web-contacting metal part being made of a stainless steel, or the guide plate surface facing the web or the web-contacting resin part and/or web-contacting metal part provided thereon has a surface roughness of 3 μm or less. It is also disclosed that the upper and lower guide plates for preventing the occurrence of curling in the web edge parts are preferably disposed between the separation-side end part of the support and the introduction part into the tenter, more preferably in the portion close to the tenter inlet.

Furthermore, JP-A-2002-036266, which is an invention for obtaining a high-quality thin TAC having a thickness of 20 to 85 μm, discloses a preferred embodiment where, for example, the difference in the tension acting on the web along the conveying direction is set to 8 N/mm² or less, or a preheating step of preheating the web after the separation step, a stretching step of stretching the web by using a tenter after the preheating step, and a relaxing step of relaxing (i.e. shrinking) the web after the stretching step by smaller amount than the stretching amount in the stretching step are provided.

Also, JP-A-2002-225054, which is aimed to realize thinning to a dry thickness of 10 to 60 μm and excellent durability, discloses a technique where, for example, the web is gripped by a clip at both edges after the separation until the residual solvent amount in the web becomes 10 mass % so as to perform drying shrinkage suppression and/or crosswise stretching by keeping the width and form a film having a plane orientation degree (S) represented by the formula: S={(Nx+Ny)/2}−Nz, of 0.0008 to 0.0020 (in the formula, Nx is the refractive index of the film in the in-plane direction having a largest refractive index, Ny is the refractive index in the in-plane direction perpendicular to Nx, and Nz is the refractive index of the film in the thickness direction), the time from casting until separation is set to from 30 to 90 seconds, or the web after separation is stretched in the crosswise direction and/or in the longitudinal direction.

Furthermore, JP-A-2002-341144 discloses a solution film-forming method comprising a stretching step, where for suppressing the optical unevenness, the film has a concentration distribution that the mass concentration of the retardation raising agent is higher as closer to the center in the film width direction.

Also, JP-A-2002-248639, which is an invention for reducing the longitudinal and crosswise dimensional change during storage under high-temperature high-humidity conditions, discloses a film producing method of casting a cellulose ester solution on a support and continuously separating and drying the film, where the film is dried such that the drying shrinkage ratio satisfies the formula: 0≦drying shrinkage ratio (%)≦0.1× residual solvent amount (%) at separation. Furthermore, in a preferred embodiment disclosed, for example, the cellulose ester film still having a residual solvent amount of 40 to 100 mass % after separation is conveyed by a tenter while gripping both edges of the film to reduce the residual solvent amount at least by 30 mass % or more, the cellulose ester film after separation has a residual solvent amount of 40 to 100 mass % at the inlet for conveyance by a tenter and a residual solvent amount of 4 to 20 mass % at the outlet, the tension with which the cellulose ester film is conveyed by the conveyance using a tenter is increased from the inlet for conveyance by a tenter to the outlet, or the tension for conveying the cellulose ester film by the conveyance using a tenter is virtually the same as the tension for stretching the cellulose ester film in the crosswise direction.

For obtaining a film assured of a small thickness and excellent in the optical isotropy and planarity, JP-A-2000-239403 discloses a technique of performing the film formation by setting the relationship between the residual solvent ratio X at the separation and the residual solvent ratio Y at the introduction into a tenter to satisfy 0.3X≦Y≦0.9X.

The optical film of the present invention may be produced by any production method but is preferably produced by the above-described production methods of an optical film.

In the optical film of the present invention, it is preferred that Re(550) is from 20 to 100 nm and Rth(550) is from 100 to 300 nm.

Particularly, in the case where the optical film is used for a VA-mode liquid crystal display device and the optical compensation is effected by one sheet provided on one side of the liquid crystal cell, the optical film preferably has Re(550) of 40 to 100 nm and Rth(550) of 160 to 300 nm, more preferably Re(550) of 45 to 80 nm and Rth(550) of 170 to 250 nm.

On the other hand, in the case where the optical film is used on both sides of the liquid crystal cell of a VA-mode liquid crystal display device and the optical compensation is effected by two sheets, the optical film preferably has Re(550) of 20 to 100 nm and Rth(550) of 100 to 200 nm, more preferably Re(550) of 25 to 80 nm and Rth(550) of 100 to 150 nm.

The polymer material mainly constituting the optical film of the present invention satisfying the above-described properties is specifically described below.

### [Material of Optical Film]

As for the material forming the optical film of the present invention, a cellulose-based polymer (hereinafter referred to as a “cellulose acylate”) as represented by triacetyl cellulose, which has been conventionally used as the transparent protective film of a polarizing plate, can be preferably used. The cellulose acylate is described in detail below.

### (Cellulose Acylate)

As for the raw material cotton of the cellulose acylate, known raw materials can be used (see, for example, JIII Journal of Technical Disclosure, No. 2001-1745). Also, the synthesis of the cellulose acylate can be performed by a known method (see, for example, Migita, et al., Mokuzai Kagaku (Wood Chemistry), pp. 180-190, Kyoritsu Shuppan (1968)). The viscosity average polymerization degree of the cellulose acylate is preferably from 200 to 700, more preferably from 250 to 500, and most preferably from 250 to 350. The cellulose ester for use in the present invention preferably has a number average molecular weight (Mn) of 10,000 to 150,000, a weight average molecular weight (Mw) of 20,000 to 500,000, and a Z average molecular weight (Mz) of 5,000 to 550,000. The molecular weight distribution of Mw/Mn (Mw is the mass average molecular weight, and Mn is the number average molecular weight) by gel permeation chromatography is preferably narrow. Specifically, the Mw/Mn value is preferably from 1.5 to 5.0, more preferably from 2.0 to 4.5, and most preferably from 3.0 to 4.0.

The acyl group of the cellulose acylate is not particularly limited, but an acetyl group, a propionyl group, a butyryl group or a benzoyl group is preferably used. The substitution degree of all acyl groups is preferably from 2.0 to 3.0, more preferably from 2.2 to 2.95. The substitution degree of acyl group as used in the present invention is a value calculated according to ASTM D817. In the case of using a cellulose acetate where the acyl group is an acetyl group, the acetylation degree is preferably from 57.0 to 62.5%, more preferably from 58.0 to 62.0%. When the acetylation degree is in this range, Re does not come to exceed the desired value by the conveyance tension at the casting, the in-plane fluctuation is reduced, and the retardation value less changes depending on the temperature and humidity.

Particularly, when the hydroxyl group of the glucose unit constituting the cellulose of the cellulose acylate film is substituted by an acyl group having a carbon number of 2 or more, assuming that the degree of substitution by an acyl group to the hydroxyl group at the 2-position of the glucose unit is DS2, the degree of substitution by an acyl group to the hydroxyl group at the 3-position is DS3, and the degree of substitution by an acyl group to the hydroxyl group at the 6-position is DS6, these substitution degrees preferably satisfy the following formulae (IV) and (V), because desired Re and Rth are easily obtained and the fluctuation of Re value depending on the temperature and humidity is more reduced.

2.0≦(DS2+DS3+DS6)≦3.0 Formula (IV):

DS6/(DS2+DS3+DS6)≧0.315 Formula (V):

More preferably,

2.2≦(DS2+DS3+DS6)≦2.9, and Formula (IV-1):

DS6/(DS2+DS3+DS6)≧0.322. Formula (V-1):

Also, assuming that the degree of substitution by an acetyl group to the hydroxyl group of the glucose unit of the cellulose acylate is A and the degree of substitution by a propionyl group, butyryl group or benzoyl group is B, A and B preferably satisfy the following formulae (VI) and (VII), because desired Re and Rth are easily obtained and a high stretch magnification can be easily realized without rupture.

2.0≦A+B≦3.0 Formula (VI):

0<B Formula (VII):

More preferably,

2.6≦A+B≦3.0, and Formula (VI-1):

0.5≦B≦1.5. Formula (VII-1):

### (Polymers Other than Cellulose Acylate)

The method of obtaining a film having preferred optical properties by the production method of the present invention comprising a stretching step of stretching the film and a shrinking step of shrinking the film is not limited to a cellulose acylate but can be applied to polymers in general which can be used as an optical film, and the same effect as that obtainable by a cellulose acylate can be expected.

Examples of the polymer usable as such an optical film include a polycarbonate copolymer and a polymer resin having a cyclic olefin structure.

Examples of the polycarbonate copolymer include a polycarbonate copolymer comprising a repeating unit represented by the following formula (A) and a repeating unit represented by the following formula (B), with the repeating unit represented by formula (A) occupying from 30 to 80 mol % in the entirety.

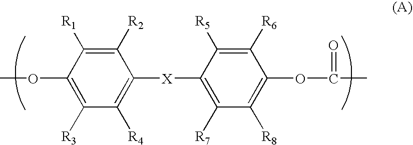

In formula (A), R₁ to R₈ each is independently selected from the group consisting of a hydrogen atom, a halogen atom and a hydrocarbon group having a carbon number of 1 to 6. Examples of the hydrocarbon group having a carbon number of 1 to 6 include a alkyl group such as methyl group, ethyl group, isopropyl group and cyclohexyl group, and an aryl group such as phenyl group. Among these, a hydrogen atom and a methyl group are preferred.

X is the following formula (X), wherein R₉ and R₁₀ each is independently a hydrogen atom, a halogen atom or an alkyl group having a carbon number of 1 to 3. Examples of the alkyl group having a carbon number of 1 to 3 are the same as those described above.

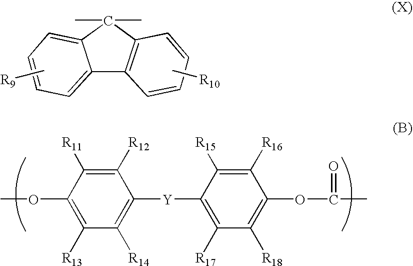

In formula (B), R₁₁ to R₁₈ each is independently selected from a hydrogen atom, a halogen atom and a hydrocarbon group having a carbon number of 1 to 22. Examples of the hydrocarbon group having a carbon number of 1 to 22 include an alkyl group having a carbon number of 1 to 9, such as methyl group, ethyl group, isopropyl group and cyclohexyl group, and an aryl group such as phenyl group, biphenyl group and terphenyl group. Among these, a hydrogen atom and a methyl group are preferred.

Y is selected from the group of formulae shown below, wherein R₁₉ to R₂₁, R₂₃ and R₂₄ each is independently at least one group selected from the group consisting of a hydrogen atom, a halogen atom and a hydrocarbon group having a carbon number of 1 to 22. Examples of such a hydrocarbon group are the same as those described above. R₂₂ and R₂₅ each is independently a hydrocarbon group having a carbon number of 1 to 20, and examples of this hydrocarbon group include a methylene group, an ethylene group, a propylene group, a butylene group, a cyclohexylene group, a phenylene group, a naphthylene group and a terphenylene group. Ar₁ to Ar₃ each is an aryl group having a carbon number of 6 to 10, such as phenyl group and naphthyl group.

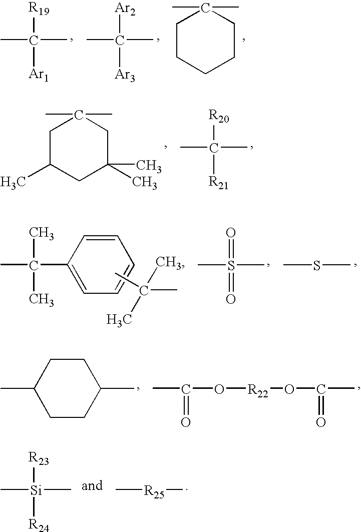

The polycarbonate copolymer is preferably a polycarbonate copolymer comprising from 30 to 60 mol % of a repeating unit represented by the following formula (C) and from 40 to 70 mol % of a repeating unit represented by the following formula (D).

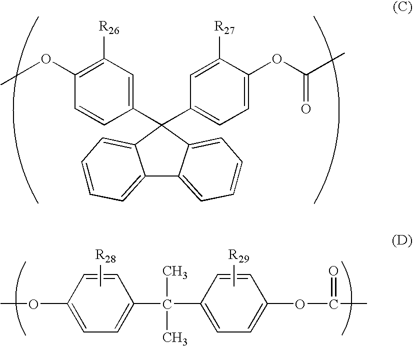

The polycarbonate copolymer is more preferably a polycarbonate copolymer comprising from 45 to 55 mol % of a repeating unit represented by formula (C) and from 45 to 55 mol % of a repeating unit represented by formula (D).

In formula (C), R₂₆ and R₂₇ each is independently a hydrogen atom or a methyl group, with a methyl group being preferred in view of handleability.

In formula (D), R₂₈ and R₂₉ each is independently a hydrogen atom or a methyl group, with a hydrogen atom being preferred in view of profitability, film properties and the like.

The optical film of the present invention preferably uses the above-described polycarbonate copolymer having a fluorene skeleton. The polycarbonate copolymer having a fluorene skeleton is preferably a blend of polycarbonate copolymers differing in the compositional ratio, each comprising a repeating unit represented by formula (A) and a repeating unit represented by formula (B). The percentage content of the repeating unit of formula (A) is preferably from 30 to 80 mol %, more preferably from 35 to 75 mol %, still more preferably from 40 to 70 mol %, based on the entire polycarbonate copolymer.

The copolymer above may comprise a combination of two or more kinds of repeating units represented by formula (A) and a combination of two or more kinds of repeating units represented by formula (B).

Here, the molar ratio above can be determined based on the entire polycarbonate bulk constituting the optical film, by using, for example, a nuclear magnetic resonance (NMR) apparatus.

The polycarbonate copolymer above can be produced by a known method. The polycarbonate is preferably produced by a method utilizing the polycondensation of a dihydroxy compound with phosgene, a melt polycondensation method or the like.

The intrinsic viscosity of the polycarbonate copolymer is preferably from 0.3 to 2.0 dl/g. If the intrinsic viscosity is less than 0.3, the polymer disadvantageously becomes brittle and cannot maintain the mechanical strength, whereas if it exceeds 2.0, the viscosity of the solution is excessively elevated and there arises a problem such as generation of die line in the solution film formation or difficulty of purification at the end of polymerization.

The optical film of the present invention may be a composition (blend) of the above-described polycarbonate copolymer and other polymer compounds. In this case, since the optical film needs to be optically transparent, it is preferred that the polymer compound is compatible with the polycarbonate copolymer or the refractive index is nearly the same among respective polymers. Other specific examples of the polymer include a poly(styrene-comaleic anhydride). The compositional ratio of the polycarbonate copolymer and the polymer compound is from 30 to 80 mass % of polycarbonate copolymer with from 20 to 70 mass % of polymer compound, preferably from 40 to 80 mass % of polycarbonate copolymer with from 20 to 60 mass % of polymer compound. Also in the case of a blend, each repeating unit of the polycarbonate copolymer may be a combination of two or more kinds thereof. The blend is preferably a compatible blend, but even if the components are not completely compatibilized with each other, when the refractive index is made equal among the components, it is possible to suppress the scattering of light from component to component and enhance the transparency. The blend may a combination of three or more kinds of materials, and a plurality of kinds of polycarbonate copolymers and other polymer compounds can be combined.

The mass average molecular weight of the polycarbonate copolymer is from 1,000 to 1,000,000, preferably from 5,000 to 500,000. The mass average molecular weight of the other polymer compound is from 500 to 100,000, preferably from 1,000 to 50,000.

Examples of the polymer resin having a cyclic olefin structure (hereinafter sometimes referred to as a “cyclic polyolefin-based resin” or a “cyclic polyolefin”) include (1) a norbornene-based resin, (2) a monocyclic olefin polymer, (3) a cyclic conjugated diene polymer, (4) a vinyl alicyclic hydrocarbon polymer, and hydrides of (1) to (4). The polymer for use in the present invention is preferably an addition (co)polymer cyclic polyolefin containing at least one repeating unit represented by the following formula (II) or an addition (co)polymer cyclic polyolefin optionally further containing at least one repeating unit represented by formula (I), if desired. An addition (co)polymer (including a ring-opening (co)polymer) containing at least one cyclic repeating unit represented by formula (III) may also be suitably used. Furthermore, an addition (co)polymer cyclic polyolefin containing at least one repeating unit represented by the formula (III) and, if desired, further containing at least one repeating unit represented by formula (I) may also be preferably used.

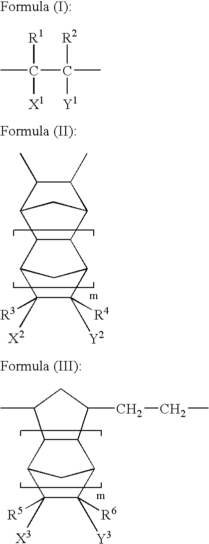

In the formulae, m represents an integer of 0 to 4. R¹ to R⁶ each represents a hydrogen atom or a hydrocarbon group having a carbon number of 1 to 10. X¹ to X³ and Y¹ to Y³ each represents a hydrogen atom, a hydrocarbon group having a carbon number of 1 to 10, a halogen atom, a halogen atom-substituted hydrocarbon group having a carbon number of 1 to 10, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O or (—CO)₂NR¹⁵ constituted by X¹ and Y¹, X² and Y², or X³ and Y³. Here, R¹¹, R¹², R¹³, R¹⁴ and R¹⁵ each represent a hydrogen atom or a hydrocarbon group having a carbon number of 1 to 20, Z represents a hydrocarbon group or halogen-substituted hydrocarbon group, W represents SiR¹⁶ₚD₃₋ₚ (where in R¹⁶ repeating unit a hydrocarbon group having a carbon number of 1 to 10, D represents a halogen atom, —OCOR¹⁶ or —OR¹⁶, and p represents an integer of 0 to 3), and n represents an integer of 0 to 10.

By virtue of introducing a functional group having large polarity for the substituents X¹ to X³ and Y¹ to Y³, the retardation (Rth) in the thickness direction of the optical film can be made large and the developability of in-plane retardation (Re) can be increased. The Re value of the film having large Re developability can be enlarged by stretching the film in the film formation process.

The norbornene-based addition (co)polymer is disclosed, for example, in JP-A-10-7732, JP-T-2002-504184 (the term (the term “JP-T” as used herein means a “published Japanese translation of a PCT patent application”), US2004229157A1 and WO2004/070463A1, and this polymer can be obtained by the addition polymerization of norbornene-based polycyclic unsaturated compounds to each other. If desired, a norbornene-based polycyclic unsaturated compound may be addition-polymerized with a conjugated diene such as ethylene, propylene, butene, butadiene and isoprene; a non-conjugated diene such as ethylidene norbornene; or a linear diene compound such as acrylonitrile, acrylic acid, methacrylic acid, maleic anhydride, acrylic acid ester, methacrylic acid ester, maleimide, vinyl acetate and vinyl chloride. This norbornene-based addition (co)polymer is commercially available under the trade name of APEL from Mitsui Chemicals, Inc., including various grades differing in the glass transition temperatures (Tg), such as APL 8008T (Tg: 70° C.), APL 6013T (Tg: 125° C.) and APL 6015T (Tg: 145° C.). Also, pellets such as TOPAS 8007, TOPAS 6013 and TOPAS 6015 are commercially available from Polyplastics Co., Ltd. Furthermore, Appear 3000 is commercially available from Ferrania Company.

The norbornene-based polymer hydride is produced by subjecting a polycyclic unsaturated compound to addition polymerization or ring-opening metathesis polymerization and then to hydrogenation as disclosed, for example, in JP-A-1-240517, JP-A-7-196736, JP-A-60-26024, JP-A-62-19801, JP-A-2003-159767 and JP-A-2004-309979. In the norbornene-based polymer for use in the present invention, R⁵ and R⁶ each is preferably a hydrogen atom or —CH₃, X³ and Y³ each is preferably a hydrogen atom, Cl or —COOCH₃, and other substituents are appropriately selected. This norbornene-based resin is commercially available under the trade name of Arton G or Arton F from JSR Corp. or under the trade name of Zeonor ZF14, ZF16, Zeonex 250 or Zeonex 280 from Zeon Corp., and these products can be used.

### (Retardation Developer)

The optical film of the present invention preferably contains a retardation developer

(a) Method for Controlling Re

In order to control the Re absolute value of the optical film of the present invention, a compound of which maximum absorption wavelength (λmax) is shorter than 250 nm in the ultraviolet absorption spectrum of the solution is preferably used as the retardation developer. By virtue of using such a compound, the absolute value can be controlled virtually without changing the wavelength dependency of Re in the visible region.

The “retardation developer” as used herein means an “additive” ensuring that the Re of an optical film containing a certain additive, as measured with light at a wavelength of 550 nm, takes a value 20 nm or more higher than the Re of an optical film produced thoroughly in the same manner except for not containing the additive, as measured with light at a wavelength of 550 nm (when reduced to a 80 μm-thick film). The increment of Re is preferably 30 nm or more, more preferably 40 nm or more, and most preferably 60 nm or more.

In view of function of the retardation developer, a rod-like compound is preferred, and the compound preferably contains at least one aromatic ring, more preferably at least two aromatic rings.

The rod-like compound preferably has a linear molecular structure. The term “linear molecular structure” means that the molecular structure of the rod-like compound is linear in a thermodynamically most stable configuration. The thermodynamically most stable configuration can be determined by crystal structure analysis or molecular orbital calculation. For example, the molecular orbital calculation is performed using a software program for molecular orbital calculation (e.g., WinMOPAC2000, produced by Fujitsu Ltd.), whereby a molecular structure capable of minimizing the heat of formation of the compound can be determined. The expression “the molecular structure is linear” means that the angle of the molecular structure is 140° or more in the thermodynamically most stable configuration determined by calculation as above.

The rod-like compound preferably exhibits liquid crystallinity. The rod-like compound more preferably comes to exhibit liquid crystallinity when heated (has thermotropic liquid crystallinity). The liquid crystal phase is preferably a nematic phase or a smectic phase.

Preferred compounds are described in JP-A-2004-4550, but the present invention is not limited thereto. Two or more kinds of rod-like compounds with the maximum absorption wavelength (λmax) being shorter than 250 nm in the ultraviolet absorption spectrum of the solution may be used in combination.

The rod-like compound can be synthesized by referring to the method described in publications. Examples of the publication include Mol. Cryst. Lig. Cryst., Vol. 53, page 229 (1979), ibid., Vol. 89, page 93 (1982), ibid., Vol. 145, page 111 (1987), ibid., Vol. 170, page 43 (1989), J. Am. Chem. Soc., Vol. 113, page 1349 (1991), ibid., Vol. 118, page 5346 (1996), ibid., Vol. 92, page 1582 (1970), J. Org. Chem., Vol. 40, page 420 (1975), and Tetrahedron, Vol. 48, No. 16, page 3437 (1992).

When the cellulose acylate is used as a raw material, the amount of the retardation developer added is preferably from 0.1 to 30 mass %, more preferably from 0.5 to 20 mass %, based on the amount of cellulose acylate.

(b) Method for Controlling Rth

In order to develop the desired Rth, a retardation raising agent is preferably used.

The “retardation developer” as used herein means an “additive” ensuring that the Rth of an optical film containing a certain additive, as measured at a wavelength of 550 nm, takes a value 20 nm or more higher than the Rth of an optical film produced thoroughly in the same manner except for not containing the additive, as measured at a wavelength of 550 nm (when reduced to a 80 μm-thick film). The increment of Rth is preferably 30 nm or more, more preferably 40 nm or more, and most preferably 60 nm or more.

The retardation developer is preferably a compound having at least two aromatic rings. Two or more kinds of retardation developers may be used in combination.

The retardation developer preferably has a maximum absorption in the wavelength region of 250 to 400 nm and preferably has substantially no absorption in the visible region.

The retardation developer for controlling Rth preferably has no effect on Re which is developed by stretching, and a discotic compound is preferably used.

The discotic compound preferably contains an aromatic heterocyclic ring in addition to an aromatic hydrocarbon ring, and the aromatic hydrocarbon ring is more preferably a 6-membered ring (i.e., benzene ring).

The aromatic heterocyclic ring is generally an unsaturated heterocyclic ring. The aromatic heterocyclic ring is preferably a 5-membered ring, a 6-membered ring or a 7-membered ring, more preferably a 5-membered ring or a 6-membered ring. The aromatic heterocyclic ring generally has a largest number of double bonds. The heteroatom is preferably a nitrogen atom, an oxygen atom or a sulfur atom, more preferably a nitrogen atom. Examples of the aromatic heterocyclic ring include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyrane ring, a pyridine ring, a pyridazine ring, a pyrimidine ring, a pyrazine ring and a 1,3,5-triazine ring.

Preferred examples of the aromatic ring include a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring, with a 1,3,5-triazine ring being more preferred. Specifically, the compounds disclosed, for example, in JP-A-2001-166144 are preferably used.

When the cellulose acylate is used as a raw material, the aromatic compound is used in an amount of 0.01 to 20 parts by mass per 100 parts by mass of the cellulose acylate. The aromatic compound is preferably used in an amount of 0.05 to 15 parts by mass, more preferably from 0.1 to 10 parts by mass, per 100 parts by mass of the cellulose acylate. Two or more kinds of the compounds may be used in combination.

(c) Method for Controlling Rth: Method by Optically Anisotropic Layer

As for the method of controlling Rth without affecting Re which is developed by stretching, a method of coating and providing an optically anisotropic layer by a liquid crystal layer or the like is preferably used.

Specific examples of the method of providing a liquid crystal layer include a method of aligning discotic liquid crystals such that the discotic plane thereof makes an angle of 5° or less with the optical film plane (see, JP-A-10-312166), and a method of aligning rod-like liquid crystals such that the long axis thereof makes an angle of 5° or less with the optical film plane (see, JP-A-2000-304932).

The optical film having an optically anisotropic layer (sometimes referred to as an optically-compensatory film) contributes to enlarging the viewing angle contrast of a liquid crystal display device, particularly, an OCB-mode or VA-mode liquid crystal display device, and reducing the color shift dependent on the viewing angle. The optically-compensatory film may be disposed between the viewer-side polarizing plate and the liquid crystal cell, may be disposed between the backside polarizing plate and the liquid crystal cell, or may be disposed in both. For example, the optically-compensatory film may be incorporated as an independent member into a liquid crystal display device or may be incorporated as one member of the polarizing plate into a liquid crystal display device by imparting optical properties to a protective film protecting the polarizing film and allowing the protective film to function also as a transparent film. An orientation film for controlling the alignment of liquid crystalline compound in the optically anisotropic layer may be provided between the optical film and the optically anisotropic layer. Furthermore, as long as the optical properties described later are satisfied, the optical film and the optically anisotropic layer each may comprise two or more layers. The optically anisotropic layer is described in detail below by referring to a case of using a cellulose acylate film for the optical film.

### [Optically Anisotropic Layer]

The optically anisotropic layer may be formed directly on the surface of the cellulose acylate film, or after forming an orientation film on the cellulose acylate film, the optically anisotropic layer may be formed on the orientation film. It is also possible to form a liquid crystalline compound layer on a separate substrate and transfer the liquid crystalline compound layer onto the cellulose acylate film by using a pressure-sensitive adhesive, an adhesive or the like.

The liquid crystalline compound used for forming the optically anisotropic layer includes a rod-like liquid crystalline compound and a disc-like liquid crystalline compound (hereinafter, the disc-like liquid crystalline compound is sometimes referred to as a “discotic liquid crystalline compound”). The rod-like liquid crystalline compound and discotic liquid crystalline compound each may be a high molecular liquid crystal or a low molecular liquid crystal. Also, the compound finally contained in the optically anisotropic layer need not exhibit liquid crystallinity any more. For example, in the case of using a low molecular liquid crystalline compound for the production of an optically anisotropic layer, an embodiment that the compound is crosslinked in the process of forming the optically anisotropic layer and does not exhibit liquid crystallinity may also be employed.

### (Rod-Like Liquid Crystalline Compound)

Preferred examples of the rod-like liquid crystalline compound which can be used in the present invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. A metal complex is also included in the rod-like liquid crystalline compound. Furthermore, a liquid crystal polymer containing a rod-like liquid crystalline compound in a repeating unit may be also used. In other words, the rod-like liquid crystalline compound may be bonded to a (liquid crystal) polymer.

The rod-like liquid crystalline compound is described in Kikan Kagaku-Sosetsu (General Chemistry Quarterly), Vol. 22, “Ekisho no Kagaku (Liquid Crystal Chemistry)”, Chapters 4, 7 and 11 (1994), compiled by The Chemical Society of Japan; and Ekisho Devise Handbook (Liquid Crystal Device Handbook)”, Chapter 3, compiled by Japan Society for the Promotion of Science, the 142th Committee.

The birefringent index of the rod-like liquid crystalline compound for use in the present invention is preferably from 0.001 to 0.7.

The rod-like liquid crystalline compound preferably has a polymerizable group for fixing its aligned state. The polymerizable group is preferably an unsaturated polymerizable group or an epoxy group, more preferably an unsaturated polymerizable group, and most preferably an ethylenically unsaturated polymerizable group.

### (Discotic Liquid Crystalline Compound)

The discotic liquid crystalline compound includes benzene derivatives described in C. Destrade, et al., Mol. Cryst., Vol. 71, page 111, (1981); truxene derivatives described in C. Destrade, et al., Mol. Cryst., Vol. 122, page 141 (1985) and Physics lett., A, Vol. 78, page 82 (1990); cyclohexane derivatives described in B. Kohne, et al., Angew. Chem., Vol. 96, page 70 (1984); and azacrown-based or phenylacetylene-based macrocycles described in J. M. Lehn, et al., J. Chem. Commun., page 1794, (1985), and J. Zhang, et al., J. Am. Chem. Soc., Vol. 116, page 2655 (1994).

The discotic liquid crystalline compound also includes a compound which has a structure that to a mother nucleus in the center of the molecule, a linear alkyl group, an alkoxy group or a substituted benzoyloxy group is radially substituted as a side chain of the mother nucleus and which exhibits liquid crystallinity. A compound where a molecule or an aggregate of molecules has a rotation symmetry and can impart a certain alignment, is preferred.

As described above, when the optically anisotropic layer is formed of a liquid crystalline compound, the compound finally contained in the optically anisotropic layer need not exhibit liquid crystallinity any more. For example, in the case where a low molecular discotic liquid crystalline molecule having a group capable of reacting under the action of heat or light is polymerized or crosslinked to have a high molecular weight resulting from the reaction under the action of heat or light and an optically anisotropic layer is thereby formed, the compound contained in the optically anisotropic layer may lose the liquid crystallinity. Preferred examples of the discotic liquid crystalline compound are described in JP-A-8-50206. The polymerization of the discotic liquid crystalline compound is described in JP-A-8-27284.

In order to immobilize the discotic liquid crystalline compound by polymerization, a polymerizable group need to be bonded as a substituent to the discotic core of the discotic liquid crystalline compound. However, when the polymerizable group is bonded directly to the discotic core, it is difficult to keep the aligned state during the polymerization reaction. Therefore, a linking group is preferably introduced between the discotic core and the polymerizable group.

In the present invention, the aligned state of molecules of the rod-like compound or discotic compound is fixed in the optically anisotropic layer. The average orientation direction at the interface on the optical film side of the molecular symmetry axis of the liquid crystalline compound intersects the in-plane slow axis of the optical film at an angle of about 45°. The term “about 45°” as used in the present invention means an angle falling within the range of 45°±5°, and the angle is preferably from 42 to 48°, more preferably from 43 to 47°.

The average orientation direction of the molecular symmetry axis of the liquid crystalline compound can be generally adjusted by selecting the liquid crystalline compound or the material for the orientation film or by selecting the rubbing method.

In the present invention, for example, in the case of producing an optically-compensatory film for OCB mode, an orientation film for forming an optically anisotropic layer is produced by rubbing and the rubbing treatment is performed in the direction of 45° with respect to the slow axis of the cellulose acylate film, whereby an optically anisotropic layer in which the average orientation direction of the molecular symmetry axis of the liquid crystalline compound at least at the interface with the cellulose acylate film interface makes an angle of 45° with respect to the in-plane slow axis of the cellulose acylate film, can be formed.

For example, when the cellulose acylate film with the slow axis being crossing at right angles with the longitudinal direction is used as a lengthy film, the optically-compensatory film can be continuously produced. More specifically, a film is produced by applying a coating solution for the formation of an orientation film to the surface of the cellulose acylate film as a lengthy film, an orientation film is then produced by continuously applying a rubbing treatment at 45° in the longitudinal direction to the surface of the film produced above, a coating solution for the formation of an optically anisotropic layer, which contains a liquid crystalline compound, is further continuously coated on the orientation film produced above, and the molecules of the liquid crystalline compound are aligned and fixed in this state to form an optically anisotropic layer, whereby a lengthy optically-compensatory film can be continuously produced. The optically-compensatory film produced as a lengthy film is cut into a desired shape before it is incorporated into a liquid crystal display device.

As regards the average orientation direction of the molecular symmetry axis of the liquid crystal compound on the surface side (air side), the average orientation direction of the molecular symmetry axis of the liquid crystalline compound on the air interface side is preferably about 45°, more preferably from 42 to 48°, still more preferably from 43 to 47°, with respect to the slow axis of the cellulose acylate film. The average orientation direction of the molecular symmetry axis of the liquid crystal compound on the air interface side can be generally adjusted by selecting the liquid crystalline compound or the kind of the additive used together with the liquid crystalline compound. Examples of the additive used together with the liquid crystalline compound include a plasticizer, a surfactant, a polymerizable monomer and a polymer. The extent of change in the orientation direction of the molecular symmetry axis can also be adjusted by selecting the liquid crystalline compound and the additive, similarly to above. In particular, the surfactant preferably enables both this adjustment and the control of the surface tension of the above-described coating solution.

The plasticizer, surfactant and polymerizable monomer used together with the liquid crystalline compound are preferably compatible with the discotic liquid crystalline compound and capable of imparting a change in the tilt angle of the liquid crystalline compound or not inhibiting the alignment. A polymerizable monomer (for example, a compound having a vinyl group, a vinyloxy group, an acryloyl group or a methacryloyl group) is preferred. The amount of such a compound added is generally from 1 to 50 mass %, preferably from 5 to 30 mass %, based on the liquid crystalline compound. Incidentally, when a mixture of monomers having 4 or more polymerizable reactive functional groups is used, the adhesion between the orientation film and the optically anisotropic layer can be elevated.

In the case of using a discotic liquid crystalline compound as the liquid crystalline compound, a polymer having a certain level of compatibility with the discotic liquid crystalline compound and capable of giving a change in the tilt angle of the discotic liquid crystalline compound is preferably used.

Examples of the polymer include a cellulose ester. Preferred examples of the cellulose ester include cellulose acetate, cellulose acetate propionate, hydroxypropyl cellulose and cellulose acetate butyrate. In order not to inhibit the alignment of the discotic liquid crystalline compound, the amount of the polymer added is preferably from 0.1 to 10 mass %, more preferably from 0.1 to 8 mass %, still more preferably from 0.1 to 5 mass %, based on the discotic liquid crystalline compound.

The discotic nematic liquid crystal phase-solid phase transition temperature of the discotic liquid crystalline compound is preferably from 70 to 300° C., more preferably from 70 to 170° C.

In the present invention, the Re(550) of the optically anisotropic layer is preferably from 0 to 300 nm, more preferably from 0 to 200 nm, still more preferably from 0 to 100 nm. The Rth(550) in the thickness direction of the optically anisotropic layer is preferably from 20 to 400 nm, more preferably from 50 to 200 nm. The thickness of the optically anisotropic layer is preferably from 0.1 to 20 microns, more preferably from 0.5 to 15 microns, and most preferably from 1 to 10 microns.

The cellulose acylate film preferably used in the present invention can be obtained by dissolving the cellulose acylate and, if desired, additives in an organic solvent and film-forming the resulting solution.

### [Additives]

Examples of the additive which can be used for the cellulose acylate solution in the present invention include a plasticizer, an ultraviolet absorbent, a deterioration inhibitor, a retardation (optical anisotropy) developer, a retardation (optical anisotropy) decreasing agent, a wavelength-dispersion adjusting agent, a dye, a fine particle, a separation accelerator and an infrared absorbent.

In the present invention, a retardation developer is preferably used. Also, at least one of a plasticizer, an ultraviolet absorbent and a separation accelerator is preferably used.

Such an additive may be a solid matter or an oily product, that is, the additive is not particularly limited in its melting point or boiling point. For example, a mixture of ultraviolet absorbents having a melting point of 20° C. or less and a melting point of 20° C. or more may be used, or the same mixture of plasticizers may be used. These are described, for example, in JP-A-2001-151901.

### [Ultraviolet Absorbent]

The ultraviolet absorbent may be freely selected according to the purpose, and an absorbent such as salicylic acid ester-based, benzophenone-based, benzotriazole-based, benzoate-based, cyanoacrylate-based and nickel complex salt-based absorbents can be used, with benzophenone-based, benzotriazole-based and salicylic acid ester-based absorbents being preferred.

Examples of the benzophenone-based ultraviolet absorbent include 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone.

Examples of the benzotriazole-based ultraviolet absorbent include 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole, 2-(2′-hydroxy-3′,5′-di-tert-butylphenyl)-5-chlorobenzotriazole and 2-(2′-hydroxy-5′-tert-octylphenyl)benzotriazole.

Examples of the salicylic acid ester-based ultraviolet absorbent include phenyl salicylate, p-octylphenyl salicylate and p-tert-butylphenyl salicylate.

Among these ultraviolet absorbents, preferred are 2-hydroxy-4-methoxybenzophenone, 2,2′-dihydroxy-4,4′-methoxybenzophenone, 2(2′-hydroxy-3′-tert-butyl-5′-methylphenyl)-5-chlorobenzotriazole, 2(2′-hydroxy-5′-tert-butylphenyl)-benzotriazole, 2(2′-hydroxy-3′,5′-di-tert-amylphenyl)benzotriazole and 2(2′-hydroxy-3′,5′-di-tert-butylphenyl)-5-chlorobenzotriazole.

As for the ultraviolet absorbent, a plurality of absorbents differing in the absorption wavelength are preferably used in combination, because a high shielding effect can be obtained over a wide wavelength range. The ultraviolet absorbent for liquid crystal preferably has excellent capability of absorbing ultraviolet light at a wavelength of 370 nm or less from the standpoint of preventing deterioration of the liquid crystal and preferably less absorbs visible light at a wavelength of 400 nm or more in view of liquid crystal display property. In particular, the ultraviolet absorbent is preferably the above-described benzotriazole-based compound, benzophenone-based compound or salicylic acid ester-based compound. Above all, a benzotriazole-based compound is preferred because of less occurrence of unnecessary coloration for the cellulose ester.

Furthermore, the compounds described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173 can also be used as the ultraviolet absorbent.

The amount of the ultraviolet absorbent added is preferably from 0.001 to 5 mass %, more preferably from 0.01 to 1 mass %, based on the cellulose acylate. When the amount added is 0.001 mass % or more, the effect by the addition can be satisfactorily brought out and this is preferred. Also, when the amount added is 5 mass % or less, the ultraviolet absorbent can be advantageously prevented from bleeding out to the film surface.

The ultraviolet absorbent may be added simultaneously at the time of dissolving the cellulose acylate or may be added to the dope after the dissolution. In particular, a mode of adding the ultraviolet absorbent solution to the dope immediately before casting by using a static mixer or the like is preferred, because the spectral absorption properties can be easily adjusted.

### [Deterioration Inhibitor]

The deterioration inhibitor can prevent deterioration or decomposition of the cellulose triacetate or the like. Examples of the deterioration inhibitor include compounds such as butylamine, hindered amine compound (JP-A-8-325537), guanidine compound (JP-A-5-271471), benzotriazole-based UV absorbent (JP-A-6-235819) and benzophenone-based UV absorbent (JP-A-6-118233).

### [Plasticizer]

The plasticizer is preferably a phosphoric acid ester or a carboxylic acid ester. Examples of the phosphoric acid ester-based plasticizer include triphenyl phosphate (TPP), tricresyl phosphate (TCP), cresyl diphenyl phosphate, octyl diphenyl phosphate, biphenyl diphenyl phosphate (BDP), trioctyl phosphate and tributyl phosphate; and examples of the carboxylic acid ester-based plasticizer include dimethyl phthalate (DMP), diethyl phthalate (DEP), dibutyl phthalate (DBP), dioctyl phthalate (DOP), diphenyl phthalate (DPP), diethylhexyl phthalate (DEHP), triethyl O-acetylcitrate (OACTE), tributyl O-acetylcitrate (OACTB), acetyltriethyl citrate, acetyltributyl citrate, butyl oleate, methylacetyl ricinoleate, dibutyl sebacate, triacetin, tributyrin, butylphthalyl butyl glycolate, ethylphthalyl ethyl glycolate, methylphthalyl ethyl glycolate and butylphthalyl butyl glycolate. The plasticizer for use in the present invention is preferably selected from these plasticizers. Furthermore, the plasticizer is preferably (di)pentaerythritol esters, glycerol esters or diglycerol esters.

### [Separation Accelerator]

Examples of the separation accelerator include ethyl esters of citric acid.

### [Infrared Absorbent]

Examples of the infrared absorbent include those described in JP-A-2001-194522.

### [Timing, etc. of Addition]

These additives may be added at any timing in the process of producing a dope, but a step of adding the additives and preparing a dope may be provided as a final preparation step in the process of preparing a dope. The amount of each material added is not particularly limited as long as its function can be exerted.

When the cellulose acylate film is a multilayer film, the kind or amount added of the additive may be different among respective layers. This is a conventionally known technique described, for example, in JP-A-2001-151902.

It is preferred that by selecting the type and the amount added of the additive, the glass transition point Tg of the cellulose acylate film measured by means of a dynamic viscoelasticity meter, “Vibron: DVA-225” {manufactured by IT Keisoku Seigyo K.K.}, is set to from 70 to 150° C. and the elastic modulus measured by means of a tensile tester, “Strograph-R2” {manufactured by Toyo Seiki Seisaku-Sho, Ltd.}, is set to from 1,500 to 4,000 MPa. More preferably, the glass transition point Tg is from 80 to 135° C. and the elastic modulus is from 1,500 to 3,000 MPa. That is, in view of suitability for the process into a polarizing plate or the process of assembling a liquid crystal display device, the cellulose acylate film preferred in the present invention is preferably set to a glass transition point Tg and an elastic modulus in the ranges above.

Furthermore, as for the additive, those described in detail in JIII Journal of Technical Disclosure, No. 2001-1745, page 16 et seq., Japan Institute of Invention and Innovation (Mar. 15, 2001) may be appropriately used.

### [Retardation Decreasing Agent]

The retardation decreasing agent used in the case of decreasing the optical anisotropy of the cellulose acylate film is described below.

By using a compound capable of inhibiting the cellulose acylate in the film from aligning in the plane and in the thickness direction, the optical anisotropy can be satisfactorily decreased and the Re and Rth can be made zero or nearly zero. For this purpose, it is advantageous that the compound for decreasing the optical anisotropy is sufficiently compatible with the cellulose acylate and the compound itself does not have a rod-like structure or a planar structure. More specifically, when the compound has a plurality of planar functional groups such as aromatic group, a structure having these functional groups not in the same plane but in a nonplanar fashion is advantageous.

The amount added of the compound for decreasing the optical anisotropy is preferably from 0.01 to 30 mass %, more preferably from 1 to 25 mass %, still more preferably from 5 to 20 mass %, based on the cellulose acylate.

One kind of the compound for decreasing the optical anisotropy may be used alone, two or more kinds of the compounds may be mixed at an arbitrary ratio and used.

### [Dye]

In the present invention, a dye for adjusting the color hue may be added. The dye content is, in terms of the mass ratio to the cellulose acylate, preferably from 10 to 1,000 ppm, more preferably from 50 to 500 ppm. By incorporating a dye in this way, light piping of the cellulose acylate film can be decreased and the yellow tint can be improved. Such a compound may be added together with the cellulose acylate or solvent at the preparation of a cellulose acylate solution or may be added during or after the preparation of the solution. Also, the compound may be added to an ultraviolet absorbent solution which is in-line added. The dyes described in JP-A-5-34858 can be used.

### [Fine Matting Agent Particle]

In the cellulose acylate film preferred in the present invention, a fine particle is preferably added as a matting agent. Examples of the fine particle for use in the present invention include silicon dioxide, titanium dioxide, aluminum oxide, zirconium oxide, calcium carbonate, calcium carbonate, talc, clay, calcined kaolin, calcined calcium silicate, hydrated calcium silicate, aluminum silicate, magnesium silicate and calcium phosphate. Among these, a fine particle containing silicon is preferred in view of giving low turbidity, and silicon dioxide is more preferred.

The fine silicon dioxide particle is preferably a fine particle having an average primary particle diameter of 20 nm or less and an apparent specific gravity of 70 g/liter or more. A fine particle having an average primary particle diameter as small as 5 to 16 nm is more preferred, because the haze of the film can be decreased. The apparent specific gravity is preferably from 90 to 200 g/liter or more, more preferably from 100 to 200 g/liter or more. As the apparent specific gravity is larger, a liquid dispersion having a higher concentration can be prepared and this is preferred in view of haze and aggregate.

In the case of using a fine silicon dioxide particle as the matting agent, the amount used thereof is preferably from 0.01 to 0.3 parts by mass per 100 parts by mass of polymer components including cellulose acylate.

The fine particle usually forms a secondary particle having an average particle diameter of 0.1 to 3.0 μm and in the film, this particle is present as an aggregate of primary particles to form irregularities of 0.1 to 3.0 μm on the film surface. The average particle diameter of the secondary particle is preferably from 0.2 to 1.5 μm, more preferably from 0.4 to 1.2 μm, and most preferably from 0.6 to 1.1 μm. When this average particle diameter is 1.5 μm or less, excessively strong haze is not caused, and when the average particle diameter is 0.2 μm or more, the effect of preventing creak can be satisfactorily exerted and this is preferred.

As for the primary and secondary particle diameters of the fine particle, particles in the film are observed through a scanning electron microscope and the diameter of a circle circumscribing a particle is defined as the particle diameter. Also, 200 particles at different places are observed and the average value thereof is defined as the average particle diameter.

The fine silicon dioxide particle may be a commercially available product such as “Aerosil” R972, R972V, R974, R812, 200, 200V, 300, R202, OX50 and TT600 {all produced by Nihon Aerosil Co., Ltd.}. The fine zirconium oxide particle is commercially available under the trade name of, for example, “Aerosil” R976 or R811 {both produced by Nihon Aerosil Co., Ltd.}, and these may be used.

Among these, “Aerosil 200V” and “Aerosil R972V” are preferred because these are a fine silicon dioxide particle having an average primary particle diameter of 20 nm or less and an apparent specific gravity of 70 g/liter or more and provide a high effect of decreasing the coefficient of friction while maintaining low turbidity of the optical film.

In the present invention, in order to obtain a cellulose acylate film containing particles having a small average secondary particle diameter, several techniques may be considered at the preparation of a liquid dispersion of fine particles. For example, in one method, a solvent and fine particles are mixed with stirring to previously prepare a liquid dispersion of fine particles, the obtained liquid dispersion of fine particles is added to a slight amount of a separately prepared cellulose acylate solution and then dissolved with stirring, and the resulting solution is further mixed with a main cellulose acylate dope solution. This preparation method is preferred in that dispersibility of fine silicone dioxide particles is good and re-aggregation of fine silicon dioxide particles scarcely occurs. In another method, a slight amount of a cellulose ester is added to a solvent and dissolved with stirring, fine particles are added thereto and dispersed by a disperser to obtain a fine particle-added solution, and the fine particle-added solution is thoroughly mixed with a dope solution by an in-line mixer. The present invention is not limited to these methods, but at the time of mixing fine silicon dioxide particles with a solvent and dispersing the solution, the concentration of silicon dioxide is preferably from 5 to 30 mass %, more preferably from 1 to 25 mass %, and most preferably from 15 to 20 mass %. A higher dispersion concentration is preferred because the liquid turbidity for the amount added becomes low and the haze and aggregate are eliminated. In the final dope solution of cellulose acylate, the amount of the matting agent added is preferably from 0.01 to 1.0 g/m², more preferably from 0.03 to 0.3 g/m², and most preferably from 0.08 to 0.16 g/m².

As for the solvent used here, preferred examples of the lower alcohols include methyl alcohol, ethyl alcohol, propyl alcohol, isopropyl alcohol and butyl alcohol. The solvents other than the lower alcohol are not particularly limited, but the solvent used at the film formation of cellulose ester is preferably used.

The organic solvent in which the cellulose acylate preferably used in the present invention is dissolved is described below.

In the present invention, the organic solvent may be either a chlorine-based solvent using a chlorine-based organic solvent as the main solvent, or a chlorine-free solvent not containing a chlorine-based organic solvent.

### [Chlorine-Based Solvent]

At the preparation of a solution of cellulose acylate preferred in the present invention, a chlorine-based organic solvent is preferably used as the main solvent. In the present invention, the kind of the chlorine-based organic solvent is not particularly limited as long as its purpose can be achieved and the cellulose acylate can be dissolved, cast and film-formed. The chlorine-based organic solvent is preferably dichloromethane or chloroform, more preferably dichloromethane. An organic solvent other than a chlorine-based organic solvent may also be mixed without any particular problem. In this case, dichloromethane is preferably used to occupy at least 50 mass % in the entire amount of organic solvents.

The other organic solvent used in combination with the chlorine-based organic solvent in the present invention is described below.

The other organic solvent is preferably a solvent selected from an ester, a ketone, an ether, an alcohol, a hydrocarbon and the like each having a carbon number of 3 to 12. The ester, ketone, ether and alcohol each may have a cyclic structure. A compound having two or more functional groups of an ester, a ketone and an ether (that is, —O—, —CO— and —COO—) may also be used as the solvent, and the compound may have another functional group such as alcoholic hydroxyl group at the same time. In the case of a solvent having two or more kinds of functional groups, the number of carbon atoms may suffice if it falls within the range specified for the compound having any one functional group. Examples of the esters having a carbon number of 3 to 12 include ethyl formate, propyl formate, pentyl formate, methyl acetate, ethyl acetate and pentyl acetate. Examples of the ketones having a carbon number of 3 to 12 include acetone, methyl ethyl ketone, diethyl ketone, diisobutyl ketone, cyclopentanone, cyclohexanone and methylcyclohexanone. Examples of the ethers having a carbon number of 3 to 12 include diisopropyl ether, dimethoxymethane, dimethoxyethane, 1,4-dioxane, 1,3-dioxolane, tetrahydrofuran, anisole and phenetole. Examples of the organic solvent having two or more kinds of functional groups include 2-ethoxyethyl acetate, 2-methoxyethanol and 2-butoxyethanol.

The alcohol preferably used in combination with the chlorine-based organic solvent may be linear, branched or cyclic. In particular, a saturated aliphatic hydrocarbon is preferred. The hydroxyl group of the alcohol may be primary, secondary or tertiary. Examples of the alcohol include methanol, ethanol, 1-propanol, 2-propanol, 1-butanol, 2-butanol, tert-butanol, 1-pentanol, 2-methyl-2-butanol and cyclohexanol. Also, a fluorine-based alcohol may be used as the alcohol. Examples thereof include 2-fluoroethanol, 2,2,2-trifluoroethanol and 2,2,3,3-tetrafluoro-1-propanol. The hydrocarbon may be linear, branched or cyclic, and either an aromatic hydrocarbon or an aliphatic hydrocarbon can be used. The aliphatic hydrocarbon may be saturated or unsaturated. Examples of the hydrocarbon include cyclohexane, hexane, benzene, toluene and xylene.

Examples of the combination of a chlorine-based organic solvent with other organic solvents include, but are not limited to, the following compositions:

dichloromethane/methanol/ethanol/butanol (80/10/5/5, parts by mass),

dichloromethane/acetone/methanol/propanol (80/10/5/5, parts by mass)

dichloromethane/methanol/butanol/cyclohexane (80/10/5/5, parts by mass),

dichloromethane/methyl ethyl ketone/methanol/butanol (80/10/5/5, parts by mass),

dichloromethane/acetone/methyl ethyl ketone/ethanol/isopropanol (75/8/5/5/7, parts by mass)

dichloromethane/cyclopentanone/methanol/isopropanol (80/7/5/8, parts by mass),

dichloromethane/methyl acetate/butanol (80/10/10, parts by mass),

dichloromethane/cyclohexanone/methanol/hexane (70/20/5/5, parts by mass),

dichloromethane/methyl ethyl ketone/acetone/methanol/ethanol (50/20/20/5/5, parts by mass),

dichloromethane/1,3-dioxolane/methanol/ethanol (70/20/5/5, parts by mass),

dichloromethane/dioxane/acetone/methanol/ethanol (60/20/10/5/5, parts by mass),

dichloromethane/acetone/cyclopentanone/ethanol/isobutanol/cyclohexane (65/10/10/5/5/5, parts by mass),

dichloromethane/methyl ethyl ketone/acetone/methanol/ethanol (70/10/10/5/5, parts by mass),

dichloromethane/acetone/ethyl acetate/ethanol/butanol/hexane (65/10/10/5/5/5, parts by mass),

dichloromethane/methyl acetoacetate/methanol/ethanol (65/20/10/5, parts by mass), and

dichloromethane/cyclopentanone/ethanol/butanol (65/20/10/5, parts by mass).

### [Chlorine-Free Solvent]

The chlorine-free organic solvent preferably used at the preparation of a solution of cellulose acylate preferably used in the present invention is described below. In the present invention, the chlorine-free organic solvent is not particularly limited as long as its purpose can be achieved and the cellulose acylate can be dissolved, cast and film-formed. The chlorine-free organic solvent for use in the present invention is preferably a solvent selected from an ester, a ketone and an ether each having a carbon number of 3 to 12. The ester, ketone and ether each may have a cyclic structure. A compound having two or more functional groups of an ester, a ketone and an ether (that is, —O—, —CO— and —COO—) may also be used as the main solvent, and the compound may have another functional group such as alcoholic hydroxyl group. In the case of a main solvent having two or more kinds of functional groups, the number of carbon atoms may suffice if it falls within the range specified for the compound having any one of the functional groups. Examples of the esters having a carbon number of 3 to 12 include ethyl formate, propyl formate, pentyl formate, methyl acetate, ethyl acetate and pentyl acetate. Examples of the ketones having a carbon number of 3 to 12 include acetone, methyl ethyl ketone, diethyl ketone, diisobutyl ketone, cyclopentanone, cyclohexanone, methylcyclohexanone and methyl acetylacetate. Examples of the ethers having a carbon number of 3 to 12 include diisopropyl ether, dimethoxymethane, dimethoxyethane, 1,4-dioxane, 1,3-dioxolane, tetrahydrofuran, anisole and phenetole. Examples of the organic solvent having two or more kinds of functional groups include 2-ethoxyethyl acetate, 2-methoxyethanol and 2-butoxyethanol.

The chlorine-free organic solvent used for cellulose acylate is selected from various aspects described above, but is preferably as follows.

The chlorine-free solvent is preferably a mixed solvent using the above-described chlorine-free organic solvent as the main solvent, which is a mixed solvent comprising three or more different kinds of solvents and in which the first solvent is at least one member selected from methyl acetate, ethyl acetate, methyl formate, ethyl formate, acetone, dioxolane and dioxane, or a mixed solution thereof, the second solvent is selected from ketones having a carbon number of 4 to 7 and acetoacetic acid esters, and the third solvent is selected from alcohols having a carbon number of 1 to 10 and hydrocarbons, preferably from alcohols having a carbon number of 1 to 8. When the first solvent is a mixed solution of two or more kinds of solvents, the second solvent may be omitted. The first solvent is preferably methyl acetate, acetone, methyl formate, ethyl formate or a mixture thereof, and the second solvent is preferably methyl ethyl ketone, cyclopentanone, cyclohexanone or methyl acetylacetate and may be a mixed solvent thereof.

In the alcohol as the third solvent, the hydrocarbon chain may be linear, branched or cyclic, and a saturated aliphatic hydrocarbon chain is preferred. The hydroxyl group of the alcohol may be primary, secondary or tertiary. Examples of the alcohol include methanol, ethanol, 1-propanol, 2-propanol, 1-butanol, 2-butanol, tert-butanol, 1-pentanol, 2-methyl-2-butanol and cyclohexanol. Also, a fluorine-based alcohol with the hydrogen of the hydrocarbon chain being partially or entirely replaced by fluorine may be used as the alcohol. Examples thereof include 2-fluoroethanol, 2,2,2-trifluoroethanol and 2,2,3,3-tetrafluoro-1-propanol.

The hydrocarbon may be linear, branched or cyclic, and either an aromatic hydrocarbon or an aliphatic hydrocarbon can be used. The aliphatic hydrocarbon may be either saturated or unsaturated. Examples of the hydrocarbon include cyclohexane, hexane, benzene, toluene and xylene.

These alcohols and hydrocarbons as the third solvent may be used individually or as a mixture of two or more kinds thereof and this is not particularly limited. Specific preferred compounds of the alcohol as the third solvent include methanol, ethanol, 1-propanol, 2-propanol, 1-butanol, 2-butanol and cyclohexanol, and specific preferred examples of the hydrocarbon include cyclohexane and hexane. Among these, more preferred are methanol, ethanol, 1-propanol, 2-propanol and 1-butanol.

The mixing ratio of these three kinds of solvents is, based on the entire amount of the mixed solvent, preferably such that the first solvent is from 20 to 95 mass %, the second solvent is from 2 to 60 mass % and the third solvent is from 2 to 30 mass %, more preferably such that the first solvent is from 30 to 90 mass %, the second solvent is from 3 to 50 mass % and the alcohol as the third solvent is from 3 to 25 mass %, still more preferably such that the first solvent is from 30 to 90 mass %, the second solvent is from 3 to 30 mass % and the third solvent is an alcohol and occupies from 3 to 15 mass %.

The chlorine-free organic solvent for use in the present invention is described in more detail in JIII Journal of Technical Disclosure, No. 2001-1745, pp. 12-16, Japan Institute of Invention and Innovation (Mar. 15, 2001).

Preferred examples of the combination of chlorine-free organic solvents for use in the present invention include, but are not limited to, the following compositions:

methyl acetate/acetone/methanol/ethanol/butanol (75/10/5/5/5, parts by mass),

methyl acetate/acetone/methanol/ethanol/propanol (75/10/5/5/5, parts by mass),

methyl acetate/acetone/methanol/butanol/cyclohexane (75/10/5/5/5, parts by mass),

methyl acetate/acetone/ethanol/butanol (81/8/7/4, parts by mass),

methyl acetate/acetone/ethanol/butanol (82/10/4/4, parts by mass),

methyl acetate/acetone/ethanol/butanol (80/10/4/6, parts by mass),

methyl acetate/methyl ethyl ketone/methanol/butanol (80/10/5/5, parts by mass),

methyl acetate/acetone/methyl ethyl ketone/ethanol/isopropanol (75/8/5/5/7, parts by mass),

methyl acetate/cyclopentanone/methanol/isopropanol (80/7/5/8, parts by mass),

methyl acetate/acetone/butanol (85/10/5, parts by mass),

methyl acetate/cyclopentanone/acetone/methanol/butanol (60/15/14/5/6, parts by mass),

methyl acetate/cyclohexanone/methanol/hexane (70/20/5/5, parts by mass),

methyl acetate/methyl ethyl ketone/acetone/methanol/ethanol (50/20/20/5/5, parts by mass),

methyl acetate/1,3-dioxolane/methanol/ethanol (70/20/5/5, parts by mass),

methyl acetate/dioxolane/acetone/methanol/ethanol (60/20/10/5/5, parts by mass),

methyl acetate/acetone/cyclopentanone/ethanol/isobutanol/cyclohexane (65/10/10/5/5/5, parts by mass),

methyl formate/methyl ethyl ketone/acetone/methanol/ethanol (50/20/20/5/5, parts by mass),

methyl formate/acetone/ethyl acetate/ethanol/butanol/hexane (65/10/10/5/5/5, parts by mass),

acetone/methyl acetoacetate/methanol/ethanol (65/20/10/5, parts by mass),

acetone/cyclopentanone/ethanol/butanol (65/20/10/5, parts by mass),

acetone/1,3-dioxolane/ethanol/butanol (65/20/10/5, parts by mass), and

1,3-dioxolane/cyclohexanone/methyl ethyl ketone/methanol/butanol (55/20/10/5/5/5, parts by mass).

Furthermore, a cellulose acylate solution prepared by the following method may also be used:

a method of preparing a cellulose acylate solution from methyl acetate/acetone/ethanol/butanol (81/8/7/4, parts by mass), filtering and concentrating the solution and then additionally adding 2 parts by mass of butanol;

a method of preparing a cellulose acylate solution from methyl acetate/acetone/ethanol/butanol (84/10/4/2, parts by mass), filtering and concentrating the solution and then additionally adding 4 parts by mass of butanol; and

a method of preparing a cellulose acylate solution from methyl acetate/acetone/ethanol (84/10/6, parts by mass), filtering and concentrating the solution and then additionally adding 5 parts by mass of butanol.

In addition to the above-described chlorine-free organic solvent of the present invention, the dope for use in the present invention may contain dichloromethane in an amount of 10 mass % or less based on the entire amount of organic solvents used in the present invention.

### [Properties of Cellulose Acylate Solution]

In view of suitability for film formation by casting, the cellulose acylate solution is preferably a solution prepared by dissolving a cellulose acylate in the above-described organic solvent to a concentration of 10 to 30 mass %, more preferably from 13 to 27 mass %, still more preferably from 15 to 25 mass %. With respect to the method for adjusting the cellulose acylate concentration to such a range, the adjustment to a predetermined concentration may be performed at the stage of dissolving the cellulose acylate, or after previously preparing a low-concentration (for example, from 9 to 14 mass %) solution, the solution may be adjusted to a predetermined high concentration in the concentration step described later. Furthermore, a high-concentration cellulose acylate solution may be previously prepared and then formulated into a cellulose acylate solution having a predetermined low concentration by adding various additives. Any of these methods may be used without problem as long as the cellulose acylate solution concentration preferred in the present invention can be obtained.

In the present invention, when the cellulose acylate solution is diluted to a concentration of 0.1 to 5 mass % by an organic solvent having the same composition, in view of solubility in a solvent, the aggregate molecular weight of cellulose acylate in the resulting diluted solution is preferably from 150,000 to 15,000,000, more preferably from 180,000 to 9,000,000. The aggregate molecular weight can be determined by a static light scattering method. The cellulose acylate is preferably dissolved such that the squared radius of inertia simultaneously determined by this method becomes from 10 to 200 nm. The squared radius of inertia is more preferably from 20 to 200 nm. Also, the cellulose acylate is preferably dissolved such that the second virial coefficient becomes from −2×10⁻⁴ to +4×10⁻⁴. The second virial coefficient is more preferably from −2×10⁻⁴ to +2×10⁻⁴.

The definitions of aggregate molecular weight, squared radius of inertia and second virial coefficient as used in the present invention are described below. These are measured using a static light scattering process according to the following method. For the convenience's sake of apparatus, the measurement is performed in the dilute region, but these measured values reflect the behavior of dope in the high-concentration region of the present invention.

First, solutions of 0.1 mass %, 0.2 mass %, 0.3 mass % or 0.4 mass % are prepared by dissolving cellulose acylate in a solvent which is used for the dope. Here, in order to prevent absorption of moisture, cellulose acylate dried at 120° C. for 2 hours is used and weighed at 25° C. and 10% RH. The dissolution is performed by the method employed at the dissolution of dope (ordinary temperature dissolution, cooling dissolution or high temperature dissolution). Subsequently, these solutions with solvent are filtered through a 0.2-μm Teflon-made filter, and static light scattering of each filtered solution is measured at 25° C. using a light scattering spectrophotometer “DLS-700” {manufactured by Otsuka Electronics Co., Ltd.} in 10° steps from 30° to 140°. The obtained data are analyzed by the BERRY plotting method. At this time, the value of the solvent determined by Abbe refraction system is used as the refractive index necessary for the analysis, and the concentration gradient (dn/dc) of refractive index is measured by a differential refractometer “DRM-1021” {manufactured by Otsuka Electronics Co., Ltd.} by using the solvent and solution used for the measurement of light scattering.

### [Preparation of Dope]

The preparation of the solution (dope) for casting and film formation of cellulose acylate is described below.

The method for dissolving cellulose acylate is not particularly limited, and the dissolution may be performed by a room temperature dissolution method, a cooling dissolution method, a high temperature dissolution method or a combination thereof. These dissolution methods are described as the preparation method of a cellulose acylate solution, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388.

The methods for dissolving cellulose acylate in an organic solvent described in these patent publications can be appropriately applied also in the present invention as long as it is within the scope of the present invention. In particular, as for the chlorine-free solvent system, the method described in detail in JIII Journal of Technical Disclosure, No. 2001-1745, pp. 22-25, Japan Institute of Invention and Innovation (Mar. 15, 2001) can be employed. Furthermore, the dope solution of cellulose acylate preferably used in the present invention is usually subjected to concentration and filtration of the solution, and these are similarly described in detail in JIII Journal of Technical Disclosure, No. 2001-1745, page 25, Japan Institute of Invention and Innovation (Mar. 15, 2001). In the case of performing the dissolution at a high temperature, the temperature is most often higher than the boiling point of the organic solvent used and in such a case, the dissolution is performed under pressure.

The cellulose acylate solution preferably has a viscosity and a dynamic storage modulus in the following ranges, because the casting is facilitated. A sample solution (1 mL) is measured using “Steel Cone” with a diameter of 4 cm/2° in a rheometer “CLS 500” (both manufactured by TA Instruments). The measurement is performed under the conditions of oscillation step/temperature ramp by varying the temperature at 2° C./min in the range from 40° C. to −10° C., and the static non-Newton viscosity n*(Pa·s) at 40° C. and the storage modulus G′ (Pa) at −5° C. are determined. Incidentally, the measurement is started after previously keeping the sample solution at the measurement initiation temperature until the liquid temperature becomes constant.

In the present invention, the dope preferably has a viscosity of 1 to 400 Pass at 40° C. and a dynamic storage modulus of 500 Pa or more at 15° C., more preferably a viscosity of 10 to 200 Pass at 40° C. and a dynamic storage modulus of 100 to 1,000,000 Pa at 15° C. Furthermore, the dynamic storage modulus at low temperature is preferably larger and, for example, when the casting support is at −5° C., the dynamic storage modulus at −5° C. is preferably from 10,000 to 1,000,000 Pa, and when the support is at −50° C., the dynamic storage modulus at −50° C. is preferably from 10,000 to 5,000,000 Pa.

When the above-described preferable cellulose acylate is used, a high-concentration dope is obtained, so that a high-concentration dope having excellent stability can be obtained even without relying on the means of concentration. In order to more facilitate the dissolution, after dissolving the cellulose acylate to a low concentration, the solution may be concentrated by using the concentrating means. The method for concentrating the solution is not particularly limited but, for example, the solution can be concentrated by a method of introducing a low-concentration solution between a cylindrical body and a rotation trajectory of the outer circumference of a rotary blade rotating in the circumferential direction inside the cylindrical body and at the same time, creating a temperature difference between the cylindrical body and the solution, thereby obtaining a high-concentration solution while evaporating the solvent (see, for example, JP-A-4-259511); or a method of injecting a heated low-concentration solution into a vessel from a nozzle, flash-evaporating the solvent during traveling of the solution from the nozzle until reaching the inner wall of vessel, and extracting the solvent vapor from the container while extracting a high-concentration solution from the vessel bottom (see, for example, U.S. Pat. Nos. 2,541,012, 2,858,229, 4,414,341 and 4,504,355).

In advance of casting, the foreign matters in the dope solution, such as undissolved material, dust and impurity, are preferably removed by filtration with use of an appropriate filter medium such as metal mesh or flannel. The filter used for the filtration of cellulose acylate solution preferably has an absolute filtration precision of 0.1 to 100 μm, more preferably from 0.5 to 25 μm. The thickness of the filter is preferably from 0.1 to 10 mm, more preferably from 0.2 to 2 mm. The filtration pressure is preferably 1.6 MPa or less, more preferably 1.2 MPa or less, still more preferably 1.0 MPa or less, yet still more preferably 0.2 MPa or less. As for the filter medium, a conventionally known material such as glass fiber, cellulose fiber, filter paper and fluororesin (e.g., ethylene tetrafluoride resin) can be preferably used. In particular, ceramic, metal and the like are preferred. The viscosity of the cellulose acylate solution immediately before film formation may be sufficient if the solution can be cast at the film formation. Usually, the solution is preferably prepared to have a viscosity of 10 to 2,000 Pass, more preferably from 30 to 1,000 Pass, still more preferably from 40 to 500 Pass. At this time, the temperature is not particularly limited as long as it is a temperature at the casting, but the temperature is preferably from −5 to +70° C., more preferably from −5 to +55° C.

### [Film Formation]

The cellulose acylate film preferably used in the present invention can be obtained by film-forming the above-described cellulose acylate solution (dope). As for the method and apparatus for film formation, the solution casting film formation method and solution casting film formation apparatus conventionally used for the production of cellulose triacetate film are used. The dope (cellulose acylate solution) prepared in a dissolving machine (kettle) is once stored in a storing kettle and finalized by removing the bubbles contained in the dope. The dope is supplied to a pressure-type die from the dope discharge port through, for example, a pressure-type quantitative gear pump capable of feeding a constant amount of solution with high precision by the number of rotations, and uniformly cast on an endlessly running metal support in the casting part from the mouth ring (slit) of the pressure-type die, and the damp-dry dope film (also called web) is peeled off from the metal support at the peeling point after nearly one round of the metal support. The obtained web is nipped by clips at both ends, conveyed by a tenter while keeping the width, thereby dried, then conveyed by a roll group of a drying apparatus to complete the drying, and taken up to a predetermined length by a take-up machine. The combination of the tenter and the drying apparatus comprising a roll group varies depending on the purpose. In the solution casting film formation method used for a functional protective film of electronic displays, in addition to the solution casting film formation apparatus, a coating apparatus is added in many cases so as to apply surface treatment to the film, such as subbing layer, antistatic layer, antihalation layer and protective layer. Each production step is simply described below, but the present invention is not limited thereto.

In producing a cellulose acylate film by a solvent cast method, the prepared cellulose acylate solution (dope) is cast on a drum or a band and the solvent is evaporated to form a film. The dope before casting is preferably adjusted to a concentration of giving a solid content of 5 to 40 mass %. The surface of the drum or band is preferably finished to provide a mirror state. The dope is preferably cast on a drum or band having a surface temperature of 30° C. or less. In particular, the metal support temperature is preferably from −10 to 20° C. Furthermore, the methods described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650 may be used in the present invention.

### [Multilayer Casting]

In casting the cellulose acylate solution on a smooth band or drum working as a metal support, a single-layer solution may be cast or a plurality of cellulose acylate solutions in two or more layers may be cast. In the case of casting a plurality of cellulose acylate solutions, respective cellulose acylate-containing solutions may be cast from multiple casting ports provided with spacing in the travelling direction of the metal support to produce a film while stacking the solutions one on another, and the methods described, for example, in JP-A-61-158414, JP-A-1-122419 and JP-A-11-198285 may be applied. Also, cellulose acylate solutions may be cast from two casting ports to effect film formation and this can be practiced by the method described, for example, in JP-B-60-27562 (the term “JP-B” as used herein means an “examined Japanese patent publication”), JP-A-61-94724, JP-A-61-947245, JP-A-61-104813, JP-A-61-158413 and JP-A-6-134933. In addition, a cellulose acylate film casting method described in JP-A-56-162617 of encompassing the flow of a high-viscosity cellulose acylate solution with a low-viscosity cellulose acylate solution and simultaneously extruding the high-viscosity and low-viscosity cellulose acylate solutions may be used. A method of incorporating a large amount of an alcohol component as a poor solvent into the solution on the outer side than into the solution on the inner side described in JP-A-61-94724 and JP-A-61-94725 is also a preferred embodiment. Furthermore, a film comprising a plurality of layers can be produced using two casting ports by separating a film cast from a first casting port and formed on a metal support, and applying second casting on the film on the side contacted with the metal support surface, and this method is described, for example, in JP-B-44-20235. The cellulose acylate solutions cast may be the same or different and are not particularly limited. In order to impart functions to multiple cellulose acylate layers, a cellulose acylate solution according to the function may be extruded from each casting port. The cellulose acylate solution may also be cast simultaneously with other functional layers (for example, adhesive layer, dye layer, antistatic layer, antihalation layer, UV absorbing layer and polarizing layer).

Many of conventional single-layer solutions have a problem that a cellulose acylate solution having high concentration and high viscosity must be extruded so as to obtain a required film thickness and in this case, the cellulose acylate solution tends to have bad stability and produce a solid matter, giving rise to particle failure or poor planarity. For solving this problem, a plurality of cellulose acylate solutions are cast relatively little by little from a plurality of casting ports, whereby high-viscosity solutions can be simultaneously extruded on the metal support and not only the planarity can be enhanced and a film having excellent surface state can be produced but also the drying load can be reduced by the virtue of using thick cellulose acylate solutions and the production speed of film can be elevated.

In the case of co-casting, the layers on the inner and outer sides are not particularly limited in the thickness, but the thickness on the outer side preferably occupies from 1 to 50%, more preferably from 2 to 30%, of the entire film thickness. Here, in the case of co-casting three or more layers, the total thickness of the layer in contact with the metal support and the layer in contact with the air side is defined as the thickness on the outer side. In the case of co-casting, a cellulose acylate film having a laminate structure may also be produced by co-casting cellulose acylate solutions differing in the concentration of the above-described additive such as plasticizer, ultraviolet absorbent and matting agent. For example, a cellulose acylate film having a constitution of skin layer/core layer/skin layer can be produced. In this case, for example, the matting agent may be incorporated in a larger amount into the skin layer or may be incorporated only into the skin layer. The plasticizer and ultraviolet absorbent can be incorporated in a larger amount into the core layer than in the skin layer or may be incorporated only into the core layer. The plasticizer and ultraviolet absorbent each may be different between the core layer and the skin layer and, for example, at least either one of a low-volatile plasticizer and a low-volatile ultraviolet absorbent may be incorporated into the skin layer, while adding a plasticizer with excellent plasticity or an ultraviolet absorbent with excellent ultraviolet absorptivity into the core layer. It is also a preferred embodiment to incorporate a separation accelerator only into the skin layer on the metal support side. In addition, an alcohol as a poor solvent may be added in a larger amount into the skin layer than into the core layer so as to gel the solution by cooling the metal support according to a cooling drum method, and this is preferred. The Tg may differ between the skin layer and the core layer, and the Tg of the core layer is preferably lower than the Tg of the skin layer. The viscosity of the cellulose acylate-containing solution at the casting may also be different between the skin layer and the core layer, and the viscosity of the skin layer is preferably lower than the viscosity of the core layer, but the viscosity of the core layer may be lower than the viscosity of the skin layer.

### [Casting Method]

Examples of the method for casting the solution include a method of uniformly extruding the prepared dope on a metal support from a pressure die, a doctor blade method of controlling the thickness of the dope once cast on a metal support by using a blade, and a reverse roll coater method of controlling the thickness by using a roll rotating in reverse. Among these, the method using a pressure die is preferred. The pressure die includes a coat hanger die, a T-die and the like, and any of these can be preferably used. Other than the methods described above, conventionally known various methods for casting and film-forming a cellulose triacetate solution can be employed, and the same effect as that described in each publication can be obtained by setting respective conditions while taking into account the difference in the boiling point or the like of the solvent used.

The endlessly running metal support used in the production of the cellulose acylate film preferably used in the present invention is a drum with the surface being mirror-finished by chromium plating or a stainless steel belt (may also be called a band) mirror-finished by surface polishing. As for the pressure die, one unit or two or more units may be provided on the upper side of the metal support. The pressure die provided is preferably one or two unit(s). In the case of providing two or more units, the amount of the dope cast may be divided at various ratios among respective dies, or the dope may be supplied to the dies at respective ratios by a plurality of precision quantitative gear pumps. The temperature of the cellulose acylate solution used for the casting is preferably from −10 to 55° C., more preferably from 25 to 50° C. In this case, the temperature may be the same in all steps or may differ among respective step portions. When the temperature differs, it may sufficient if the temperature immediately before casting is a desired temperature.

### [Drying]

In the production of the cellulose acylate film, the dope on the metal support may be generally dried, for example, by a method of blowing hot air from the surface side of the metal support (drum or belt), that is, from the surface of the web on the metal support; a method of blowing hot air from the back surface of the drum or belt; or a back-surface liquid heat transfer method of bringing a liquid controlled in the temperature into contact with the drum or belt from the back surface opposite the dope casting surface, and heating the drum or belt through heat transfer, thereby controlling the surface temperature. The back-surface liquid heat transfer method is preferred. The metal support surface before casting may be at any temperature as long as it is lower than the boiling point of the solvent used for the dope. However, in order to accelerate the drying or deprive the solution of its fluidity on the metal support, the surface temperature is preferably set to a temperature 1 to 10° C. lower than the boiling point of the solvent having a lowest boiling point out of the solvents used. Incidentally, this does not apply to the case where the cast dope is cooled and peeled off without drying it.

In order to suppress light leakage which occurs when the polarizing plate is obliquely viewed, the transmission axis of the polarizer and the in-plane slow axis of the cellulose acylate film need to be arranged in parallel. The transmission axis of a roll film-shaped polarizer continuously produced is generally parallel to the width direction of the roll film and therefore, for continuously laminating the roll film-shaped polarizer and a protective film comprising a roll film-shaped cellulose acylate film, the in-plane slow axis of the roll film-shaped protective film needs to be parallel to the width direction of the film. Accordingly, the stretching is preferably performed at a larger ratio in the width direction. The stretching may be performed on the way of film-formation process or the stock film produced and taken up may be stretched. In the former case, the film may be stretched in the state of containing a residual solvent and can be preferably stretched when the residual solvent amount is from 2 to 30 mass %.

The thickness of the cellulose acylate film preferably used the present invention, which is obtained after drying, varies depending on the use end but usually, the film thickness is preferably from 5 to 500 μm, more preferably from 20 to 300 μm, still more preferably from 30 to 150 μm. In the case of optical use, particularly, use for VA liquid crystal display devices, the film thickness is preferably from 40 to 110 μm. The film thickness may be adjusted to a desired thickness by controlling, for example, the concentration of solid contents contained in the dope, the slit gap of die mouth ring, the extrusion pressure from die or the speed of metal support.

The thus-obtained cellulose acylate film preferably has a width of 0.5 to 3 m, more preferably from 0.6 to 2.5 m, still more preferably from 0.8 to 2.2 m. The length of the film taken up is preferably from 100 to 10,000 m, more preferably from 500 to 7,000 m, still more preferably from 1,000 to 6,000 m, per roll. At the time of taking up the film, knurling is preferably provided to at least one edge. The width of the knurl is preferably from 3 to 50 mm, more preferably from 5 to 30 mm, and the height is preferably from 0.5 to 500 μm, more preferably from 1 to 200 μm. The knurling may be provided by either one-sided pressing or double-sided pressing.

The fluctuation of the Re(590) value in the width direction of the film is preferably ±5 nm, more preferably ±3 nm. Also, the fluctuation of the Rth(590) in the width direction is preferably ±10 nm, more preferably ±5 nm. Furthermore, the fluctuations of the Re value and Rth value in the length direction are also preferably in respective fluctuation ranges for the width direction.

In the cellulose acylate film preferably used in the present invention, the fluctuation of the slow-axis angle in the film plane is preferably from −2° to +2°, more preferably from −1° to +1°, and most preferably −0.5° to +0.5°, with respect to the reference direction of the roll film. The reference direction as used herein indicates the longitudinal direction of the roll film when longitudinally stretching the cellulose acylate film and indicates the width direction of the roll film when transversely stretching the film.

In the cellulose acylate film preferably used in the present invention, the difference ΔRth=|Rth(550)10%RH−Rth(550)80%RH|between the Rth value at 25° C.-10% RH and the Rth value at 25° C.-80% RH is preferably from 0 to 10 nm from the standpoint of less allowing a liquid crystal display device to cause tint change due to aging.

In the cellulose acylate film preferably used in the present invention, the equilibrium moisture content at 25° C.-80% RH is preferably 5.5% or less from the standpoint of less allowing a liquid crystal display device to cause tint change due to aging.

In determining the moisture content, a the cellulose acylate film sample of 7 mm×35 mm is measured by the Karl Fischer's method with use of a water content measuring meter and a sample drying apparatus {“CA-03” and “VA-05”, both manufactured by Mitsubishi Chemical Corp.}. The moisture content is calculated by dividing the amount (g) of water by the mass (g) of sample.

In the cellulose acylate film preferably used in the present invention, the moisture permeability (in terms of moisture permeability with a film thickness of 80 μm) at 60° C.-95% RH for 24 hours is preferably from 400 to 1,800 g/m²·24 hr from the standpoint of less allowing a liquid crystal display device to cause tint change due to aging.

The moisture permeability becomes small when the thickness of cellulose acylate film is large, and becomes large when the film thickness is small. Accordingly, whatever thickness the sample has, the value needs to be converted by providing a reference film thickness. In the present invention, assuming that the reference film thickness is 80 μm, the film thickness is calculated according to the following mathematical formula (13):

80 μm-reduced moisture permeability=measured moisture permeability×measured film thickness μm/80 μm Mathematical Formula (13):

As for the measuring method of moisture permeability, the methods described in the “Measurement of Amount of Vapor Permeated (mass method, thermometer method, vapor pressure method, adsorption amount method)” of Kobunshi Jikken Koza 4, Kobunshi no Bussei II (Polymer Experiment Lecture 4, Physical Properties II of Polymers), pp. 285-294, Kyoritsu Shuppan, can be applied.

In the measurement of glass transition temperature, a cellulose acylate film sample (unstretched) of 5 mm×30 mm is moisture-conditioned at 25° C.-60% RH for 2 hours or more and then measured by a dynamic viscoelasticity meter “Vibron: DVA-225” {manufactured by IT Keisoku Seigyo K.K.} under the conditions of a gripping distance of 20 mm, a temperature rising rate of 2° C./min, a measurement temperature range of 30 to 200° C. and a frequency of 1 Hz. The storage modulus is taken as a logarithmic axis on the ordinate, the temperature (° C.) is taken as a linear axis on the abscissa, and the temperature showing the abrupt decrease of the storage modulus, which is observed when the storage modulus shifts from the solid region to the glass transition region, is defined as the glass transition temperature Tg. More specifically, when a straight line 1 in the solid region and a straight line 2 in the glass transition region are drawn on the obtained chart, the intersection of the straight line 1 and the straight line 2 is the temperature at which the storage modulus abruptly decreases during temperature rise and the film starts softening, and this is a temperature causing the storage modulus to start shifting to the glass transition region and therefore, is defined as the glass transition temperature Tg (dynamic viscoelasticity).

In the measurement of modulus, a cellulose acylate film sample of 10 mm×150 mm is moisture-conditioned at 25° C.-60% RH for 2 hours or more and then measured by a tensile tester “Strography R2” {manufactured by Toyo Seiki Seisaku-Sho, Ltd.} under the conditions of a chuck-to-chuck distance of 100 mm, a temperature of 25° C. and a stretching rate of 10 mm/min.

In the measurement of coefficient of hygroscopic expansion, assuming the value obtained by measuring the dimension of a film left standing at 25° C.-80% RH for 2 hours or more with a pin gauge is L₈₀% and the value obtained by measuring the dimension of a film left standing at 25° C.-10% RH for 2 hours or more with a pin gauge is L_{10%}, the coefficient of hygroscopic expansion is determined according to the following mathematical formula (14):

(L_{80%}−L_{10%})/(80%RH−10%RH)×10⁶ Mathematical Formula (14):

In the cellulose acylate film preferably used in the present invention, the haze is preferably from 0.01 to 2%. The haze can be measured as follows.

A cellulose acylate film sample of 40 mm×80 mm is measured according to JIS K-6714 by a haze meter “HGM-2DP” {manufactured by Suga Test Instruments Co., Ltd.} at 25° C. and 60% RH.

In the cellulose acylate film preferably used in the present invention, the change in the mass when the film is left standing for 48 hours under the conditions of 80° C. and 90% RH is preferably from 0 to 5 mass %.

In the cellulose acylate film preferably used in the present invention, the dimensional change when the film is left standing for 24 hours under the conditions of 60° C. and 95% RH, and the dimensional change when the film is left standing for 24 hours under the conditions of 90° C. and 5% RH, each is preferably from 0 to 5%.

The photoelastic coefficient is preferably 50×10⁻¹³ cm²/dyne or less from the standpoint of less allowing a liquid crystal display device to cause tint change due to aging.

As for the specific measuring method, a cellulose acylate film sample of 10 mm×100 mm is applied with a tensile stress in the long axis direction and the retardation at this time is measured by an ellipsometer “M150” {manufactured by JASCO Corp.}. The photoelastic coefficient is calculated from the variation of retardation based on the stress.

### [Melt Film Formation]

The optical film of the present invention may be produced by melt film formation. The film may be produced by injection molding heat-melting raw materials such as raw material polymer and additives, and extruding the melt into a film, or may be produced by sandwiching the raw material between two heated plates and pressing it to form a film.

The heat-melting temperature is not particularly limited as long as it is a temperature at which the raw material polymer uniformly melts. Specifically, the heating temperature is not less than the melting point or softening point. In order to obtain a uniform film, the melting is performed under heating at a temperature higher than the melting point of the raw material polymer, preferably at a temperature from 5 to 40° C. higher than the melting point, more preferably from 8 to 30° C. higher than the melting point.

### [Orientation Film]

The optically-compensatory film may have an orientation film between the cellulose acylate film and an optically anisotropic layer. Also, only an orientation film is used at the production of an optically anisotropic layer and after producing the optically anisotropic layer on an orientation film, only the optically anisotropic layer may be transferred onto the cellulose acylate film.

In the present invention, the orientation film is preferably a layer comprising a crosslinked polymer. The polymer for use in the orientation film may be either a polymer which itself can be crosslinked, or a polymer which is crosslinked by a crosslinking agent. The orientation film is formed by causing a reaction between polymers having a functional group or between polymers having incorporated thereinto a functional group, by the effect of light, heat, pH change or the like; or by using a crosslinking agent which is a compound having high reactivity, introducing a binding group derived from the crosslinking agent between polymers, and crosslinking between polymers.

The orientation film comprising a crosslinked polymer can be usually formed by applying a coating solution containing the above-described polymer or a mixture of the polymer and a crosslinking agent, on a support, and subjecting it to heating or the like. In order to prevent the orientation film from dusting in the rubbing step described later, the crosslinking degree is preferably elevated. When the value (1-(Ma/Mb)) obtained by subtracting the ratio (Ma/Mb) of the amount (Ma) of the crosslinking agent remaining after crosslinking to the amount (Mb) of the crosslinking agent added to the coating solution, from 1 is defined as the crosslinking degree, the crosslinking degree is preferably from 50 to 100%, more preferably from 65 to 100%, and most preferably from 75 to 100%.

In the present invention, the polymer used in the orientation film may be either a polymer which itself can be crosslinked or a polymer which is crosslinked by a crosslinking agent. A polymer having both functions may be of course used. Examples of these polymers include a polymer such as polymethyl methacrylate, acrylic acid/methacrylic acid copolymer, styrene/maleimide copolymer, polyvinyl alcohol, modified polyvinyl alcohol, poly(N-methylolacrylamide), styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethylcellulose, gelatin, polyethylene, polypropylene and polycarbonate, and a compound such as silane coupling agent. The polymer is preferably, for example, a water-soluble polymers such as poly(N-methylolacrylamide), carboxymethylcellulose, gelatin, polyvinyl alcohol or modified polyvinyl alcohol, more preferably gelatin, a polyvinyl alcohol or a modified polyvinyl alcohol, still more preferably a polyvinyl alcohol or a modified polyvinyl alcohol.

In the case of coating a polyvinyl alcohol or a modified polyvinyl alcohol directly on the cellulose acylate film for use in the present invention, a method of providing a hydrophilic undercoat layer or applying a saponification treatment is preferably used.

Among those polymers, a polyvinyl alcohol or a modified polyvinyl alcohol is preferred.

Examples of the polyvinyl alcohol include those having a saponification degree of 70 to 100%. In general, the saponification degree is preferably from 80 to 100%, more preferably from 82 to 98%. The polymerization is preferably from 100 to 3,000.

The modified polyvinyl alcohol include a modified product of polyvinyl alcohol, such as those modified by copolymerization (for example, a modifying group such as COONa, Si(OX)₃, N(CH₃)₃.Cl, C₉H₁₉COO, SO₃Na or C₁₂H₂₅ is introduced), those modified with a chain transfer (for example, a modifying group such as COONa, SH or SC₁₂H₂₅ is introduced), and those modified by block polymerization (for example, a modifying group such as COOH, CONH₂, COOR, C₆H₅ is introduced). The polymerization degree is preferably from 100 to 3,000. Among these, preferred is an unmodified or modified polyvinyl alcohol having a saponification degree of 80 to 100%, and more preferred is an unmodified or alkylthio-modified polyvinyl alcohol having a saponification degree of 85 to 95%.

In order to impart adhesion between the cellulose acylate film and the optically anisotropic layer, a crosslinking/polymerization active group is preferably introduced into the polyvinyl alcohol. Preferred examples thereof are described in detail in JP-A-8-338913.

In the case of using a hydrophilic polymer such as polyvinyl alcohol for the orientation film, the moisture content is preferably controlled in view of film hardness. The moisture content is preferably from 0.4 to 2.5%, more preferably from 0.6 to 1.6%. The moisture content can be measured by a commercially available moisture content meter of the Karl Fischer method.

The orientation film preferably has a thickness of 10 μm or less.

The cellulose acylate film for use in the present invention preferably has Re(550) of 20 to 100 nm and Rth(550) of 100 to 300 nm.

Particularly, in the case where the cellulose acylate film is used as an optically-compensatory film for a VA-mode liquid crystal display device and the optical compensation is effected by one sheet provided on one side of the liquid crystal cell, the cellulose acylate film preferably has Re(550) of 40 to 100 nm and Rth(550) of 160 to 300 nm, more preferably Re(550) of 45 to 80 nm and Rth(550) of 170 to 250 nm. Also, these optically-compensatory films may be used on both sides of the liquid crystal cell of the VA-mode liquid crystal display device.

### [Polarizing Plate]

The present invention provides a polarizing plate comprising a polarizing film and a pair of protective films sandwiching the polarizing film, wherein at least one sheet of the protective films comprises the above-described optical film. For example, a polarizing plate obtained by dyeing a polarizing film comprising a polyvinyl alcohol film or the like with iodine, stretching the film, and stacking a protective film on both surfaces thereof, may be used. The polarizing plate is disposed on the outer side of a liquid crystal cell. A pair of polarizing plates each comprising a polarizing film and a pair of protective films sandwiching the polarizing film are preferably disposed to sandwich the liquid crystal cell. Incidentally, the protective film disposed on the liquid crystal cell side is preferably the optical film of the present invention or an optically-compensatory film.

### <<Adhesive>>

The adhesive for laminating the polarizing film and the protective films is not particularly limited, but examples thereof include a PVA-based resin (including a PVA modified with an acetoacetyl group, a sulfonic acid group, a carboxyl group, an oxyalkylene group or the like) and an aqueous boron compound solution. Among these, a PVA-based resin is preferred. The dry thickness of the adhesive layer is preferably from 0.01 to 10 μm, more preferably from 0.05 to 5 μm.

### <Consistent Production Process of Polarizing Film and Protective Film>

The polarizing plate usable in the present invention may be produced by a method comprising, after stretching the film for polarizing film, a drying step of shrinking the film to reduce the volatile content, but after a protective film is laminated on at least one surface subsequently to the drying or during the drying, a post-heating step is preferably provided. Specific examples of the method for lamination include a method of laminating a protective film to the polarizing film by using an adhesive during the drying step while holding both ends of the film, and then slitting both ends; and a method of, after the drying, removing the film for polarizing film from the both-end holding parts, slitting both ends of the film, and laminating a protective film. As for the slitting method, a general technique such as a method of cutting both ends with a cutter (e.g., knife) or a method using a laser may be employed. After the films are laminated, the laminate is preferably heated so as to dry the adhesive and improve the polarizing performance. The heating conditions vary depending on the adhesive but in the case of an aqueous adhesive, the heating temperature is preferably 30° C. or more, more preferably from 40 to 100° C., still more preferably from 50 to 90° C. In view of performance and production efficiency, these steps are preferably performed in a consistent production line.

### <<Performances of Polarizing Plate>>

As for the optical property and durability (short-term or long-term storability), the polarizing plate of the present invention preferably has a performance equal to or higher than that of a commercially available superhigh-contrast product (for example, HLC2-5618 produced by Sanritz Corp.). More specifically, it is preferred that the visible light transmittance is 42.5% or more, the polarization degree of {(Tp−Tc)/(Tp+Tc)} ½≧0.9995 (wherein Tp is parallel transmittance and Tc is orthogonal transmittance), the rate of change of light transmittance between before and after standing in an atmosphere of 60° C. and humidity of 90% RH for 500 hours and further in a dry atmosphere of 80° C. for 500 hours is 3% or less, more preferably 1% or less, based on the absolute value, and the rate of change of polarization degree is 1% or less, more preferably 0.1% or less, based on the absolute value.

### [Surface Treatment of Cellulose Acylate Film]

The cellulose acylate film preferably used in the present invention is surface-treated depending on the case, whereby the adhesion of the cellulose acylate film to each functional layer (for example, an undercoat layer or a back layer) can be enhanced. Examples of the surface treatment which can be used include glow discharge treatment, ultraviolet irradiation treatment, corona treatment, flame treatment and acid or alkali treatment. The glow discharge treatment may be a low-temperature plasma occurring in a low-pressure gas of 10⁻³ to 20 Torr, and a plasma treatment under an atmospheric pressure is also preferred. The plasma-exciting gas means a gas which is plasma-excited under such a condition, and examples thereof include argon, helium, neon, krypton, xenon, nitrogen, carbon dioxide, chlorofluorocarbons such as tetrafluoromethane, and a mixture thereof. These are described in detail in JIII Journal of Technical Disclosure, No. 2001-1745, pp. 30-32, Japan Institute of Invention and Innovation (Mar. 15, 2001). In the atmospheric pressure plasma treatment which is recently attracting attention, for example, an irradiation energy of 20 to 500 kGy at 10 to 1,000 keV, preferably an irradiation energy of 20 to 300 kGy at 30 to 500 keV, is used. Among these treatments, an alkali saponification treatment is preferred and this is a very effective surface treatment for cellulose acylate film.

### [Alkali Saponification Treatment]

The alkali saponification treatment is preferably performed by a method of dipping the cellulose acylate film directly in a bath containing a saponification solution or a method of coating a saponification solution on the cellulose acylate film. Examples of the coating method include a dip coating method, a curtain coating method, an extrusion coating method, a bar coating method and an E-type coating method. Since the saponification solution is coated on the cellulose acylate film, the solvent for the alkali saponification treatment coating solution is preferably selected from those having good wettability and ensuring good surface state without forming irregularities on the cellulose acylate film surface. More specifically, an alcohol-based solvent is preferred, and isopropyl alcohol is more preferred. An aqueous surfactant solution may also be used as the solvent. The alkali in the alkali saponification coating solution is preferably an alkali dissolvable in the above-described solvent, more preferably KOH or NaOH. The pH of the saponification coating solution is preferably 10 or more, more preferably 12 or more. The reaction conditions at the alkali saponification are preferably room temperature and from 1 second to 5 minutes, more preferably from 5 seconds to 5 minute, still more preferably from 20 seconds to 3 minutes. After the alkali saponification reaction, the saponification solution-coated surface is preferably washed with water or washed with an acid, followed by washing with water.

In the polarizing plate according to the present invention, an optically anisotropic layer is preferably provided on the protective film.

The material for the optically anisotropic layer is not particularly limited and, for example, a liquid crystalline compound, a non-liquid crystalline compound, an inorganic compound, or an organic/inorganic complex compound may be used. The liquid crystalline compound may be a compound used by aligning a low-molecule compound having a polymerizable group and fixing the alignment through polymerization under the action of light or heat, or a compound used by heating and aligning a liquid crystal polymer and then cooling and fixing the alignment in the glass state. As for the liquid crystalline compound, those having a discotic structure, a rod-like structure or a structure showing optical biaxiality may be used. As for the non-liquid crystalline compound, a polymer having an aromatic ring, such as polyimide and polyester, may be used.

The optically anisotropic layer may be formed using various methods such as coating, vapor deposition and sputtering.

In the case of providing an optically anisotropic layer on the protective film of the polarizing plate, the adhesive layer is provided on the outer side of the optically anisotropic layer more remote from the polarizer side.

In the polarizing plate related to the present invention, at least one layer selected from a hardcoat layer, an antiglare layer and an antireflection layer is preferably provided on the surface of the protective film on at least one side of the polarizing plate. That is, in use of the polarizing plate for a liquid crystal display device, a functional film such as antireflection layer is preferably provided on the protective film disposed on the side opposite the liquid crystal cell, and at least one layer selected from a hardcoat layer, an antiglare layer and an antireflection layer is preferably provided as such a functional film. Incidentally, these layers need not be provided as individual layers but, for example, by imparting an antiglare function to an antireflection layer or hardcoat layer, the antireflection layer or hardcoat layer may be caused to function as an antiglare antireflection layer, instead of providing two layers of antireflection layer and antiglare layer.

### [Antireflection Layer]

In the present invention, an antireflection layer obtained by stacking at least a light scattering layer and a low refractive index layer in this order on the protective layer of the polarizing plate, or an antireflection layer obtained by stacking a medium refractive index layer, a high refractive index layer and a low refractive index layer in this order on the protective film is suitably provided. Preferred examples thereof are described below. Incidentally, in the former construction, the specular reflectivity is generally 1% or more and this film is called a Low Reflection (LR) film, whereas in the latter construction, a specular reflectivity of 0.5% or less can be realized and this film is called an Anti-Reflection (AR) film.

### [LR Film]

Preferred examples of the antireflection layer (LR film) obtained by providing a light scattering layer and a low refractive index layer on the protective film of the polarizing plate are described below.

In the light scattering layer, matting particles are preferably dispersed, and the material for the light scattering layer in the portion except for matting particles preferably has a refractive index of 1.50 to 2.00. The refractive index of the low refractive index layer is preferably from 1.20 to 1.49. In the present invention, the light scattering layer has both an antiglare property and a hardcoat property and may comprise a single layer or a plurality of layers, for example, from 2 to 4 layers.

The antireflection layer is preferably designed to have a surface irregularity shape such that the centerline average roughness Ra is from 0.08 to 0.40 μm, the 10-point average roughness Rz is 10 times or less of Ra, the average peak-to-trough distance Sm is from 1 to 100 μm, the standard deviation of the protrusion height from the deepest portion of irregularities is 0.5 μm or less, the standard deviation of the average peak-to-trough distance Sm based on the centerline is 20 μm or less, and the plane at a tilt angle of 0 to 5° occupies 10% or more, because satisfactory antiglare property and visually uniform matted texture are achieved.

Also, when the color tint of reflected light under a C light source has a* value of −2 to 2 and b* value of −3 to 3 and the ratio of minimum reflectance to maximum reflectance in the range of 380 to 780 nm is from 0.5 to 0.99, the reflected light gives a neutral color tint and this is preferred. Furthermore, the b* value of transmitted light under a C light source is preferably adjusted to 0 to 3, so that yellow tinting of white display when applied to a display device can be decreased. In addition, when a lattice of 120 μm×40 μm is inserted between the surface light source and the antireflection film of the present invention and the brightness distribution on the film is measured, the standard deviation of the brightness distribution is preferably 20 or less, because the polarizing plate of the present invention less glares when applied to a high-definition panel.

The antireflection layer usable in the present invention is preferably designed to have optical properties such that the specular reflectivity is 2.5% or less, the transmittance is 90% or more, and the 60° glossiness is 70% or less, whereby the reflection of outside light can be inhibited and the visibility is enhanced. In particular, the specular reflectivity is more preferably 1% or less, and most preferably 0.5% or less. Also, it is preferred that the haze is from 20 to 50%, the internal haze/entire haze value ratio is from 0.3 to 1, the decrease of the haze value after formation of the low refractive index layer from the haze value with layers up to the light scattering layer is within 15%, the clearness of transmitted image is from 20 to 50% with a comb width of 0.5 mm, and the vertical light transmittance/transmittance in the direction inclined at 2° from the vertical direction is from 1.5 to 5.0, because the high-definition LCD panel can be prevented from glaring or blurring of characters or the like.

### (Low Refractive Index Layer)

The refractive index of the low refractive index layer which can be used in the present invention is preferably from 1.20 to 1.49, more preferably from 1.30 to 1.44. Furthermore, in view of reducing the reflectance, the low refractive index layer preferably satisfies the following mathematical formula (19):

(m/4)λ×0.7<n_{L}d_{L}<(m/4)λ×1.3 Mathematical Formula (19):

wherein m is a positive odd number, n_{L} is the refractive index of the low refractive index layer, d_{L} is the film thickness (nm) of the low refractive index layer, and λ is the wavelength and is a value in the range of 500 to 550 nm.

The materials constituting the low refractive index layer are described below.

The low refractive index layer preferably contains a fluorine-containing polymer as the low refractive index binder.

The fluorine polymer is preferably a fluorine-containing polymer in which the coefficient of dynamic friction is from 0.03 to 0.20, the contact angle for water is from 90 to 120°, and the slipping angle of pure water is 70° or less and which is crosslinked under heat or ionizing radiation. When the polarizing plate according to the present invention is loaded in an image display device, the peel force with a commercially available adhesive tape is preferably lower because a seal or memo attached can be easily peeled off, and the peel force as measured by a tensile tester is preferably 500 gf or less, more preferably 300 gf or less, and most preferably 100 gf or less. Also, as the surface hardness is higher, the surface is less scratch. The surface hardness as measured by a microhardness meter is preferably 0.3 GPa or more, more preferably 0.5 GPa or more.

Examples of the fluorine-containing polymer for use in the low refractive index layer include a hydrolysate or dehydrating condensate of a perfluoroalkyl group-containing silane compound {e.g., (heptadecafluoro-1,1,2,2-tetrahydro-decyl)triethoxysilane}, and a fluorine-containing copolymer in which a fluorine-containing monomer unit and a constituent unit for imparting crosslinking reactivity are contained as the constituent components.

Specific examples of the fluorine-containing monomer include fluoroolefins (e.g., fluoroethylene, vinylidene fluoride, tetrafluoroethylene, perfluorooctylethylene, hexafluoropropylene, perfluoro-2,2-dimethyl-1,3-dioxol), partially or completely fluorinated alkyl ester derivatives of (meth)acrylic acid [e.g., “VISCOAT 6FM” {produced by Osaka Organic Chemical Industry Ltd.}, “M-2020” {produced by Daikin Industries, Ltd.}], and completely or partially fluorinated vinyl ethers. Among these, perfluoroolefins are preferred and in view of refractive index, solubility, transparency, availability and the like, hexafluoropropylene is more preferred.

Examples of the constituent unit for imparting crosslinking reactivity include a constituent unit obtained by the polymerization of a monomer previously having a self-crosslinking functional group within the molecule, such as glycidyl(meth)acrylate and glycidyl vinyl ether; a constituent unit obtained by the polymerization of a monomer having a carboxyl group, a hydroxyl group, an amino group, a sulfo group or the like {such as (meth)acrylic acid, methylol (meth)acrylate, hydroxyalkyl(meth)acrylate, allyl acrylate, hydroxyethyl vinyl ether, hydroxybutyl vinyl ether, maleic acid and crotonic acid}; and a constituent unit obtained by introducing a crosslinking reactive group such as (meth)acryloyl group into the above-described constituent units by a polymer reaction (for example, the crosslinking reactive group can be introduced by causing an acrylic acid chloride to act on a hydroxyl group).

Other than the above-described fluorine-containing monomer unit and constituent unit for imparting crosslinking reactivity, for example, in view of solubility in solvent or transparency of film, a monomer not containing a fluorine atom may also be appropriately copolymerized. The monomer unit which can be used in combination is not particularly limited and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate), methacrylic acid esters (e.g., methyl methacrylate, ethyl methacrylate, butyl methacrylate, ethylene, glycol dimethacrylate), styrene derivatives (e.g., styrene, divinylbenzene, vinyltoluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butylacrylamide, N-cyclohexylacrylamide), methacrylamides and acrylonitrile derivatives.

With such a polymer, a hardening agent may be appropriately used in combination as described in JP-A-10-25388 and JP-A-10-147739.

### (Light Scattering Layer)

The light scattering layer is formed for the purpose of providing the film with light scattering property by virtue of at least either surface scattering or internal scattering, and hardcoat property for enhancing the scratch resistance of the film. Accordingly, the light scattering layer is formed comprising a binder for imparting hardcoat property, a matting particle for imparting light scattering property, and, if desired, an inorganic filler for elevating the refractive index, preventing crosslinking shrinkage and intensifying the strength. Furthermore, when such a light scattering layer is formed, the light scattering layer functions also as an antiglare layer and the polarizing plate comes to have an antiglare layer.

From the standpoint of imparting the hardcoat property, the thickness of the light scattering layer is preferably from 1 to 10 μm, more preferably from 1.2 to 6 μm. When the thickness is not less than the lower limit above, a problem such as insufficient hard property is hardly caused, whereas when it is not more than the upper limit above, this advantageously eliminates a trouble such as that curling or brittleness is worsened and in turn the suitability for processing is impaired.

The binder of the light scattering layer is preferably a polymer having a saturated hydrocarbon chain or polyether chain as the main chain, more preferably a polymer having a saturated hydrocarbon chain as the main chain. Also, the binder polymer preferably has a crosslinked structure. The binder polymer having a saturated hydrocarbon chain as the main chain is preferably a polymer of an ethylenically unsaturated monomer. The binder polymer having a saturated hydrocarbon chain as the main chain and having a crosslinked structure is preferably a (co)polymer of a monomer having two or more ethylenically unsaturated groups. In order to obtain a binder polymer having a high refractive index, a monomer where an aromatic ring or at least one atom selected from a halogen atom (except for fluorine), a sulfur atom, a phosphorus atom and a nitrogen atom is contained in the structure of the monomer above may also be selected.

Examples of the monomer having two or more ethylenically unsaturated groups include an ester of a polyhydric alcohol and a (meth)acrylic acid {for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate}; an ethylene oxide-modified product of the ester above; vinylbenzene and a derivative thereof {for example, 1,4-divinylbenzene, 4-vinylbenzoic acid-2-acryloyl ethyl ester, 1,4-divinylcyclohexanone}; a vinylsulfone (for example, divinylsulfone); an acrylamide (for example, methylenebisacrylamide); and a methacrylamide. These monomers may be used in combination of two or more thereof.

Specific examples of the high refractive index monomer include bis(4-methacryloylthiophenyl)sulfide, vinylnaphthalene, vinylphenyl sulfide and 4-methacryloxyphenyl-4′-methoxyphenyl thioether. These monomers may also be used in combination of two or more thereof.

Such a monomer having an ethylenically unsaturated group can be polymerized by the irradiation of ionizing radiation or under heating, in the presence of a photo-radical initiator or a thermal radical initiator. Accordingly, the antireflection film can be formed by preparing a coating solution containing a monomer having an ethylenically unsaturated group, a photoradical initiator or thermal radical initiator, a matting particle and an inorganic filler, applying the coating solution onto the protective film, and curing the coating solution through a polymerization reaction under ionization radiation or heat. As for the photoradical initiator and the like, known materials can be used.

The polymer having a polyether as the main chain is preferably a ring-opening polymer of a polyfunctional epoxy compound. The ring-opening polymerization of a polyfunctional epoxy compound can be performed by the irradiation of ionizing radiation or under heating, in the presence of a photoacid generator or a heat-acid generator. Accordingly, the antireflection film can be formed by preparing a coating solution containing a polyfunctional epoxy compound, a photoacid generator or heat-acid generator, a matting particle and an inorganic filler, applying the coating solution onto the protective film, and curing the coating solution through a polymerization reaction under ionizing radiation or heat.

A crosslinked structure may also be introduced into the binder polymer by using a monomer having a crosslinking functional group in place of or in addition to the monomer having two or more ethylenically unsaturated groups and by introducing the crosslinking functional group into the polymer and causing a reaction of the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also, a vinylsulfonic acid, an acid anhydride, a cyanoacrylate derivative, a melamine, an etherified methylol, an ester, a urethane, and a metal alkoxide such as tetramethoxysilane can be used as the monomer for introducing a crosslinked structure. A functional group which exhibits crosslinking property as a result of decomposition reaction, such as blocked isocyanate group, may also be used. That is, the crosslinking functional group for use in the present invention may be a functional group which does no directly exhibit a reaction but exhibits reactivity as a result of decomposition.

The binder polymer having such a crosslinking functional group is coated and then heated, whereby a crosslinked structure can be formed.

In the light scattering layer, a matting particle larger than the filler particle and having an average particle size of 1 to 10 μm, preferably 1.5 to 7.0 μm, such as inorganic compound particle or resin particle, is contained for the purpose of imparting antiglare property. Specific preferred examples of the matting particle include an inorganic compound particle such as silica particle and TiO₂ particle; and a resin particle such as acrylic particle, crosslinked acrylic particle, polystyrene particle, crosslinked styrene particle, melamine resin particle and benzoguanamine resin particle. Among these, a crosslinked styrene particle, a crosslinked acrylic particle, a crosslinked acrylstyrene particle and a silica particle are preferred. The shape of the matting particle may be either spherical or amorphous.

Furthermore, two or more matting particles differing in the particle diameter may also be used in combination. A matting particle having a larger particle diameter can impart antiglare property, while imparting another optical property by a matting particle having a smaller particle diameter.

The particle diameter distribution of the matting particle is most preferably monodisperse, and individual particles preferably have the same particle diameter as much as possible. For example, when a particle having a particle diameter 20% or more larger than the average particle diameter is defined as a coarse particle, the percentage of coarse particles in the total number of particles is preferably 1% or less, more preferably 0.1% or less, still more preferably 0.01% or less. The matting particle having such a particle diameter distribution is obtained by classifying the particles after a normal synthesis reaction, and when the number of classifications is increased or the level of classification is elevated, a matting agent having a more preferred distribution can be obtained.

The matting particle is preferably contained in the light scattering layer such that the amount of the matting particle in the formed light scattering layer is from 10 to 1,000 mg/m², more preferably from 100 to 700 mg/m².

The particle size distribution of the matting particle is measured by a Coulter counter method, and the measured distribution is reduced to a particle number distribution.

In order to elevate the refractive index, the light scattering layer preferably contains, in addition to the above-described matting particle, an inorganic filler comprising an oxide of at least one metal selected from titanium, zirconium, aluminum, indium, zinc, tin and antimony and having an average particle diameter of 0.2 μm or less, preferably 0.1 μm or less, more preferably 0.06 μm or less.

Conversely, in order to increase the difference in the refractive index from the matting particle, a silicon oxide is preferably used in the light scattering layer using a high refractive index matting particle so that the refractive index of the layer can be kept rather low. The preferred particle diameter is the same as that of the above-described inorganic filler.

Specific examples of the inorganic filler for use in the light scattering layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. It is also preferred to treat the inorganic filler surface by silane coupling treatment or titanium coupling treatment. A surface treating agent having a functional group capable of reacting with the binder species on the filler surface is preferably used.

The amount of the inorganic filler added is preferably from 10 to 90%, more preferably from 20 to 80%, still more preferably from 30 to 75%, of the entire mass of the light scattering layer.

Such a filler causes no scattering because the particle diameter is sufficiently smaller than the wavelength of light, and the dispersion element obtained by dispersing the filler in the binder polymer behaves as an optically uniform material.

The bulk of a mixture of the binder and the inorganic filler in the light scattering layer preferably has a refractive index of 1.50 to 2.00, more preferably from 1.51 to 1.80. The refractive index in this range can be obtained by appropriately selecting the kind of the binder and inorganic filler and the ratio of the amounts thereof. How to select these can be easily known by previously performing an experiment.

Particularly, in order to prevent coating unevenness, drying unevenness, point defect or the like and ensure surface uniformity of the light scattering layer, the coating composition for the formation of the light scattering layer contains either a fluorine-containing surfactant or a silicone-containing surfactant or both thereof. Above all, a fluorine-containing surfactant is preferred, because with a smaller amount added, the effect of improving surface failures such as coating unevenness, drying unevenness and point defect of the antireflection film preferably used in the present invention can be brought out. The purpose is to impart suitability for high-speed coating while enhancing the surface uniformity and thereby elevate the productivity.

### [AR Film]

The antireflection layer (AR film) formed by stacking a medium refractive index layer, a high refractive index layer and a low refractive index layer in this order on the protective film is described below.

The antireflection layer comprising a layer structure having at least a medium refractive index layer, a high refractive index layer and a low refractive index layer (outermost layer) on the protective film is designed to have a refractive index satisfying the following relationship:

refractive index of high refractive index layer>refractive index of medium refractive index layer>refractive index of protective film>refractive index of low refractive index layer.

Also, a hardcoat layer may be provided between the protective film and the medium refractive index layer. Furthermore, the antireflection layer may comprise a medium refractive index layer, a hardcoat layer, a high refractive index layer and a low refractive index layer. Examples thereof include antireflection layers described in JP-A-8-122504, JP-A-8-110401, JP-A-10-300902, JP-A-2002-243906 and JP-A-2000-111706.

Other functions may be imparted to each layer, and examples of such a layer include an antifouling low refractive index layer and an antistatic high refractive index layer (see, for example, JP-A-10-206603 and JP-A-2002-243906).

The haze of the antireflection layer is preferably 5% or less, more preferably 3% or less. The surface strength of the film is, in a pencil hardness test according to JIS K5400, preferably H or more, more preferably 2H or more, and most preferably 3H or more.

### (High Refractive Index Layer and Medium Refractive Index Layer)

In the antireflection layer, the layer having a high refractive index comprises a cured film containing at least a matrix binder and an inorganic compound fine particle having a high refractive index and an average particle diameter of 100 nm or less.

The inorganic compound fine particle having a high refractive index includes an inorganic compound having a refractive index of 1.65 or more, preferably 1.9 or more. Examples thereof include an oxide of Ti, Zn, Sb, Sn, Zr, Ce, Ta, La or In, and a composite oxide containing such a metal atom.

Examples of the method for preparing such a fine particle include a method of treating the particle surface with a surface-treating agent (such as silane coupling agent, see, for example, JP-A-11-295503, JP-A-11-153703 and JP-A-2000-9908; anionic compound or organic metal coupling agent, see, for example, JP-A-2001-310432), a method of constituting a core-shell structure using a high refractive index particle as the core (see, for example, JP-A-2001-166104), and a method using a specific dispersant in combination (see, for example, JP-A-11-153703, U.S. Pat. No. 6,210,858 and JP-A-2002-277609).

Examples of the material for forming the matrix include conventionally known thermoplastic resin and curable resin films.

The material is preferably at least one composition selected from a polyfunctional compound-containing composition containing two or more polymerizable groups which are at least either one of a radical polymerizable group and a cation polymerizable group; a composition comprising a hydrolyzable group-containing organic compound; and a composition comprising its partial condensation product. Examples thereof include compounds described in JP-A-2000-47004, JP-A-2001-315242, JP-A-2001-31871 and JP-A-2001-296401.

A colloidal metal oxide obtained from a hydrolysis condensate of a metal oxide, and a curable film obtained from a metal alkoxide composition are also preferred, and these are described, for example, in JP-A-2001-293818.

The refractive index of the high refractive index layer is preferably from 1.70 to 2.20, and the thickness of the high refractive index layer is preferably from 5 nm to 10 μm, more preferably from 10 nm to 1 μm.

The refractive index of the medium refractive index layer is adjusted to a value between the refractive index of the low refractive index layer and the refractive index of the high refractive index layer. The refractive index of the medium refractive index layer is preferably from 1.50 to 1.70, and the thickness is preferably from 5 nm to 10 μm, more preferably from 10 nm to 1 μm.

### (Low Refractive Index Layer)

The low refractive index layer is sequentially stacked on the high refractive index layer. The refractive index of the low refractive index layer is preferably from 1.20 to 1.55, more preferably from 1.30 to 1.50.

The low refractive index layer is preferably constituted as an outermost layer having scratch resistance and antifouling property. For greatly enhancing the scratch resistance, it is effective to impart slipperiness to the surface, and conventionally known techniques for a thin film layer, such as introduction of silicone or introduction of fluorine, can be applied.

The fluorine-containing compound is preferably a compound containing from 35 to 80 mass % of a fluorine atom and having a crosslinking or polymerizable functional group. Examples thereof include compounds described in JP-A-9-222503 (paragraphs [0018] to [0026]), JP-A-11-38202 (paragraphs [0019] to [0030]), JP-A-2001-40284 (paragraphs [0027] and [0028]) and JP-A-2000-284102.

The refractive index of the fluorine-containing compound is preferably from 1.35 to 1.50, more preferably from 1.36 to 1.47.

The silicone compound is preferably a compound which has a polysiloxane structure and which contains a curable functional group or a polymerizable functional group in the polymer chain and forms a bridged structure in the film. Examples thereof include a reactive silicone [e.g., “SILAPLANE” {produced by Chisso Corp.}] and a polysiloxane containing a silanol group at both ends (see, for example, JP-A-1′-258403).

The crosslinking or polymerization reaction of at least either one polymer of the fluorine-containing polymer having a crosslinking or polymerizable group and the siloxane polymer is preferably performed by irradiating light or applying heat simultaneously with or after the coating of a coating composition containing a polymerization initiator, a sensitizer and the like for forming the outermost layer, whereby the low refractive index layer is formed.

A sol/gel cured film which is cured by the condensation reaction of an organic metal compound such as silane coupling agent and a specific silane coupling agent containing a fluorine-containing hydrocarbon group, in the co-presence of a catalyst, is also preferred.

Examples of the specific silane coupling agent include a polyfluoroalkyl group-containing silane compound or a partial hydrolysis condensate thereof (e.g., compounds described in JP-A-58-142958, JP-A-58-147483, JP-A-58-147484, JP-A-9-157582 and JP-A-11-106704), and a silyl compound containing a poly(perfluoroalkyl ether) group which is a fluorine-containing long chain group (e.g., compounds described in JP-A-2000-117902, JP-A-2001-48590 and JP-A-2002-53804).

In addition to these additives, the low refractive index layer may contain a filler {for example, a low refractive index inorganic compound having an average primary particle diameter of 1 to 150 nm, such as silicon dioxide (silica), fluorine-containing particle (e.g., magnesium fluoride, calcium fluoride, barium fluoride) and organic fine particle described in JP-A-11-3820 (paragraphs [0020] to [0038])}, a silane coupling agent, a slipping agent, a surfactant and the like.

In the case where the low refractive index layer underlies an outermost layer, the low refractive index layer may be formed by a vapor phase process (e.g., vacuum deposition, sputtering, ion plating, plasma CVD). In view of production at a low cost, a coating method is preferred.

The thickness of the low refractive index layer is preferably from 30 to 200 nm, more preferably from 50 to 150 nm, and most preferably from 60 to 120 nm.

### (Hardcoat Layer)

The hardcoat layer is provided on the surface of the protective film so as to impart physical strength to the protective film having provided thereon the antireflection layer. In particular, the hardcoat layer is preferably provided between the protective film and the high refractive index layer. The hardcoat layer is preferably formed through a crosslinking reaction or polymerization reaction of a photo- and/or heat-curable compound. The curable functional group in the curable compound is preferably a photopolymerizable functional group. A hydrolyzable functional group-containing organic metal compound or an organic alkoxysilyl compound is also preferred.

Specific examples of these compounds include those described above for the high refractive index layer.

Specific examples of the constitutional composition for the hardcoat layer include those described in JP-A-2002-144913, JP-A-2000-9908 and International Publication No. WO00/46617, pamphlet.

The high refractive index layer can serve also as the hardcoat layer. In such a case, the hardcoat layer is preferably formed containing fine particles finely dispersed by using the means described for the high refractive index layer.

The hardcoat layer can be made to serve also as an antiglare layer by incorporating thereinto particles having an average particle diameter of 0.2 to 10 μm and thereby imparting an antiglare function.

The thickness of the hardcoat layer can be appropriately designed according to the usage. The thickness of the hardcoat layer is preferably from 0.2 to 10 μm, more preferably from 0.5 to 7 μm.

The surface strength of the hardcoat layer is, in a pencil hardness test according to JIS K5400, preferably H or more, more preferably 2H or more, and most preferably 3H or more. Also, in a Taber test according to JIS K5400, the abrasion loss of a specimen between before and after the test is preferably smaller.

### (Other Layers of Antireflection Layer)

In addition to these layers, a forward scattering layer, a primer layer, an antistatic layer, an undercoat layer, a protective layer and the like may be provided.

### (Antistatic Layer)

In the case of providing an antistatic layer, an electrical conductivity of 10⁻⁸ (Ωcm⁻³) or less in terms of the volume resistivity is preferably imparted. A volume resistivity of 10⁻⁸ (Ωcm⁻³) may be imparted using a hygroscopic substance, a water-soluble inorganic salt, a certain kind of surfactant, a cationic polymer, an anionic polymer, a colloidal silica or the like, but these have a problem that the dependency on temperature and humidity is large and a sufficient electrical conductivity cannot be ensured at low humidity. Therefore, the material for the electrically conducting layer is preferably a metal oxide. Some metal oxides are colored and if such a metal oxide is used as the material for the electrically conducting layer, the film as a whole is detrimentally colored. Examples of the metal for forming a non-colored metal oxide include Zn, Ti, Sn, Al, In, Si, Mg, Ba, Mo, W and V. A metal oxide mainly comprising such a metal is preferably used.

Specific examples of the metal oxide include ZnO, TiO₂, SnO₂, Al₂O₃, In₂O₃, SiO₂, MgO, BaO, MoO₃, WO₃, V₂O₅ and a composite oxide thereof. Among these, ZnO, TiO₂ and SnO₂ are preferred. In the case of containing a heteroatom, for example, addition of Al, In or the like is effective for ZnO, addition of Sb, Nb, halogen atom or the like is effective for SnO2, and addition of Nb, Ta or the like is effective for TiO₂.

Furthermore, as described in JP-B-59-6235, a material prepared by attaching the above-described metal oxide to another crystalline metal particle or fibrous material (for example, titanium oxide) may also be used. Incidentally, the volume resistance value is a physical value different from the surface resistance value and these cannot be simply compared, but in order to ensure electrical conductivity of 10⁻⁸ (Ωcm⁻³) or less in terms of the volume resistance value, it is sufficient that the antistatic layer has a surface resistance value of generally 10⁻¹⁰ (Ω/square) or less, preferably 10⁻⁸ (Ω/square). The surface resistance value of the antistatic layer must be measured as a value when the antistatic layer is an outermost layer, and this value can be measured on the way of forming the laminate film.

### [Liquid Crystal Display Device]

The optical film of the present invention or the polarizing plate obtained by laminating the optical film to a polarizing film is advantageously used for a liquid crystal display device, particularly, a transmission-type liquid crystal display device.

The transmission-type liquid crystal display device comprises a liquid crystal cell and two polarizing plates disposed on both sides thereof. The polarizing plate comprises a polarizing film and two transparent protective films disposed on both sides thereof. The liquid crystal cell carries a liquid crystal between two electrode substrates.

One sheet of the polarizing plate of the present invention is disposed on one side of the liquid crystal cell, or two sheets thereof are disposed on both surfaces of the liquid crystal cell.

The liquid crystal cell is preferably VA mode, OCB mode, IPS mode or TN mode, more preferably OCB mode, IPS mode or VA mode.

In the VA-mode liquid crystal cell, rod-like liquid crystalline molecules are oriented substantially in the vertical alignment when a voltage is not applied.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) an (MVA-mode) liquid crystal cell where the VA mode is modified to a multi-domain system for enlarging the viewing angle (described in SID97, Digest of Tech. Papers (preprints), 28, 845 (1997)); (3) an (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

In the case of a VA-mode liquid crystal display device, when using one sheet of the polarizing plate of the present invention, the polarizing plate is preferably used on the backlight side.

The OCB-mode liquid crystal cell is a liquid crystal cell of bend orientation mode where rod-like liquid crystalline molecules are oriented substantially in the reverse direction (symmetrically) between upper portion and lower portion of the liquid crystal cell. The liquid crystal display device using a liquid crystal cell of bend orientation mode is disclosed in U.S. Pat. Nos. 4,583,825 and 5,410,422. Since rod-like liquid crystalline molecules are symmetrically oriented between upper portion and lower portion of the liquid crystal cell, the liquid crystal cell of bend orientation mode has an optically self-compensating ability.

Accordingly, this liquid crystal mode is called an OCB (optically compensatory bend) liquid crystal mode. A liquid crystal display device of bend orientation mode is advantageous in that the response speed is fast.

The IPS-mode liquid crystal display device has a liquid crystal cell comprising comprises a pair of substrates sandwiching a liquid crystal layer, a group of electrodes formed on one of the paired substrates, a liquid crystal composition substance layer having dielectric anisotropy and being sandwiched between the substrates, an orientation control layer formed to face the paired substrates for aligning the molecular orientation of the liquid crystal composition substance to a predetermined direction, and driving means for applying a driving voltage to the group of electrodes. The group of electrodes has an array structure where the electrodes are disposed to apply an electric field mainly parallel to the interface between the orientation control layer and the liquid crystal composition substance layer.

In the TN-mode liquid crystal cell, rod-like liquid crystalline molecules are oriented substantially in the horizontal alignment at the time of not applying a voltage and furthermore, twisted at an angle of 60 to 120°.

The TN-mode liquid crystal cell is most frequently utilized in a color TFT liquid crystal display device and described in a large number of publications.

### EXAMPLES

The present invention is described in greater detail by referring to Examples and Comparative Examples, but the present invention is not limited to these Examples.

### Examples 1 to 10

### Comparative Examples 1 to 6

### Reference Example

### Production of Optical Film>

### (1) Cellulose Acylate

A cellulose acylate is prepared by adding a sulfuric acid as a catalyst to the raw material cellulose, further adding an anhydrous carboxylic acid working out to the raw material of an acyl substituent, thereby performing an acylation reaction, and thereafter subjecting the reaction product to neutralization, saponification and ripening. At this time, the amount of catalyst, the kind and amount of anhydrous carboxylic acid, the amount added of neutralizer, the amount added of water, the reaction temperature and the ripening temperature are adjusted to prepare cellulose acylates differing in the kind of acyl group, the substitution degree, the bulk specific gravity and the polymerization degree. Furthermore, each cellulose acylate is washed with acetone to remove the low molecular weigh components.

Out of the thus-prepared cellulose acylates, the following dope is prepared using a cellulose acylate having acetyl group substitution degrees of DS2+DS3+DS6=2.79 and DS6/(DS2+DS3+DS6)=0.322.

### (2) Preparation of Dope

### <1-1> Cellulose Acylate Solution

The following composition is charged into a mixing tank and stirred to dissolve respective components, and the obtained solution is heated at 90° C. for about 10 minutes and then filtered through a filter paper having an average pore size of 34 μm and a calcined metal filter having an average pore size of 10 μm. Here, the additive is selected from Additives 1 to 3 according to Table 1.

Cellulose Acylate Solution

| | |
|---|---|
| Cellulose acetate | 100.0 parts by mass |
| Additive | 12.0 parts by mass |
| Methylene chloride | 403.0 parts by mass |
| Methanol | 60.2 parts by mass |

Additive 1: humidity dependency improver

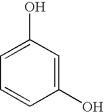

Additive 2: humidity dependency improver

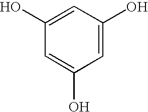

Additive 3: plasticizer
A mixture of triphenyl phosphate/biphenyl diphenyl phosphate = 2/1 (by
weight)

### <1-2> Matting Agent Liquid Dispersion

The following composition containing the cellulose acylate solution prepared by the above-described method is charged into a disperser to prepare a matting agent liquid dispersion.

Matting Agent Liquid Dispersion

| | |
|---|---|
| Silica particle having an average particle | 2.0 parts by mass |
| diameter of 16 nm (aerosil R972, produced | |
| by Nihon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution

The following composition containing the cellulose acylate solution prepared by the above-described method is charged into a mixing tank and dissolved by stirring under heating to prepare a retardation developer solution.

Retardation Developer Solution

| | |
|---|---|
| Rth Developer A | 20.0 parts by mass |
| Methylene chloride | 58.3 parts by mass |
| Methanol | 8.7 parts by mass |
| Cellulose acylate solution | 12.8 parts by mass |

100 Parts by mass of the cellulose acylate solution, 1.35 parts by mass of the matting agent liquid dispersion and the retardation developer solution in an amount causing Rth Developer A to occupy 5.1 parts by mass in the optical film are mixed to prepare a dope for film formation.

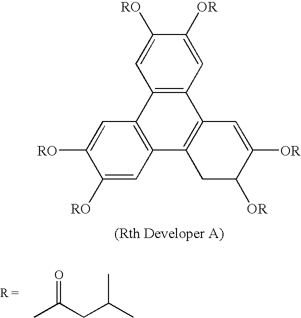

### (Casting)

The dope prepared above is cast using a glass sheet casting device. The dope is dried with hot air at a charge air temperature of 70° C. for 6 minutes, and the film peeled off from the glass sheet is fixed to a frame and dried with hot air at a charge air temperature of 100° C. for 10 minutes and further with hot air at a charge air temperature of 140° C. for 20 minutes to produce an optical film having a thickness of 108 μm. The glass transition temperature of the optical film is 140° C.

This film is subjected to stretching and shrinking under the conditions shown in Table 1 while gripping four sides by a biaxial stretching tester (manufactured by Toyo Seiki Seisaku-Sho, Ltd.). As the common condition, the film before stretching is preheated at the charge air temperature indicated in each Example for 3 minutes to confirm that the film surface temperature measured by a non-contact infrared thermometer is within the charge air temperature±1° C. After stretching, the film is cooled by blowing air for 5 minutes while keeping the gripping by the clip. In the Table, MD indicates the casting direction at the glass sheet casting and TD indicates the width direction orthogonal thereto.

### <Wrinkle of Film>

The wrinkle of the film is visually evaluated.

C: wrinkle can be observed clearly

B: wrinkle can be observed if the film is carefully viewed

A: wrinkle cannot be observed even if the film is carefully viewed

### <Re and Rth of Film for Light at Wavelengths of 450, 550 and 650 nm>

The Re and Rth of this film for light at wavelengths of 450, 550 and 650 nm are measured by KOBRA 21ADH (manufactured by Oji Test Instruments) according to the method described above.

The results are shown in Table 1. It is seen from Table 1 that the Re and Rth of the optical film produced by the production method of the present invention for light at wavelengths of 450, 550 and 650 nm satisfy all of the relationships of formulae (Ia), (Ib), (II) and (III).

### <Humidity Dependency of Re>

The optical film obtained is humidity-conditioned at 25° C.-10% RH and 25° C.-80% RH for 2 hours or more, and the retardation Re in those environments is measured. At this time, ΔRe(550)=Re(550)10%RH−Re(550)80%RH is calculated as the variation of retardation Re at a wavelength 550 nm from 10% RH to 80% RH.

It is seen from Table 1 that in the optical film of the present invention, ΔRe(550) is small as compared with the optical film of Comparative Example and the humidity dependency of Re is reduced.

TABLE 1

| | | Stretching | Shrinking | | | | | | | | | |
|---|---|---|---|---|---|---|---|---|---|---|---|---|
| | Charge Air | Direction/ | Direction/ | | | Re | Rth | Value of | Value of | Value of | Value of | |
| | Temperature | Stretch | Shrinkage | | Wrinkle | (550) | (550) | Formula | Formula | Formula | Formula | ΔRe |
| | (° C.) | Ratio | Ratio | Additive | of Film | (nm) | (nm) | (Ia) | (II) | (II) | (III) | (550) |
| Example 1 | 160 | TD/20% | MD/13% | 1 | A | 45 | 160 | 0.85 | 1.10 | 0.90 | 1.05 | 5 |
| Example 2 | 180 | TD/35% | MD/30% | 2 | A | 69 | 190 | 0.70 | 1.25 | 0.80 | 1.20 | 7 |
| Example 3 | 180 | TD/30% | MD/15% | 2 | A | 52 | 115 | 0.60 | 1.60 | 0.67 | 1.40 | 6 |
| Example 4 | 180 | TD/20% | MD/25% | 1 | A | 55 | 121 | 0.61 | 1.62 | 0.66 | 1.38 | 6 |
| Example 5 | 140 | TD/15% | MD/8% | 1 | A | 35 | 145 | 0.80 | 1.15 | 0.85 | 1.10 | 4 |
| Example 6 | 190 | TD/35% | MD/30% | 2 | A | 20 | 165 | 0.09 | 1.80 | 0.11 | 1.60 | 3 |
| Comparative | 160 | TD/20% | MD/13% | 3 | A | 45 | 160 | 0.84 | 1.11 | 0.89 | 1.04 | 25 |
| Example 1 | | | | | | | | | | | | |
| Comparative | 180 | TD/35% | MD/30% | 3 | A | 69 | 190 | 0.71 | 1.24 | 0.81 | 1.19 | 35 |
| Example 2 | | | | | | | | | | | | |
| Comparative | 180 | TD/30% | MD/15% | 3 | A | 51 | 114 | 0.59 | 1.59 | 0.68 | 1.41 | 29 |
| Example 3 | | | | | | | | | | | | |
| Comparative | 180 | TD/20% | MD/25% | 3 | A | 55 | 121 | 0.62 | 1.63 | 0.65 | 1.37 | 31 |
| Example 4 | | | | | | | | | | | | |
| Comparative | 160 | TD/15% | MD/fixed width | 1 | A | 18 | 90 | 1.00 | 1.00 | 1.05 | 0.95 | 2 |
| Example 5 | | | | | | | | | | | | |
| Comparative | 180 | TD/35% | MD/fixed width | 2 | A | 55 | 185 | 1.00 | 1.00 | 1.05 | 0.95 | 6 |
| Example 6 | | | | | | | | | | | | |
| Example 7 | 160 | TD/15% | MD/7% | 1 | A | 23 | 109 | 0.94 | 1.06 | 0.94 | 1.04 | 3 |
| Example 8 | 170 | TD/35% | MD/10% | 2 | A | 53 | 116 | 0.93 | 1.07 | 0.93 | 1.05 | 6 |
| Example 9 | 180 | TD/10% | MD/20% | 1 | B | 45 | 160 | 0.85 | 1.10 | 0.90 | 1.05 | 5 |
| Example 10 | 180 | TD/20% | MD/40% | 2 | B | 69 | 190 | 0.70 | 1.25 | 0.80 | 1.20 | 7 |
| Reference | 180 | TD/20% | MD/free width | 1 | A | 51 | 160 | 0.70 | 1.20 | 0.70 | 1.20 | 5 |
| Example | | | | | | | | | | | | |

### <Production of Polarizing Plate>

A polarizing film is produced by adsorbing iodine to a stretched polyvinyl alcohol film.

The optical films produced in Examples 1 to 10, Comparative Examples 1 to 6 and Reference Example each is laminated to one side of the polarizing film by using a polyvinyl alcohol-based adhesive. Here, the saponification treatment is performed under the following conditions.

An aqueous solution containing 1.5 mol/liter of sodium hydroxide is prepared and kept at 55° C. Also, an aqueous solution containing 0.01 mol/liter of dilute sulfuric acid is prepared and kept at 35° C. The optical film produced is dipped in the aqueous sodium hydroxide solution prepared above for 2 minutes and then dipped in water to thoroughly wash out the aqueous sodium hydroxide solution. Subsequently, the film is dipped in the aqueous dilute sulfuric acid solution prepared above for 1 minute and then dipped in water to thoroughly wash out the aqueous dilute sulfuric acid solution. Thereafter, the sample is thoroughly dried at 120° C.

A commercially available cellulose triacylate film (FUJI-TAC TD80UF, produced by Fuji Photo Film Co., Ltd.) is saponified, then laminated to the opposite side of the polarizer by using a polyvinyl alcohol-based adhesive, and dried at 70° C. for 10 minutes or more.

The transmission axis of the polarizing film and the slow axis of the optical film produced as above are arranged to run in parallel. Also, the transmission axis of the polarizing film and the slow axis of the commercially available cellulose triacylate film are arranged to cross at right angles.

### <Production of Liquid Crystal Cell>

The liquid crystal cell is produced by setting the cell gap between substrates to 3.6 μm, injecting dropwise a liquid crystal material (“MLC6608”, produced by Merck Ltd.) with negative dielectric anisotropy between the substrates, and encapsulating it to form a liquid crystal layer between the substrates. The retardation of the liquid crystal layer (that is, a product Δn·d of the thickness d (μm) and the refractive index anisotropy Δn of the liquid crystal layer) is set to 300 nm. Incidentally, the liquid crystal material is oriented in the vertical alignment.

### <Mounting on VA Panel>

A commercially available superhigh contrast product (HLC2-5618, manufactured by Sanritz Corp.) is used for the upper polarizing plate (viewer side) of a liquid crystal display device using the vertically aligned liquid crystal cell produced above. For the lower polarizing plate (backlight side), the polarizing plate using the cellulose acylate film produced in each of Examples 1, 2, 9 and 10, Comparative Examples 1 to 6 and Reference Example is disposed by arranging the cellulose acylate film to come to the liquid crystal cell side. The upper polarizing plate and lower polarizing plate each is laminated to the liquid crystal cell through a pressure-sensitive adhesive. At this time, a cross-Nicol arrangement is employed such that the transmission axis of the upper polarizing plate runs in the vertical direction and the transmission axis of the lower polarizing plate runs in the horizontal direction.

A rectangular wave voltage of 55 Hz is applied to the liquid crystal cell to set a normally black mode with white display of 5 V and black display of 0 V. The black display transmittance (%) at a viewing angle in the direction of azimuthal angle of 45° and polar angle 60° at the black display time and the color shift Δx between the polar angle of 60° at an azimuthal angle of 45° and the polar angle of 60° at an azimuthal angle of 180° are determined. The results are shown in Table 1. Also, on the condition that the transmittance ratio (white display/black display) is a contrast ratio, the viewing angle is measured in 8 steps from black display (L1) to white display (L8) (the polar angle range where the contrast ratio is 10 or more and the black side is free from tone reversal) by using a measuring apparatus (EZ-Contrast 160D, manufactured by ELDIM). The results are shown in Table 2. The produced liquid crystal display device is observed, as a result, it is found that in Examples 1, 2, 9 and 10, a neutral black display can be realized in both the front direction and the viewing angle direction. Viewing Angle (polar angle range where the contrast ratio is 10 or more and the black side is free from tone reversal):

A: The polar angle is 80° or more in up/down right/left directions.

B: The polar angle is 80° or more in 3 directions out of up/down right/left directions.

C: The polar angle is 80° or more in 2 directions out of up/down right/left directions.

D: The polar angle is 80° or more in 0 to 1 direction out of up/down right/left directions.

### Color Shift (Δx):

A: less than 0.02

B: from 0.02 to 0.04

C: from 0.04 to 0.06

D: more than 0.06

TABLE 2

| | Viewing Angle | Color Shift |
|---|---|---|
| Example 1 | B | B |
| Example 2 | A | A |
| Comparative Example 1 | B | B |
| Comparative Example 2 | A | A |
| Comparative Example 3 | D | C |
| Comparative Example 4 | D | C |
| Comparative Example 5 | D | D |
| Comparative Example 6 | A | D |
| Example 9 | A | B |
| Example 10 | A | A |
| Reference Example | B | B |

### Examples 1 to 14

Optical films are produced thoroughly in the same manner as in Example 2 except that the relationship of the substitution degree DS2 by an acyl group to the hydroxyl group at the 2-position of the glucose unit of the cellulose acylate used, the substitution degree DS3 by an acyl group to the hydroxyl group at the 3-position and the substitution degree DS6 by an acyl group to the hydroxyl group at the 6-position is adjusted as shown in Table 3. Each optical film is processed into a polarizing plate, and the polarizing plate is mounted on a VA panel and evaluated. The evaluation results are shown in Table 3. In Example 11, a neutral black display can be realized in both the front direction and the viewing angle direction. Also, in Example 12, the color shift is small and a neutral black display can be realized. These results reveal that such a performance can be improved by adjusting the substitution degrees (DS2+DS3+DS6) and DS6/(DS2+DS3+DS6) by an acyl group to the hydroxyl group of the glucose unit of the optical film.

TABLE 3

| | (DS2 + | | | | Value of | Value of | Value of | Value of | | | |
|---|---|---|---|---|---|---|---|---|---|---|---|
| | DS3 + | DS6/(DS2 + | Re(550) | Rth(550) | Formula | Formula | Formula | Formula | ΔRe | Viewing | Color |
| | DS6) | DS3 + DS6) | (nm) | (nm) | (Ia) | (Ib) | (II) | (III) | (550) | Angle | Shift |
| Example 11 | 2.5 | 0.34 | 57 | 180 | 0.85 | 1.15 | 0.85 | 1.1 | 6 | B | A |
| Example 12 | 1.9 | 0.33 | 40 | 170 | 0.95 | 1.2 | 0.85 | 1.0 | 4 | B | B |
| Example 13 | 2.75 | 0.28 | 35 | 150 | 0.7 | 1.1 | 1.0 | 1.1 | 3 | C | B |
| Example 14 | 1.8 | 0.3 | 21 | 130 | 1.0 | 1.2 | 0.8 | 1.2 | 3 | C | B |

### Examples 15 and 16

### Comparative Example 7 and Examples 17 to 22

### <Mounting on VA Panel>

The polarizing plate comprising the optical film produced in each of Examples 3 and 4, Comparative Example 5, and Examples 7, 8 and 11 to 14 is disposed on both the upper polarizing plate (viewer side) and the lower polarizing plate (backlight side) of a liquid crystal display device using the vertically aligned liquid crystal cell produced above, by arranging the optical film on the liquid crystal cell side. The upper polarizing plate and lower polarizing plate are laminated to the liquid crystal cell through a pressure-sensitive adhesive. At this time, a cross-Nicol arrangement is employed such that the transmission axis of the upper polarizing plate runs in the vertical direction and the transmission axis of the lower polarizing plate runs in the horizontal direction. In this way, liquid crystal display devices of Examples 15 and 16, Comparative Example 7 and Examples 17 to 22 are produced.

A rectangular wave voltage of 55 Hz is applied to the liquid crystal cell to set a normally black mode with white display of 5 V and black display of 0 V. The black display transmittance (%) at a viewing angle in the direction of azimuthal angle of 45° and polar angle 60° at the black display time and the color shift Δx between the polar angle of 60° at an azimuthal angle of 45° and the polar angle of 60° at an azimuthal angle of 180° are determined. The results are shown in Table 4. Also, on the condition that the transmittance ratio (white display/black display) is a contrast ratio, the viewing angle is measured in 8 steps from black display (L1) to white display (L8) (the polar angle range where the contrast ratio is 10 or more and the black side is free from tone reversal) by using a measuring apparatus (EZ-Contrast 160D, manufactured by ELDIM). The results are shown in Table 4. The produced liquid crystal display device is observed, as a result, it is found that in Examples 15 to 18, 21 and 22, a neutral black display can be realized in both the front direction and the viewing angle direction. Viewing Angle (polar angle range where the contrast ratio is 10 or more and the black side is free from tone reversal):

A: The polar angle is 80° or more in up/down right/left directions.

B: The polar angle is 80° or more in 3 directions out of up/down right/left directions.

C: The polar angle is 80° or more in 2 directions out of up/down right/left directions.

D: The polar angle is 80° or more in 0 to 1 direction out of up/down right/left directions.

### Color Shift (Δx):

A: less than 0.02

B: from 0.02 to 0.04

C: from 0.04 to 0.06

D: more than 0.06

TABLE 4

| | (DS2 + | | | | Value of | Value of | Value of | Value of | | | |
|---|---|---|---|---|---|---|---|---|---|---|---|
| | DS3 + | DS6/(DS2 + | Re(550) | Rth(550) | Formula | Formula | Formula | Formula | ΔRe | Viewing | Color |
| | DS6) | DS3 + DS6) | (nm) | (nm) | (Ia) | (Ib) | (II) | (III) | (550) | Angle | Shift |
| Example 15 | 2.79 | 0.322 | 52 | 115 | 0.60 | 1.60 | 0.67 | 1.40 | 6 | A | A |
| Example 16 | 2.79 | 0.322 | 55 | 121 | 0.61 | 1.62 | 0.66 | 1.38 | 6 | A | A |
| Comparative | 2.79 | 0.322 | 18 | 90 | 1.00 | 1.00 | 1.05 | 0.95 | 2 | B | D |
| Example 7 | | | | | | | | | | | |
| Example 17 | 2.79 | 0.322 | 23 | 109 | 0.94 | 1.06 | 0.94 | 1.04 | 3 | A | B |
| Example 18 | 2.79 | 0.322 | 53 | 116 | 0.93 | 1.07 | 0.93 | 1.05 | 6 | A | B |
| Example 19 | 2.5 | 0.340 | 57 | 180 | 0.85 | 1.15 | 0.85 | 1.1 | 6 | C | A |
| Example 20 | 1.9 | 0.330 | 40 | 170 | 0.95 | 1.2 | 0.85 | 1.0 | 4 | C | B |
| Example 21 | 2.75 | 0.280 | 35 | 150 | 0.7 | 1.1 | 1.0 | 1.1 | 3 | A | A |
| Example 22 | 1.8 | 0.300 | 21 | 130 | 1.0 | 1.2 | 0.8 | 1.2 | 3 | B | B |

### Example 23

### Evaluation of Mounting on OCB Panel

### (Alkali Treatment)

The optical film produced in Example 1 is coated with 10 ml/m² of an aqueous 1.0 mol/L potassium hydroxide solution (solvent: water/isopropyl alcohol/propylene glycol=69.2 parts by mass/15 parts by mass/15.8 parts by mass) and kept in a state of about 40° C. for 30 seconds. Subsequently, the alkali solution is scraped off and after washing with pure water, the water droplets are removed by an air knife. The film is then dried at 100° C. for 15 seconds.

The contact angle for pure water on the alkali-treated surface is measured and found to be 42°.

### (Formation of Orientation Film)

A coating solution for orientation film having the following composition is coated on the alkali-treated surface by a #16 wire bar coater in an amount of 28 ml/m² and dried with warm air at 60° C. for 60 seconds and further with warm air at 90° C. for 150 seconds to form an orientation film.

Composition of Coating Solution for Orientation Film

| | |
|---|---|
| Modified polyvinyl alcohol shown below | 10 parts by mass |
| Water | 371 parts by mass |
| Methanol | 119 parts by mass |
| Glutaraldehyde (crosslinking agent) | 0.5 parts by mass |
| Citric acid ester (AS3, produced by Sankyo | 0.35 parts by mass |
| Chemical Co., Ltd.) | |

Modified Polyvinyl Alcohol:

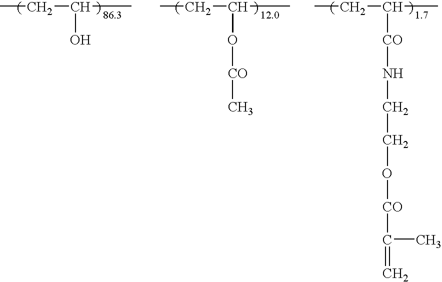

### (Rubbing Treatment)

The transparent support having formed thereon the orientation film is conveyed at a speed of 20 m/min, and a rubbing roll (diameter: 300 mm) is set to apply rubbing at 45° with respect to the longitudinal direction and rotated at 650 rpm, whereby the transparent support surface on which the orientation film is provided is rubbed. The contact length between the rubbing roll and the transparent support is set to 18 mm.

### (Formation of Another Optically Anisotropic Layer)

In 102 Kg of methyl ethyl ketone, 41.01 Kg of the discotic liquid crystalline compound used in Example 1, 4.06 Kg of ethylene oxide-modified trimethylolpropane triacrylate (V#360, produced by Osaka Organic Chemical Industry Ltd.), 0.35 Kg of cellulose acetate butyrate (CAB531-1, produced by Eastman Chemical), 1.35 Kg of a photopolymerization initiator (Irgacure 907, produced by Ciba Geigy) and 0.45 Kg of a sensitizer (Kayacure DETX, produced by Nippon Kayaku Co., Ltd.) are dissolved. To the resulting solution, 0.1 Kg of a fluoroaliphatic group-containing copolymer (Megafac F780, produced by Dainippon Ink and Chemicals, Inc.) is added to prepare a coating solution. This coating solution is continuously coated on the orientation film surface of the transparent support under conveyance at 20 m/min by rotating a #3.2 wire bar at 391 revolutions in the same direction as the film conveying direction.

The resulting film is continuously heated from room temperature to 100° C. to dry the solvent and then dried in a drying zone at 130° C. for about 90 seconds such that the wind velocity on the surface of the discotic optically anisotropic layer becomes 2.5 m/sec, whereby the discotic liquid crystalline compound is aligned. Subsequently, this film is conveyed to a drying zone at 80° C. and in the state of the film surface temperature being at about 100° C., irradiated with an ultraviolet ray at an illuminance of 600 mW for 4 seconds by using an ultraviolet irradiating apparatus (ultraviolet lamp, output: 160 W/cm, emission length: 1.6 m) to allow a crosslinking reaction to proceed, whereby the alignment of the discotic liquid crystalline compound is fixed. Thereafter, the film is allowed to cool to room temperature and cylindrically taken up into a roll form. In this way, a rolled optically-compensatory film (KH-3) is produced.

The viscosity of the optically anisotropic layer is measured at a film surface temperature of 127° C. and found to be 695 cp. The viscosity is a result when a crystal layer (excluding the solvent) having the same composition as the optically anisotropic layer is measured by an E-type viscometer using heating.

A part of the rolled optically-compensatory film KH-3 produced is cut out and using this as a sample, the optical properties are measured. The Re retardation value of the optically anisotropic layer measured at a wavelength of 546 nm is 38 nm. Also, the angle (tilt angle) between the disc plane of the discotic liquid crystalline compound in the optically anisotropic layer and the support plane is continuously changed in the layer thickness direction and is 28° on average. Furthermore, only the optically anisotropic layer is separated from the sample, and the average direction of the molecular axis of symmetry of the optically anisotropic layer is measured and found to be 45° with respect to the longitudinal direction of the optically-compensatory film.

### (Production of Polarizing Plate)

A polarizing film is produced by adsorbing iodine to a stretched polyvinyl alcohol film, and the film (KH-3) produced is laminated to one side of the polarizing film by using a polyvinyl alcohol-based adhesive. The transmission axis of the polarizing film and the slow axis of the retardation plate (KH-3) are arranged to run in parallel.

A commercially available cellulose acetate film (FUJI-TAC TD80UF, produced by Fuji Photo Film Co., Ltd.) is saponified and then laminated to the opposite side of the polarizing film by using a polyvinyl alcohol-based adhesive. In this way, a polarizing plate is produced.

### (Production of Bend-Aligned Liquid Crystal Cell)

A polyimide film is provided as an orientation film on a glass substrate with an ITO electrode, and the orientation film is subjected to rubbing. Two sheets of the thus-obtained glass substrate are laid to face each other by arranging the rubbing directions in parallel, and the cell gap is set to 4.7 μm. A liquid crystalline compound (ZLI1132, produced by Merck Ltd.) having Δn of 0.1396 is injected into the cell gap to produce a bend-aligned liquid crystal cell.

Two sheets of the polarizing plate produced by the method above are laminated to sandwich the bend-aligned cell obtained. These are disposed such that the optically anisotropic layer of the polarizing plate faces the cell substrate, and the rubbing direction of the liquid crystal cell and the rubbing direction of “another” optically anisotropic layer facing the liquid crystal cell are antiparallel with each other.

A rectangular wave voltage of 55 Hz is applied to the liquid crystal cell to set a normally black mode with white display of 2 V and black display of 5 V. A voltage at which the transmittance at the front becomes minimum, that is, a black voltage, is applied and the produced liquid crystal display device is observed, as a result, it is found that a neutral black display can be realized in both the front direction and the viewing angle direction.

### Examples 24 and 25 and Comparative Examples 8 and 9

Using a cellulose acylate having an acetyl group substitution degree of 2.00, a propionyl group substitution degree of 0.60 and a viscosity average polymerization degree of 350 out of the cellulose acylates prepared, 100 parts by mass of the cellulose acylate, 12 parts by mass of Additive 1 (humidity dependency improver), 290 parts by mass of methylene chloride and 60 parts by mass of ethanol are charged into a closed vessel, the temperature is gradually elevated while slowly stirring the mixture, and the mixture is dissolved by elevating the temperature up to 80° C. over 60 minutes. The pressure in the vessel becomes 1.5 atm. The resulting dope is filtered using Azumi Filter Paper No. 244 produced by Azumi Filter Paper Co., Ltd. and then left standing for 24 hours to remove bubbles in the dope.

Separately, 5 parts by mass of the cellulose acylate above, 5 parts by mass of TINUVIN 109 (produced by Ciba Specialty Chemicals Corp.), 15 parts by mass of TINUVIN 326 (produced by Ciba Specialty Chemicals Corp.), and 0.5 parts by mass of AEROSIL R972V (produced by Nihon Aerosil Co., Ltd.) are mixed with 94 parts by mass of methylene chloride and 8 parts by mass of ethanol and dissolved with stirring to prepare an ultraviolet absorbent solution. R972V is added by previously dispersing it in the ethanol above.

The ultraviolet absorbent solution is added to the dope at a ratio of 6 parts by mass per 100 parts by mass of dope and thoroughly mixed by a static mixer.

### (Casting)

The thus-prepared dope is cast by the same method as in (Casting) of Example 1 and an optical film having a thickness of 108 μm is produced. The glass transition temperature of the optical film is 140° C. This film is subjected to stretching and shrinking under the conditions shown in Table 5 while gripping four sides by a biaxial stretching tester according to the same method as in (Casting) above.

Using the film passed through stretching•shrinking steps in this way, measurement and production of a polarizing plate are performed in the same manner as in <Re and Rth of Film for Light at Wavelengths of 450, 550 and 650 nm> and <Production of Polarizing Plate> of Example 1. Furthermore, evaluation of mounting is performed through the same procedure as in <Production of Liquid Crystal Cell> of Example 1 and <Mounting on VA Panel> of Example 9. The results are shown in Table 5.

TABLE 5

| | Charge Air | Stretching | Shrinking Direction/ | Treatment | Re(550) | |
|---|---|---|---|---|---|---|
| | Temperature (° C.) | Direction/Stretch Ratio | Shrinkage Ratio | Order | (nm) | Rth(550) (nm) |
| Example 24 | 160 | TD/20% | MD/10% | Pattern 2 | 45 | 127 |
| Example 25 | 180 | TD/30% | MD/15% | Pattern 2 | 60 | 116 |
| Comparative Example 8 | 160 | TD/20% | MD/fixed width | Pattern 7 | 40 | 120 |
| Comparative Example 9 | 180 | TD/20% | MD/fixed width | Pattern 7 | 55 | 110 |

| | Value of Formula | Value of Formula | Value of Formula | Value of Formula | Viewing | Color | |
|---|---|---|---|---|---|---|---|
| | (Ia) | (Ib) | (II) | (III) | Angle | Shift | ΔRe(550) |
| Example 24 | 0.9 | 1.1 | 0.9 | 1.15 | A | A | 5 |
| Example 25 | 0.85 | 1.15 | 0.8 | 1.2 | A | A | 6 |
| Comparative Example 8 | 1.0 | 1.0 | 1.05 | 0.95 | A | D | 4 |
| Comparative Example 9 | 1.05 | 0.9 | 1.1 | 1.0 | A | D | 4 |

### Examples 26 to 28

Cellulose acylate films are produced in the same manner as in Example 24 except for changing the substitution degrees by acetyl group (abbreviated as Ac), propionyl group (abbreviated as Pr), butyryl group (abbreviated as Bt) and benzoyl group (abbreviated as Bz) to the values shown in Table 6. The measurement and evaluation of mounting are performed also in the same manner as in Example 24.

TABLE 6

| | Ac Sub- | Pr Sub- | Bt Sub- | Bz Sub- | | | Value of | Value of | Value of | Value of | | | |
|---|---|---|---|---|---|---|---|---|---|---|---|---|---|
| | stitution | stitution | stitution | stitution | Re(550) | Rth(550) | Formula | Formula | Formula | Formula | Viewing | Color | ΔRe |
| | Degree | Degree | Degree | Degree | (nm) | (nm) | (Ia) | (Ib) | (II) | (III) | Angle | Shift | (550) |
| Example 26 | 1.98 | 0.72 | 0 | 0 | 45 | 128 | 0.9 | 1.1 | 0.85 | 1.1 | A | A | 6 |
| Example 27 | 2.0 | 0 | 0.7 | 0 | 41 | 122 | 0.8 | 1.15 | 0.9 | 1.2 | A | A | 7 |
| Example 28 | 2.0 | 0 | 0 | 0.7 | 50 | 130 | 0.85 | 1.2 | 0.8 | 1.15 | A | A | 6 |

As seen above, in the cellulose acylate film where the substitution degree B by a propionyl group, a butyryl group or a benzoyl group is 0 or more, a viewing angle and a color shift performance equal to those in Examples 9, 10 and 13 using a cellulose acylate film where all substituents are an acetyl group, can be realized without adding a retardation developer.

According to the present invention, a cellulose acylate film particularly for VA, IPS and OCB modes, ensuring correct optical compensation of a liquid crystal cell to achieve high contrast and improve the color shift dependent on the viewing angle direction at the black display time, a production method thereof, and a polarizing plate using the cellulose acylate film are provided. Also, according to the present invention, a liquid crystal display device, particularly, a VA-, IPS- or OCB-mode liquid crystal display device, improved in the contrast and the color shift dependent on the viewing angle direction at the black display time is provided.

The entire disclosure of each and every foreign patent application from which the benefit of foreign priority has been claimed in the present application is incorporated herein by reference, as if fully set forth.

What is claimed is:

1. An optical film comprising:
at least one kind of humidity dependency improver that improves ΔRe,
wherein the optical film has:
a ratio of Re/Rth which is larger as a wavelength is longer in the visible wavelength region; and
Re which is larger as a wavelength is longer in the visible wavelength region,
wherein Re represents an in-plane retardation (unit: nm) of the optical film;
Rth represents a retardation (unit: nm) in a thickness direction of the optical film; and
ΔRe represents a humidity dependency of Re defined by the following formula (1):
ΔRe=|Re(550)10%RH−Re(550)80%RH|, Formula (1):
wherein Re(550)10%RH represents Re at a wavelength of 550 nm, at a temperature of 25° C. and at a relative humidity of 10%; and
Re(550)80%RH represents Re at a wavelength of 550 nm, at a temperature of 25° C. and at a relative humidity of 80%.

2. The optical film according to claim 1, further comprising:
at least one kind of polymer.

3. The optical film according to claim 2, having ΔRe(A) and ΔRe(0) which satisfy the following formula (2):

|ΔRe(A)−ΔRe(0)|/A≧1 (unit: nm/parts by mass), Formula (2):
wherein ΔRe(A) represents ΔRe of the optical film comprising the humidity dependency improver in an amount of A parts by mass, assuming that the optical film comprises the polymer in an amount of 100 parts by mass; and
ΔRe(0) represents ΔRe of the optical film comprising the humidity dependency improver in an amount of 0 parts by mass, assuming that the optical film comprises the polymer in an amount of 100 parts by mass.

4. The optical film according to claim 1, having the retardation values which satisfy the following formulae (Ia), (Ib), (II), (III) and (A):
0.4<{(Re(450)/Rth(450))/(Re(550)/Rth(550))}<0.95 Formula (Ia):
1.05<{(Re(650)/Rth(650))/(Re(550)/Rth(550))}<1.9 Formula (Ib):
0.1<(Re(450)/Re(550))<0.95 Formula (II):
1.03<(Re(650)/Re(550))<1.93 Formula (III):
10≧|Re(550)10%RH−Re(550)80%RH|, Formula (A):
wherein Re(λ) represents Re at a wavelength of λ nm; and
Rth(λ) represents Rth at a wavelength of λ nm.

5. The optical film according to claim 1,
wherein the humidity dependency improver is a compound containing at least two hydrogen-bonding groups.

6. A production method of an optical film, comprising:
a step of stretching a film by a stretch ration of X %; and
a step of shrinking the film by a shrinkage ratio of Y %,
wherein X and Y satisfy the following formula (Z); and
the film comprises a humidity dependency improver which is a compound containing at least two hydrogen-bonding groups:
400−4000/\sqrt{(100+X)}≧Y≧100−1000/\sqrt{(100+X)}. Formula (Z):

7. The optical film according to claim 1, which is produced by the production method of an optical film comprising:
a step of stretching a film by a stretch ration of X %; and
a step of shrinking the film by a shrinkage ratio of Y %,
wherein X and Y satisfy the following formula (Z); and
the film comprises a humidity dependency improver which is a compound containing at least two hydrogen-bonding groups:
400−4000/\sqrt{(100+X)}≧Y≧100−1000/\sqrt{(100+X)}. Formula (Z):

8. The optical film according to claim 1,
wherein Re(550) is from 20 to 100 nm; and
Rth(550) is from 100 to 300 nm,
wherein Re(550) represents Re at a wavelength of 550 nm; and
Rth(550) represents Rth at a wavelength of 550 nm.

9. The optical film according to claim 1, further comprising:
a cellulose acylate.

10. The optical film according to claim 9, wherein the cellulose acylate satisfies the following formulae (IV) and (V):
2.0≧(DS2+DS3+DS6)≦3.0 Formula (IV):
DS6/(DS2+DS3+DS6)≧0.315 Formula (V):
wherein DS2 represents a degree of substitution of a hydroxyl group by an acyl group at a 2-position in a glucose unit of the cellulose acylate;
DS3 represents a degree of substitution of a hydroxyl group by an acyl group at a 3-position in a glucose unit of the cellulose acylate; and
DS6 represents a degree of substitution of a hydroxyl group by an acyl group at a 6-position in a glucose unit of the cellulose acylate.

11. The optical film according to claim 9,
wherein the cellulose acylate satisfies the formulae (VI) and (VII):
2.0≦A+B≦3.0 Formula (VI):
0<B, Formula (VII):
wherein A represents a degree of substitution of a hydroxyl group by an acetyl group in a glucose unit of the cellulose acylate; and
B represents a degree of substitution of a hydroxyl group by a propionyl group, butyryl group or benzoyl group in a glucose unit of the cellulose acylate.

12. The optical film according to claim 1, further comprising:
a retardation developer.

13. A polarizing plate comprising:
a polarizing film; and
a pair of protective films between which the polarizing film is sandwiched,
wherein at least one of the protective films is the optical film according to claim 1.

14. A liquid crystal display device comprising:
the optical film according to claim 1.

15. A liquid crystal display device of IPS, OCB or VA mode, comprising
a liquid crystal cell; and
a pair of polarizing plates arranged on both sides of the liquid crystal cell,
wherein the pair of the polarizing plates are the polarizing plates according to claim 13.

16. A liquid crystal display device of VA mode, comprising:
the polarizing plate according to claim 13 on a backlight side.
